(19) United States
(12) Patent Application Publication
(10) Pub. No.: US 2025/0298505 A1
(43) Pub. Date: Sep. 25, 2025

(54) INTERACTIONS BETWEEN AN INPUT DEVICE AND AN ELECTRONIC DEVICE

(71) Applicant: Apple Inc., Cupertino, CA (US)

(72) Inventors: Brandon M. WALKIN, San Francisco, CA (US); Jules K. FENNIS, Seattle, WA (US); David HERNANDEZ ALVAREZ, Cupertino, CA (US); Igor KORIN, Santa Clara, CA (US); Jennifer P. CHEN, Mountain View, CA (US)

(21) Appl. No.: 19/037,064

(22) Filed: Jan. 24, 2025

Related U.S. Application Data
(60) Provisional application No. 63/625,239, filed on Jan. 25, 2024.
(60) Provisional application No. 63/643,270, filed on May 6, 2024.

(51) Int. Cl. G06F 3/0487; G06F 3/0346; G06F 3/0354; G06F 3/0482; G06F 3/04845

(52) U.S. Cl. CPC G06F 3/0487; G06F 3/0346; G06F 3/03545; G06F 3/0482; G06F 3/04845; G06F 2203/04807

(57) ABSTRACT

An electronic device displays a palette user interface in response to receiving one or more inputs from an electronic stylus that is communicatively coupled to an electronic device. In some embodiments, the electronic device displays the palette user interface at a spatial arrangement that is based on a pose of the stylus at the time that the input to initiate display of the palette user interface is received. In some embodiments, the electronic device generates at the electronic stylus a tactile output having one or more tactile output characteristics based on characteristics of the one or more inputs from the electronic stylus. In some embodiments, the palette user interface includes one or more selectable options that when selected, initiate a process to display one or more additional user interfaces for configuring the output that is generated by the device in response to stylus inputs.

### CROSS REFERENCE TO RELATED APPLICATIONS

This application claims the benefit of U.S. Provisional Application No. 63/625,239, filed Jan. 25, 2024, and U.S. Provisional Application No. 63/643,270, filed May 6, 2024, the contents of which are herein incorporated by reference in their entireties for all purposes.

### FIELD OF THE DISCLOSURE

This relates generally to electronic devices that interact with input devices, and user interactions with such devices.

### BACKGROUND

User interaction with electronic devices has increased significantly in recent years. These devices can be devices such as computers, tablet computers, televisions, multimedia devices, mobile devices, and the like.

In some circumstances, users wish to interact with a content creation application using an electronic device with an input device such as a stylus. Enhancing these interactions improves the user's experience with the device and decreases user interaction time, which is particularly important where input devices are battery-operated.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### SUMMARY

Some embodiments of the disclosure are directed to an electronic device that facilitates efficient interactions between a user and a content creation application. In some embodiments, the device detects an input for initiating display of a palette user interface from an electronic stylus that is interacting with and is communicatively coupled to the electronic device. In some embodiments, in response to receiving the input, the device displays the palette user interface at a spatial arrangement that is based on the pose of the electronic stylus at the time that the input for initiating display of the palette user interface was received. In some embodiments, the electronic device receives via the electronic stylus an input having one or more input characteristics at the electronic device, and in response, based on input characteristics, the device generates at the electronic stylus a tactile output having one or more tactile output characteristics. In some embodiments, the palette user interface includes one or more selectable options that when selected, initiate a process to display one or more additional user interfaces for configuring the output that is generated by the device in response to stylus inputs.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIGS. 3A-3G is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIG. 5I illustrates a block diagram of an exemplary architectures for devices according to some embodiments.

FIGS. 6A-6L illustrate exemplary ways in which an electronic device displays a palette user interface in response to receiving an input from an electronic stylus, in accordance with some embodiments.

FIG. 7 is a flowchart illustrating a method for displaying a palette user interface in response to receiving an input from an electronic stylus, in accordance with some embodiments.

FIGS. 8A-8N illustrate various examples of the operation of an electronic device using an electronic stylus configured to enable stylus squeeze inputs and provide tactile outputs, in accordance with some embodiments.

FIG. 9 is a flowchart illustrating a method for providing a tactile output at an electronic stylus in response to an input received by the electronic device, in accordance with some embodiments.

FIGS. 10A-10W illustrate exemplary additional user interfaces and interactions with the additional user interface associated with a palette user interface, in accordance with some embodiments.

FIG. 11 is a flowchart illustrating a method for displaying additional user interfaces associated with a palette user interface, in accordance with some embodiments.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods for interaction between the electronic device and an input device (e.g., from a stylus or other input device). Such techniques can reduce the cognitive burden on a user who uses such devices. Further, such techniques can reduce processor and battery power otherwise wasted on redundant user inputs.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

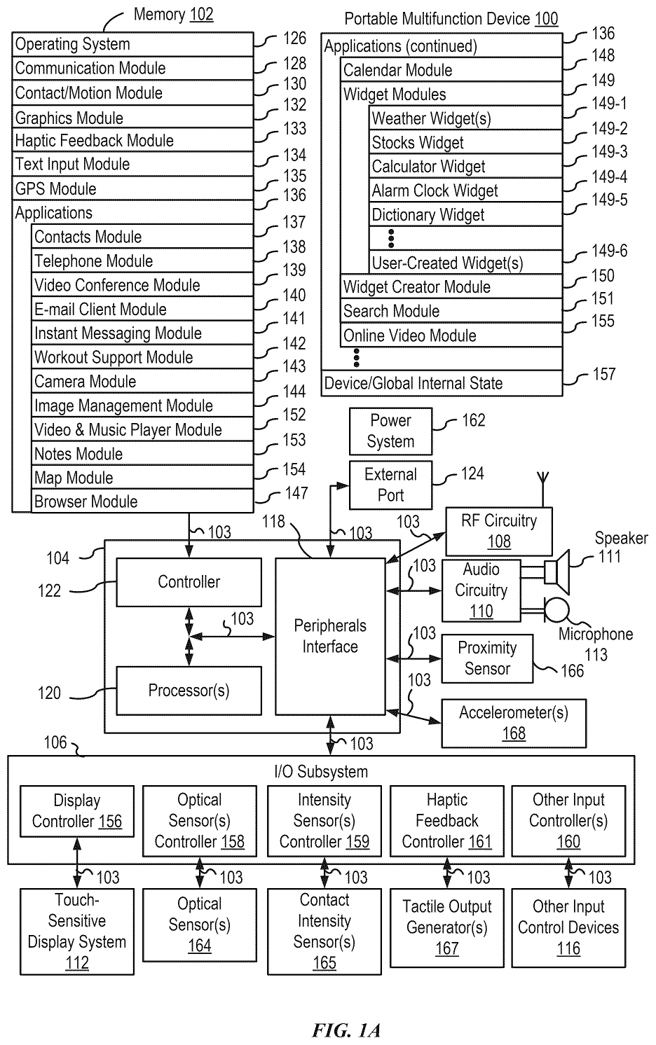

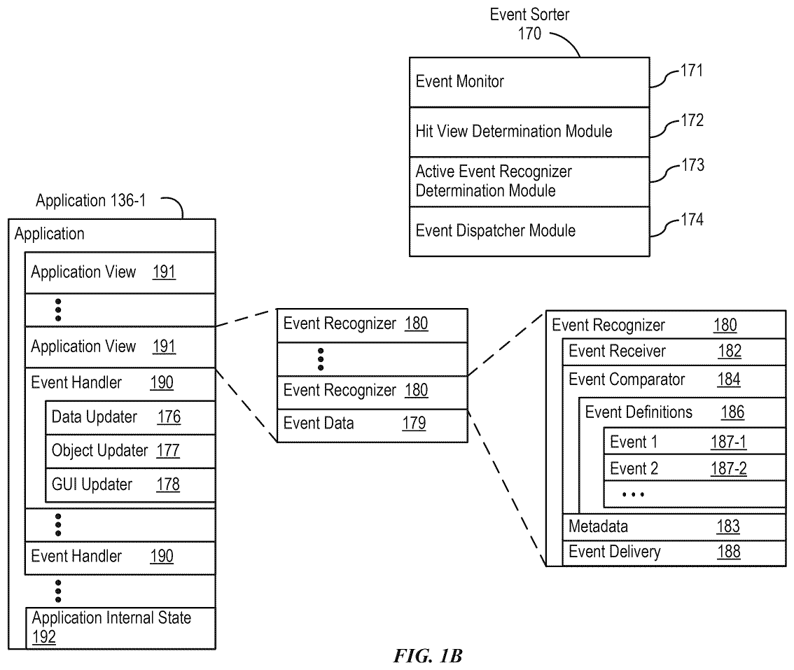

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

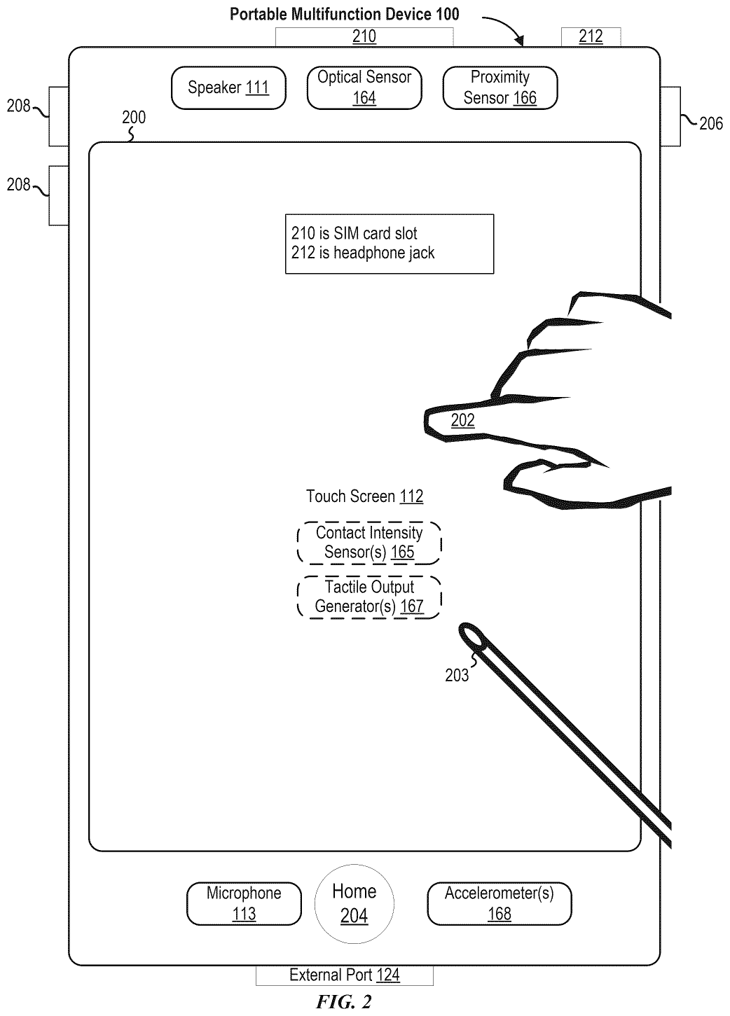

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, and/or rocker buttons), dials, slider switches, joysticks, click wheels, and so forth. In some alternate embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), 6,570,557 (Westerman et al.), and/or 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, device 100 is a portable computing system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system (e.g., an integrated display, and/or touch screen 112). In some embodiments, the display generation component is separate from the computer system (e.g., an external monitor, and/or a projection system). As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

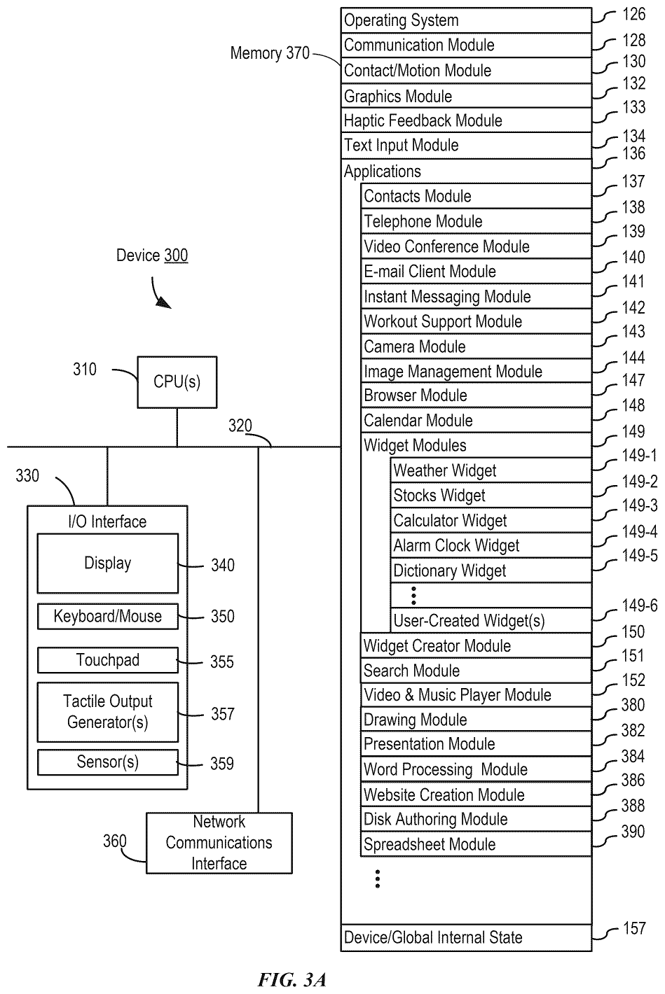

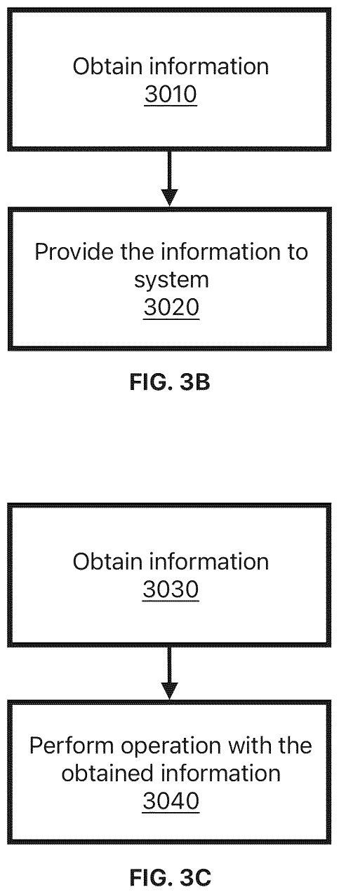

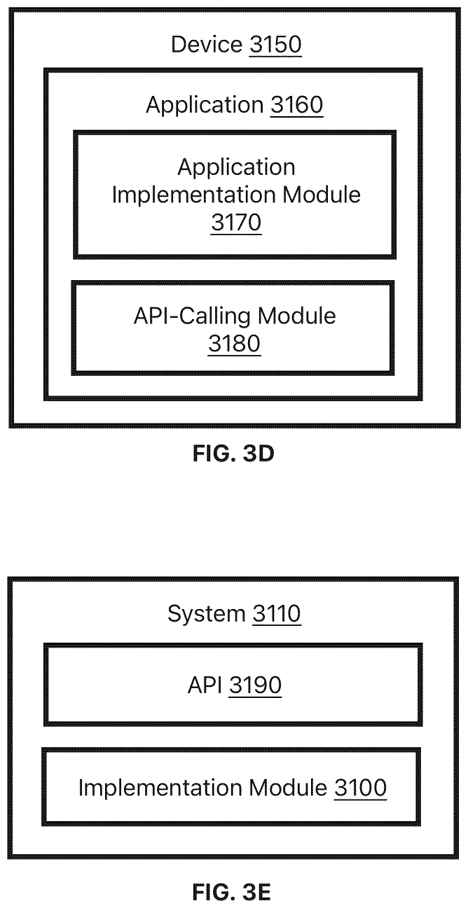

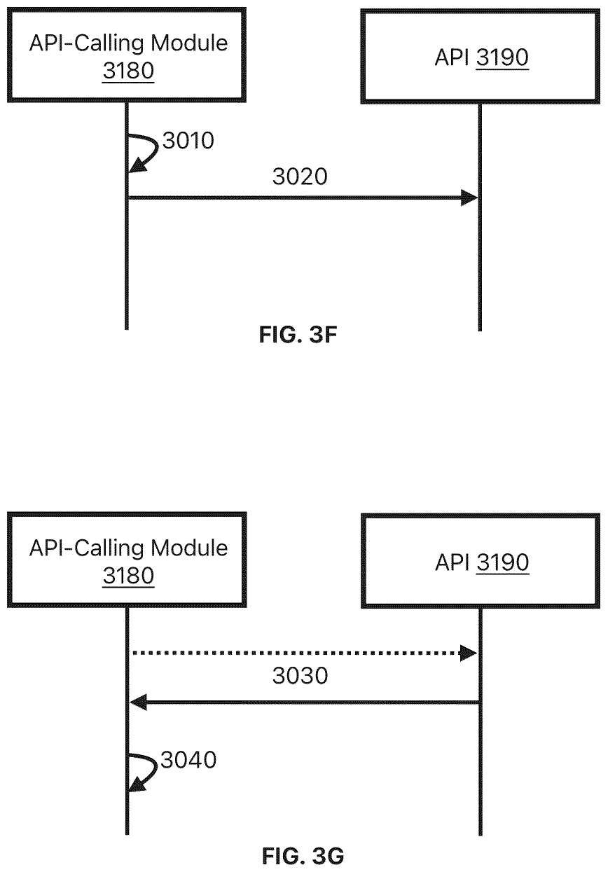

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, and/or power management) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), and/or FIREWIRE) is adapted for coupling directly to other devices or indirectly over a network (e.g., the Internet, and/or wireless LAN). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications, one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, and/or to-do lists) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,67, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, and/or scrolls on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

In some embodiments, stylus 203 is an active device and includes one or more electronic circuitry. For example, stylus 203 includes one or more sensors, and one or more communication circuitry (such as communication module 128 and/or RF circuitry 108). In some embodiments, stylus 203 includes one or more processors and power systems (e.g., similar to power system 162). In some embodiments, stylus 203 includes an accelerometer (such as accelerometer 168), magnetometer, and/or gyroscope that is able to determine the position, angle, location, and/or other physical characteristics of stylus 203 (e.g., such as whether the stylus is placed down, angled toward or away from a device, and/or near or far from a device). In some embodiments, stylus 203 is in communication with an electronic device (e.g., via communication circuitry, over a wireless communication protocol such as Bluetooth) and transmits sensor data to the electronic device. In some embodiments, stylus 203 is able to determine (e.g., via the accelerometer or other sensors) whether the user is holding the device. In some embodiments, stylus 203 can accept tap inputs (e.g., single tap or double tap) on stylus 203 (e.g., received by the accelerometer or other sensors) from the user and interpret the input as a command or request to perform a function or change to a different input mode.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

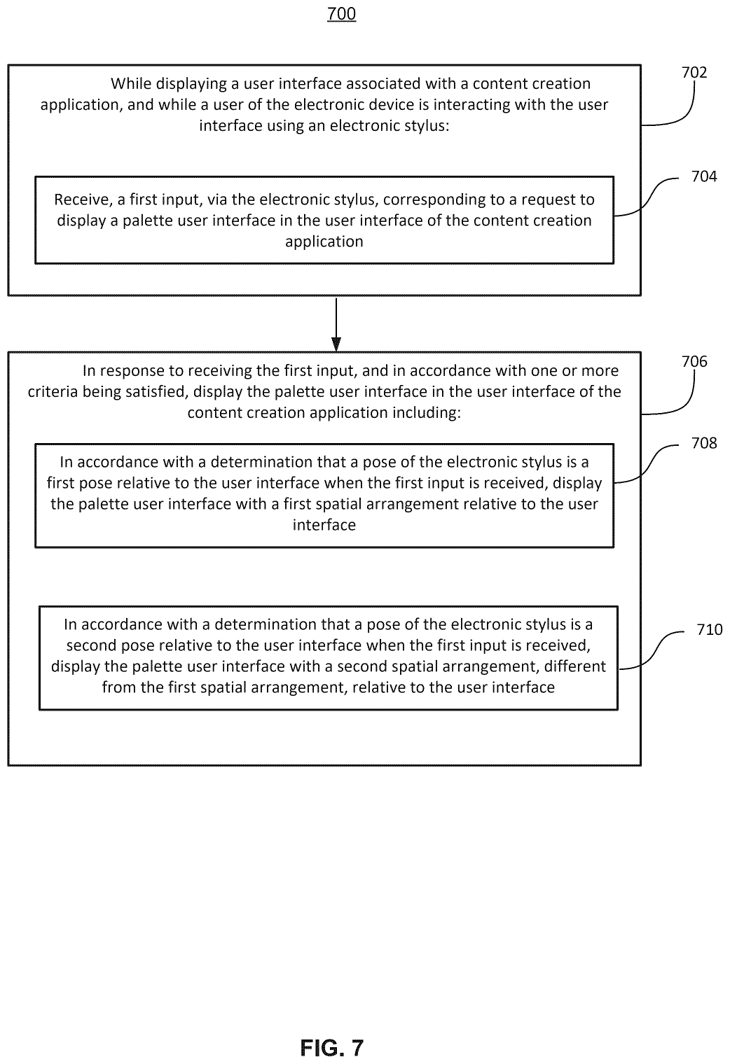

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700 (FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

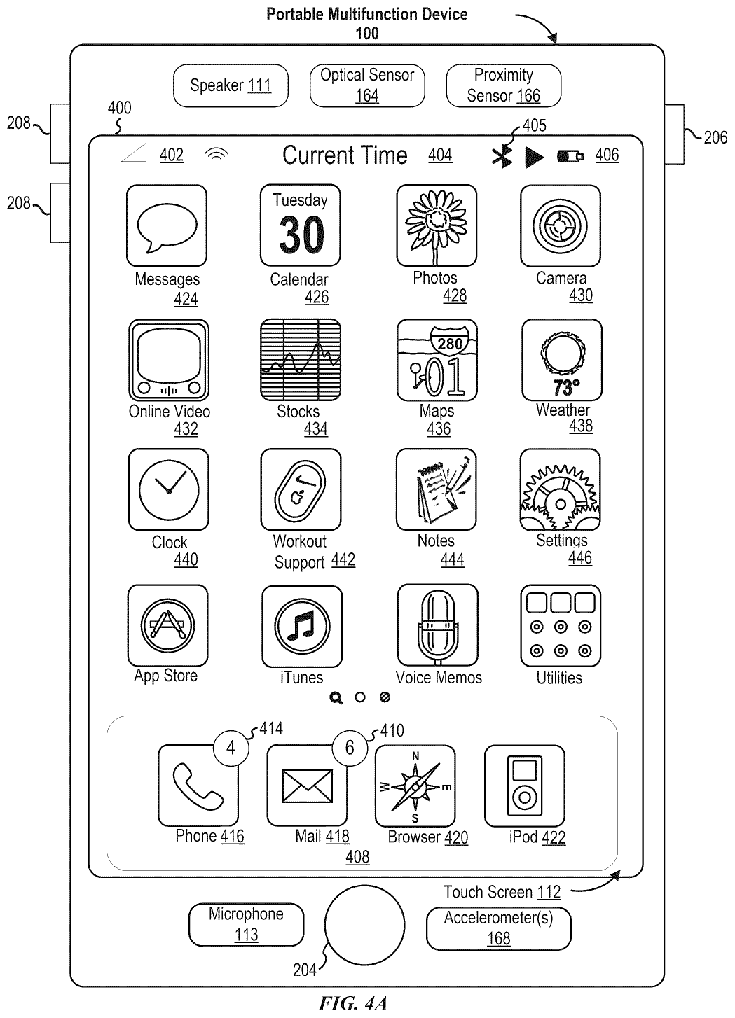

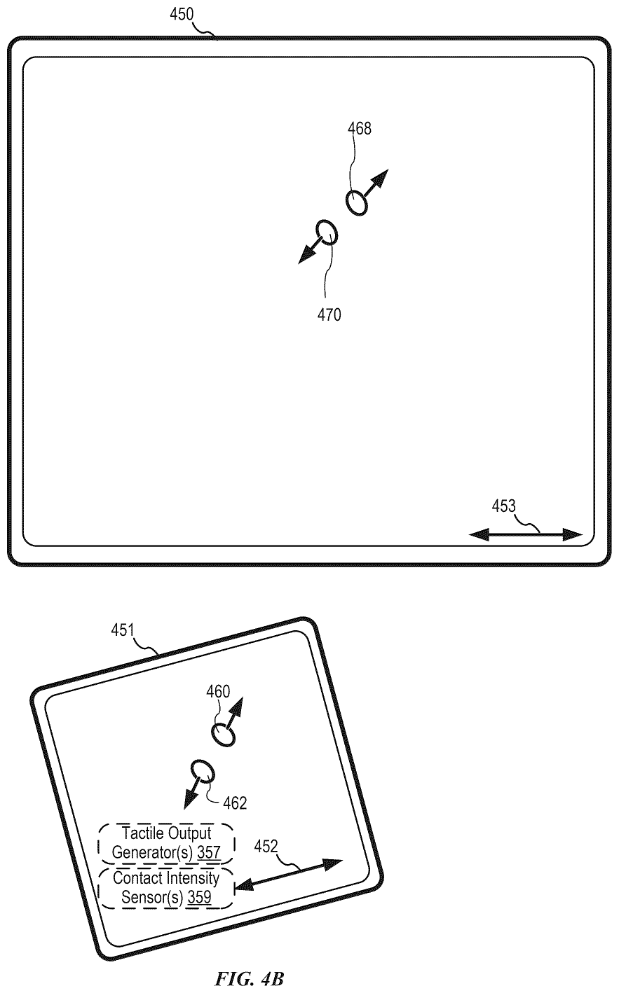

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

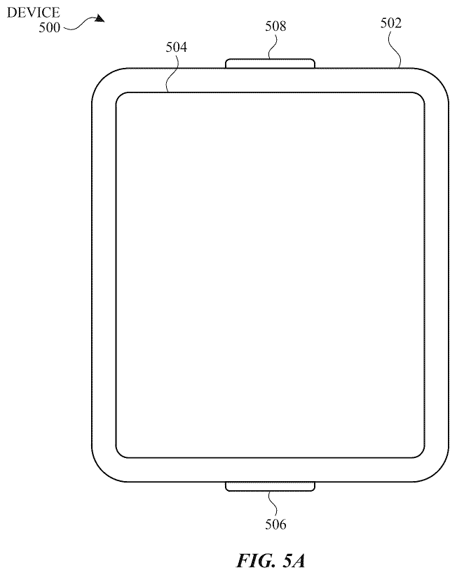

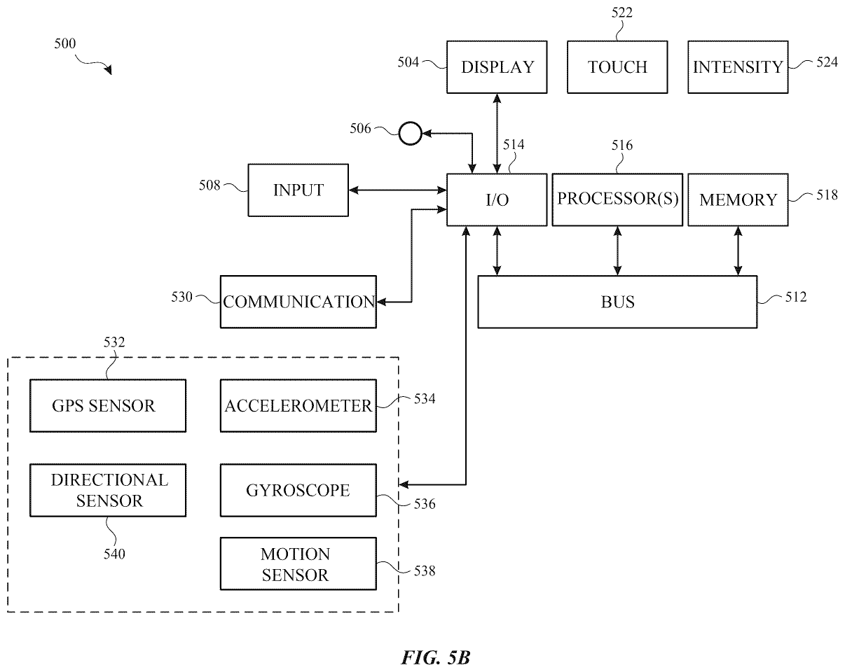

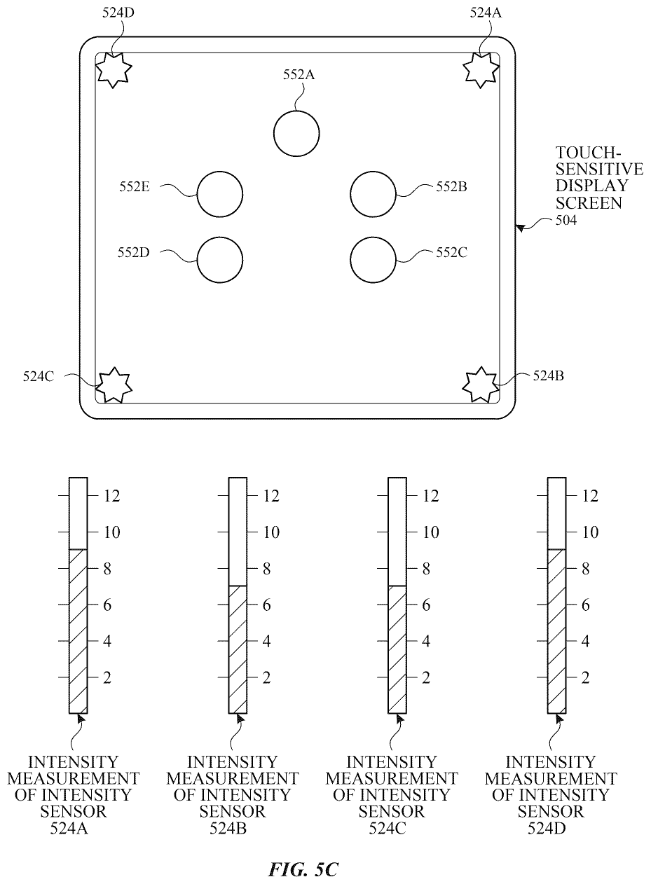

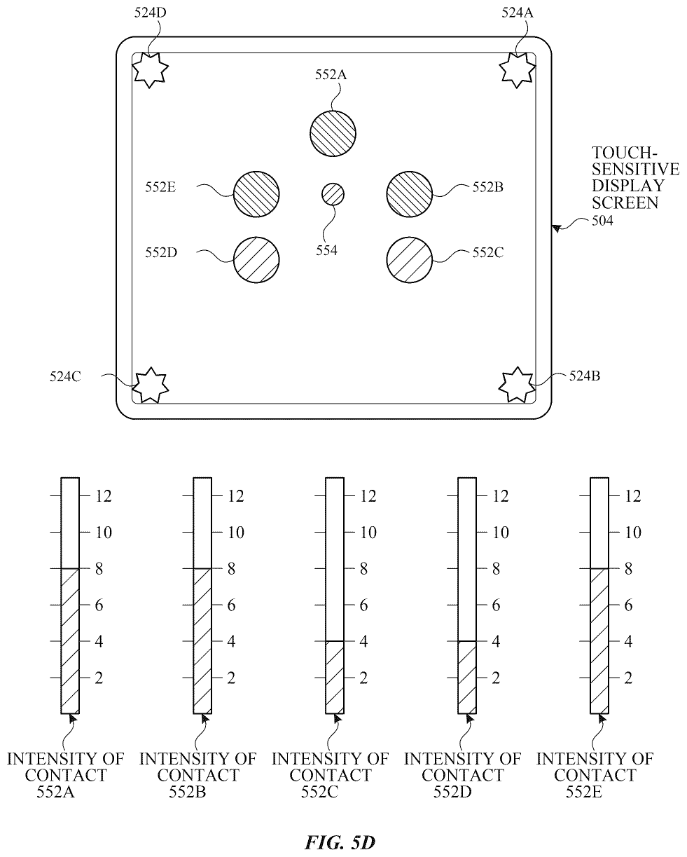

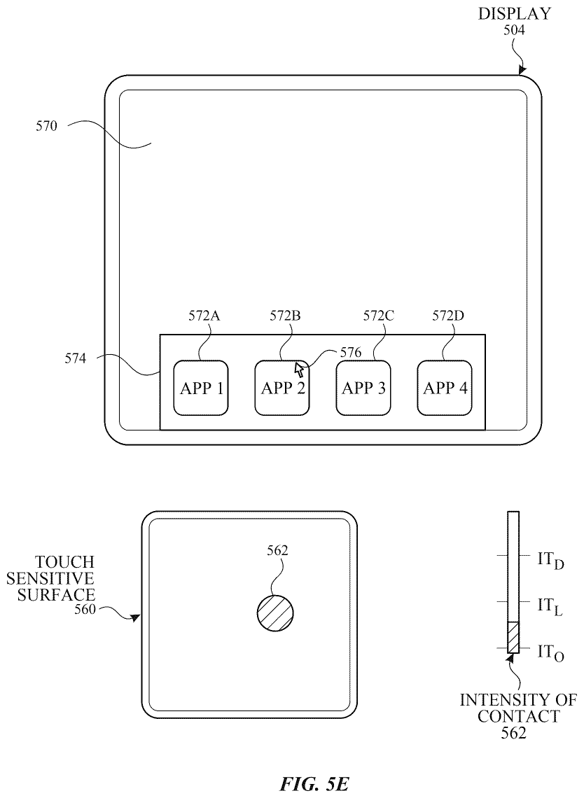

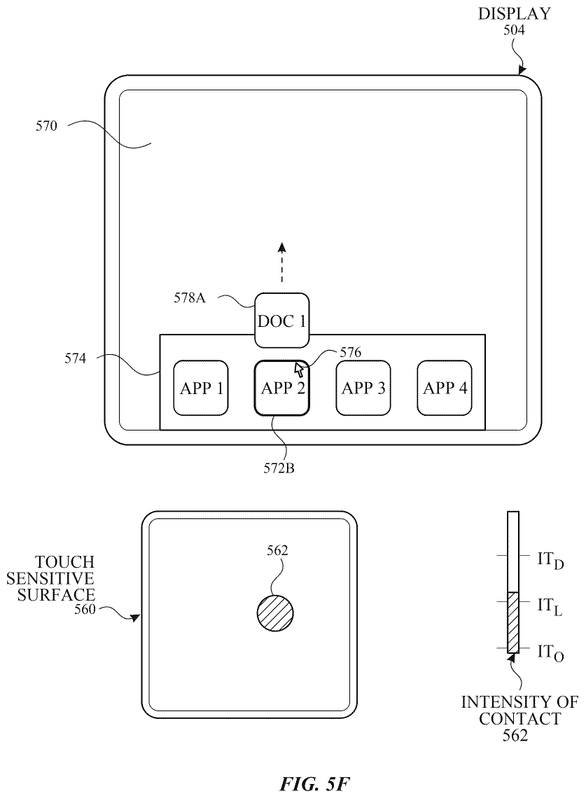

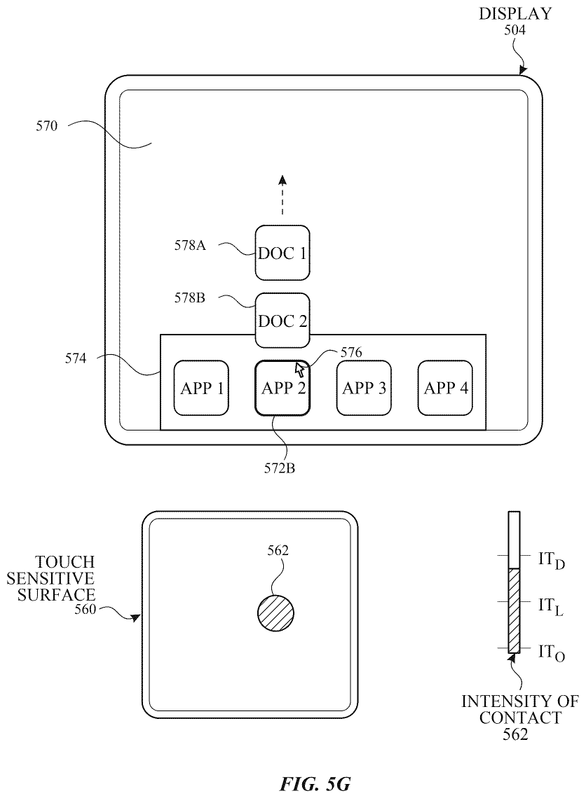

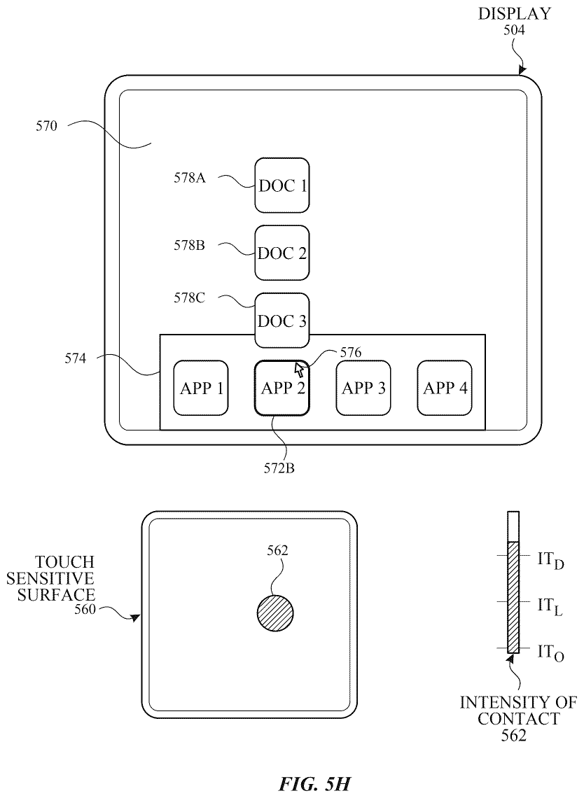

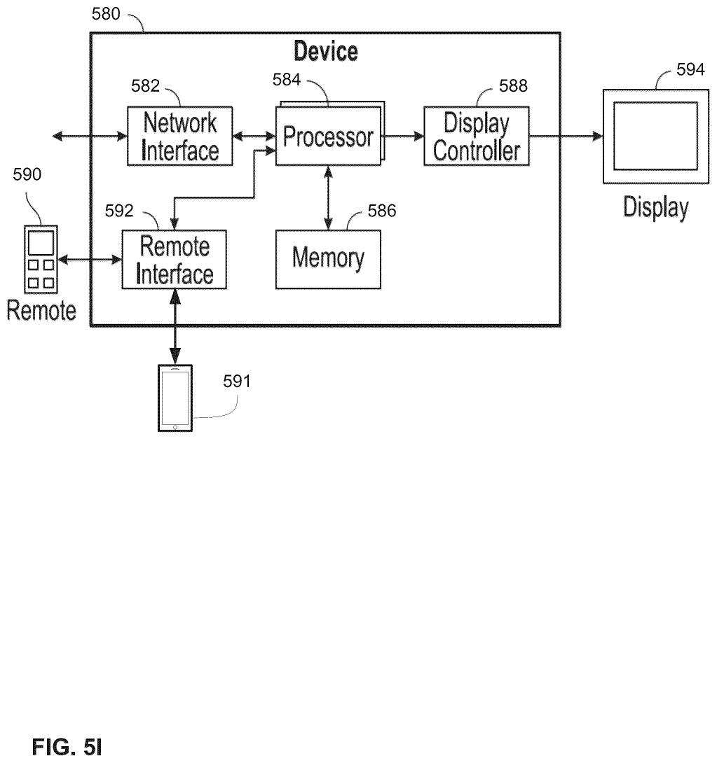

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700, 900, and 1100 (FIGS. 7, 9, and 11). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A· (Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “ITL”) in FIG. 5E, to an intensity above a deep press intensity threshold (e.g., “ITD”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “ITD”). Contact 562 is maintained on touch-sensitive surface 560. In response to the detection of the gesture, and in accordance with contact 562 having an intensity that goes above the deep press intensity threshold (e.g., “ITD”) during the gesture, reduced-scale representations 578A-578C (e.g., thumbnails) of recently opened documents for App 2 are displayed, as shown in FIGS. 5F-5I. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “ITD”). In some embodiments, the intensity, on which the progress of the animation is based, is the characteristic intensity of the contact. The operations described with reference to FIGS. 5E-5H can be performed using an electronic device similar or identical to device 100, 300, or 500.

FIG. 5I illustrates a block diagram of an exemplary architecture for the device 580 according to some embodiments of the disclosure. In the embodiment of FIG. 5I, media or other content is optionally received by device 580 via network interface 582, which is optionally a wireless or wired connection. The one or more processors 584 optionally execute any number of programs stored in memory 586 or storage, which optionally includes instructions to perform one or more of the methods and/or processes described herein (e.g., methods 700, 900, 1100, 1300, 1500, and 1700).

In some embodiments, display controller 588 causes the various user interfaces of the disclosure to be displayed on display 594. Further, input to device 580 is optionally provided by remote 590 via remote interface 592, which is optionally a wireless or a wired connection. In some embodiments, input to device 580 is provided by a multifunction device 591 (e.g., a smartphone) on which a remote control application is running that configures the multifunction device to simulate remote control functionality, as will be described in more detail below. In some embodiments, multifunction device 591 corresponds to one or more of device 100 in FIGS. 1A and 2, device 300 in FIG. 3A, and device 500 in FIG. 5A. It is understood that the embodiment of FIG. 5I is not meant to limit the features of the device of the disclosure, and that other components to facilitate other features described in the disclosure are optionally included in the architecture of FIG. 5I as well. In some embodiments, device 580 optionally corresponds to one or more of multifunction device 100 in FIGS. 1A and 2, device 300 in FIG. 3A, and device 500 in FIG. 5A; network interface 582 optionally corresponds to one or more of RF circuitry 108, external port 124, and peripherals interface 118 in FIGS. 1A and 2, and network communications interface 360 in FIG. 3A; processor 584 optionally corresponds to one or more of processor(s) 120 in FIG. 1A and CPU(s) 310 in FIG. 3A; display controller 588 optionally corresponds to one or more of display controller 156 in FIG. 1A and I/O interface 330 in FIG. 3A; memory 586 optionally corresponds to one or more of memory 102 in FIG. 1A and memory 370 in FIG. 3A; remote interface 592 optionally corresponds to one or more of peripherals interface 118, and I/O subsystem 106 (and/or its components) in FIG. 1A, and I/O interface 330 in FIG. 3A; remote 590 optionally corresponds to and or includes one or more of speaker 111, touch-sensitive display system 112, microphone 113, optical sensor(s) 164, contact intensity sensor(s) 165, tactile output generator(s) 167, other input control devices 116, accelerometer(s) 168, proximity sensor 166, and I/O subsystem 106 in FIG. 1A, and keyboard/mouse 350, touchpad 355, tactile output generator(s) 357, and contact intensity sensor(s) 359 in FIG. 3A, and touch-sensitive surface 451 in FIG. 4; and, display 594 optionally corresponds to one or more of touch-sensitive display system 112 in FIGS. 1A and 2, and display 340 in FIG. 3A.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

### User Interfaces and Associated Processes

### Palette User Interfaces for Content Creation Applications

Users interact with electronic devices in many different manners, including interacting with content creation applications for creating visual content such as drawings, paintings, and textual content. In some embodiments, the electronic device facilitates interaction between the user of the device and the content creation application using an electronic stylus or other input device that is communicatively coupled (e.g., wirelessly or using a hard-wired connection) with the electronic device. For instance, in the case of an electronic stylus, the user is able to generate visual content on the content creation application by touching the stylus on or near a user interface of the content creation application and moving the electronic stylus across the user interface. In response to detecting that the electronic stylus is being used to provide input to the user interface, the electronic device generates visual content such as a line, mark, or other shape that is commensurate with the input applied to the user interface using the electronic stylus. In some embodiments, the user is able to customize the appearance of the visual content that is generated by the electronic device in response to inputs received from the electronic stylus. For instance, the output generated by the electronic device on the user interface of the content creation application in response to an input provided by the electronic stylus can be made to appear as if the electronic stylus is operating as a physical writing utensil such as a pencil, pen, marker, and/or highlighter. Optionally, the output is also customizable in regards to other parameters such as line thickness, color, brightness, translucency, and/or texture. In some embodiments, the electronic device also allows the user to undo/redo outputs that are generated by inputs provided by the electronic stylus as part of the customization of the appearance of the visual content that is generated by the electronic device in response to input received from the electronic stylus. In some embodiments, the user is able to customize the appearance of the visual content by interacting with a palette user interface that is displayed by the electronic device as part of the content creation application and includes a plurality of selectable options, with each option pertaining to a customizable feature of the output generated in response to stylus inputs.

In some embodiments, the palette user interface includes all of the selectable options pertaining to the customizable features of the stylus input and visual content output generated in response to the stylus input thus making the palette user interface large in terms of size. Thus, optionally, the palette user interface is displayed outside of the user interface or to a side of the user interface at which visual content is displayed so as to not occlude portions of the user interface so that the visual content is visible to the user while the user is engaging with the content creation application. Thus, in some embodiments, in order to interact with the palette user interface, the user must move the electronic stylus to the location on the electronic device where the palette user interface is displayed so as to interact with the palette user interface (e.g., an expanded palette user interface) to select a selectable option of the palette user interface or otherwise interact with the palette user interface. Since the palette user interface is displayed at a location that is away from the user interface where the visual content is displayed or away from the portion of the user interface where the visual content is being generated in some circumstances means that the user must direct their attention away from the visual content that is being generated and lift the electronic stylus to the palette user interface which causes disruption to the process of generating visual content using the electronic stylus. In some circumstances, if the palette user interface is displayed over a portion of the user interface where the visual content is being displayed, the palette user interface can visually occlude the visual content, which can further disrupt the process of generating visual content using the electronic stylus. Displaying a mini-palette user interface that includes a subset of the customizable features at or near the portion of the user interface that the user is interacting with can allow the user to customize the output generated by the electronic stylus in an efficient manner without requiring the user to always interact with the expanded palette user interface that is displayed away from the visual content. The embodiments described below provide ways in which an electronic device displays a mini-palette user interface for displaying selectable options associated with the visual content generated by the electronic stylus, thus enhancing the user's interaction with the device. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

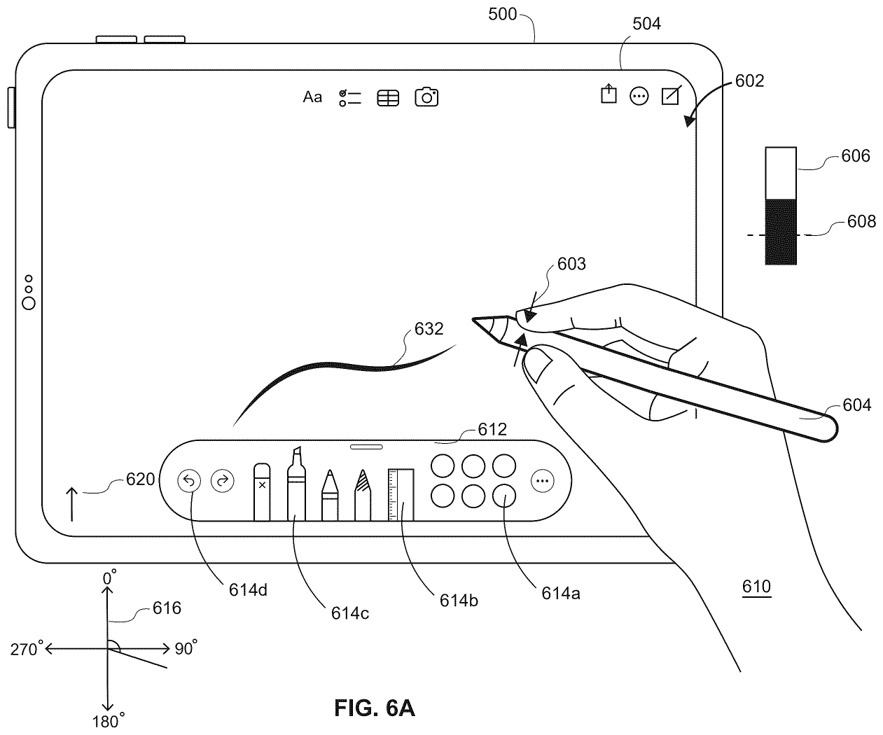

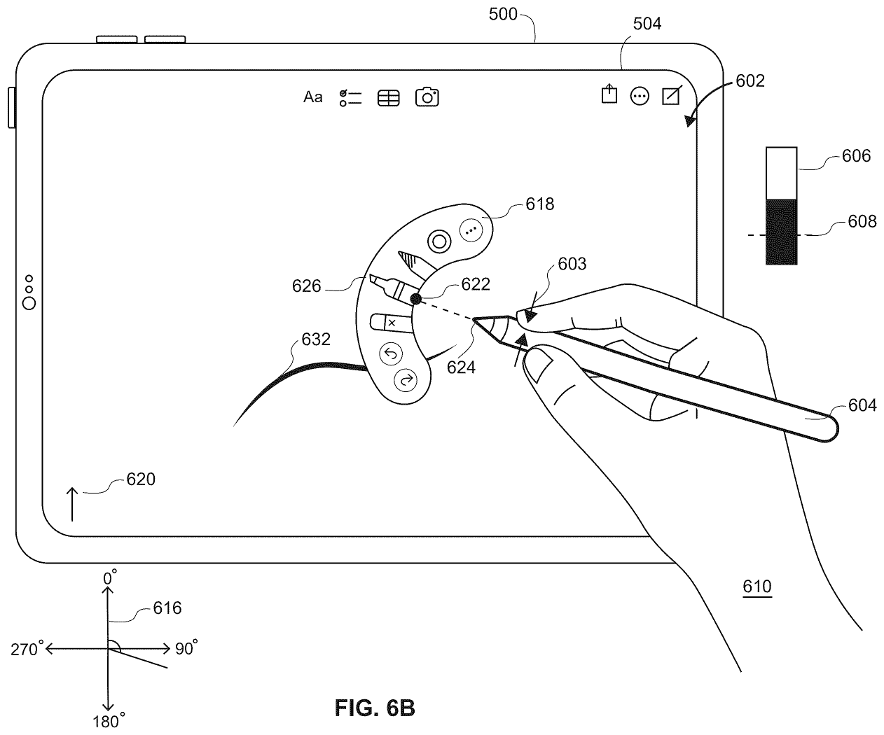

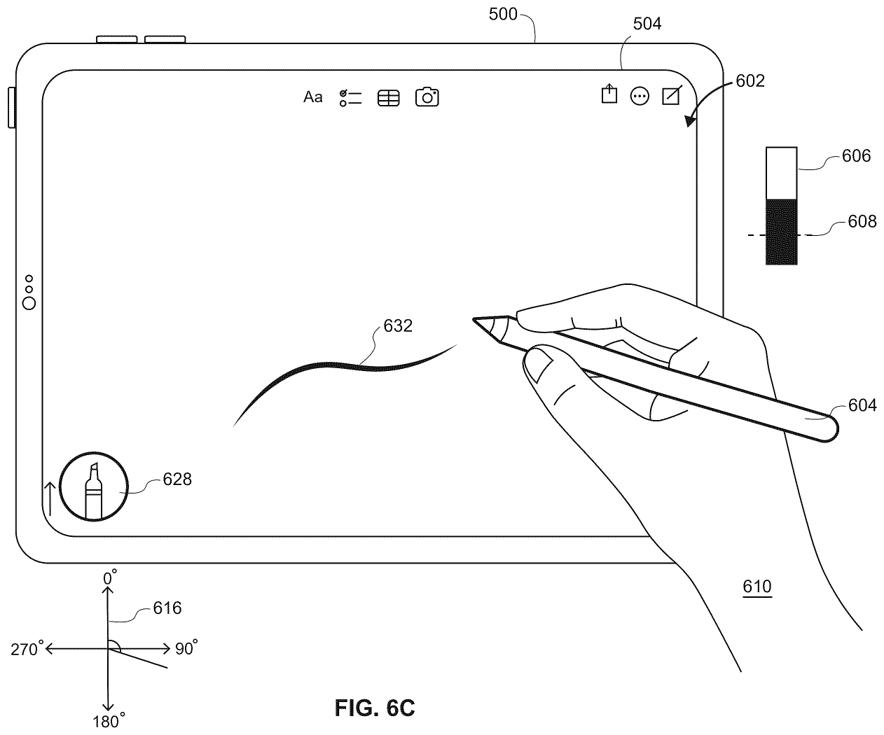

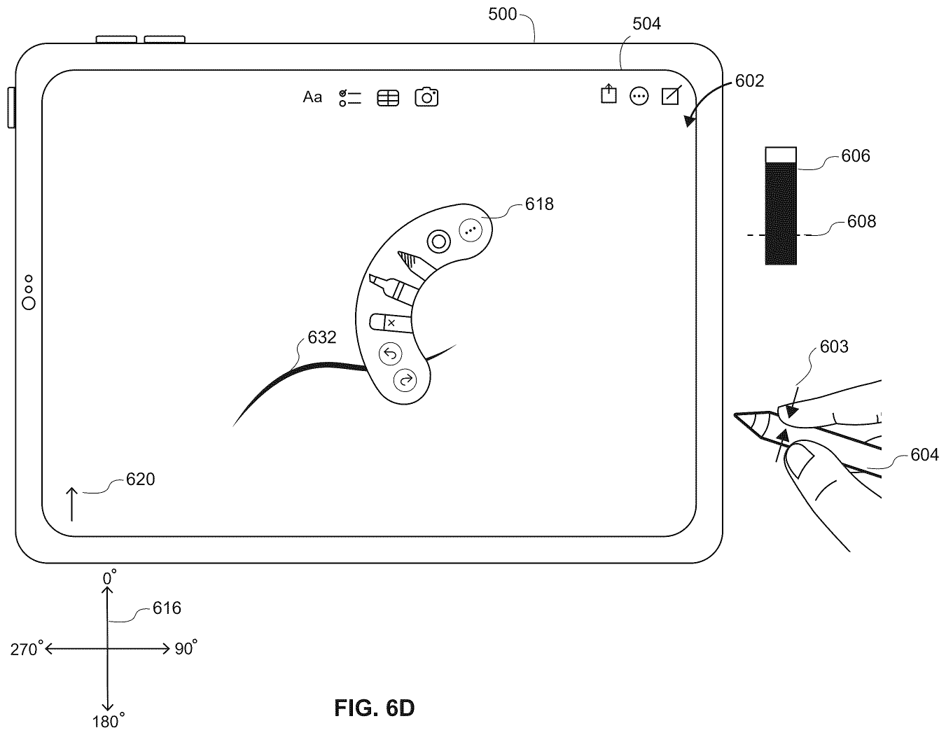

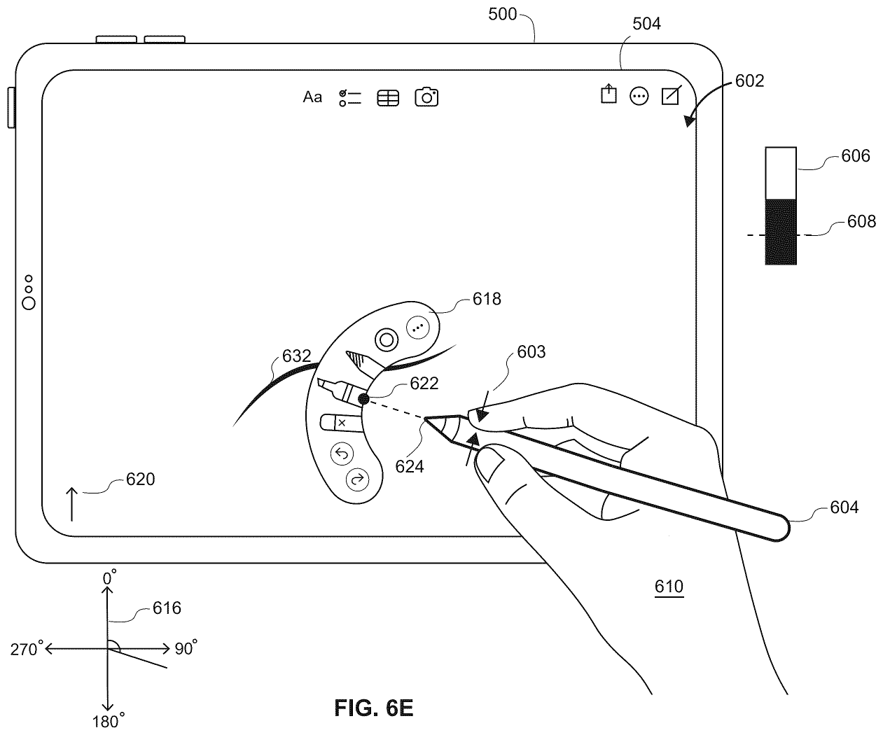

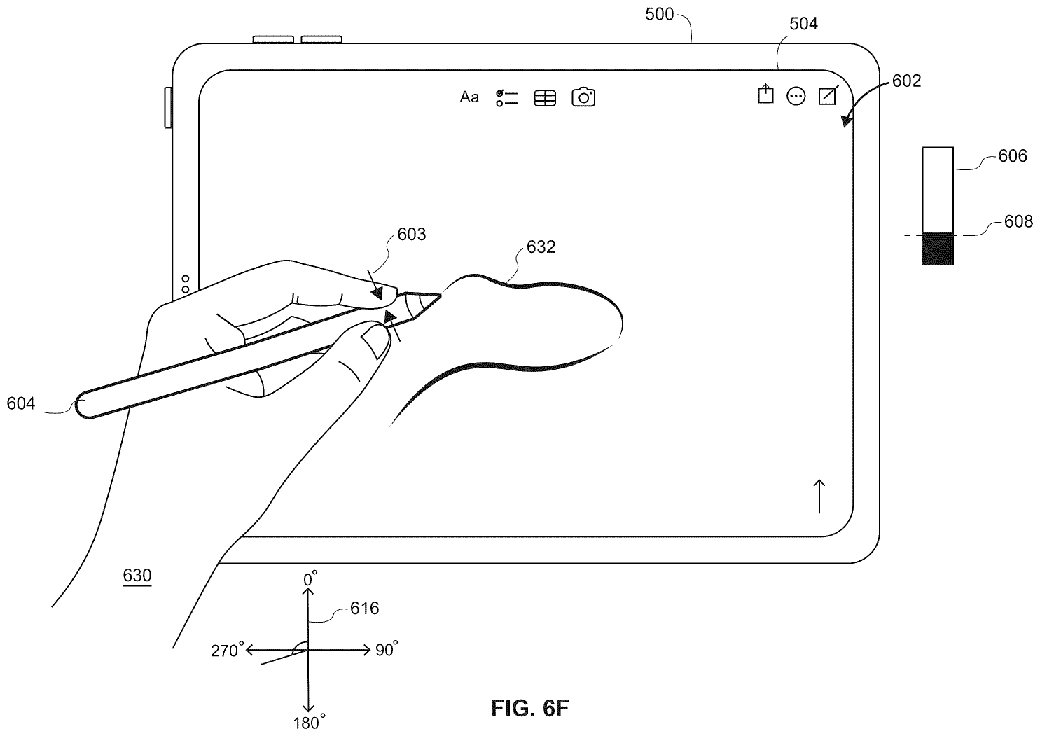

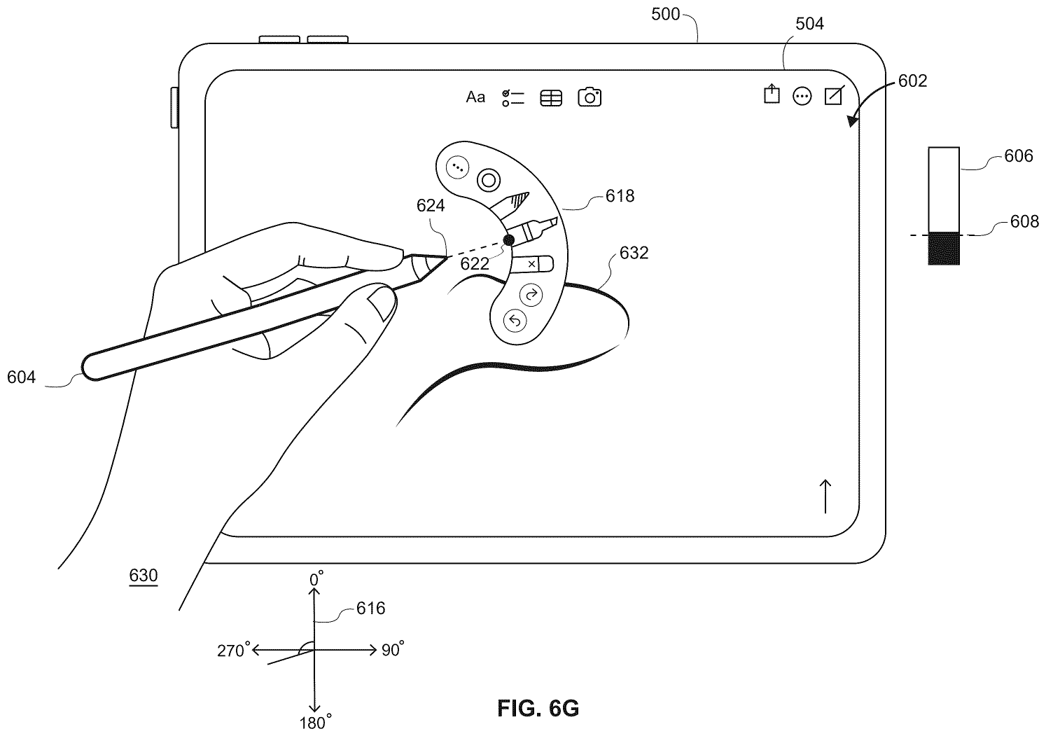

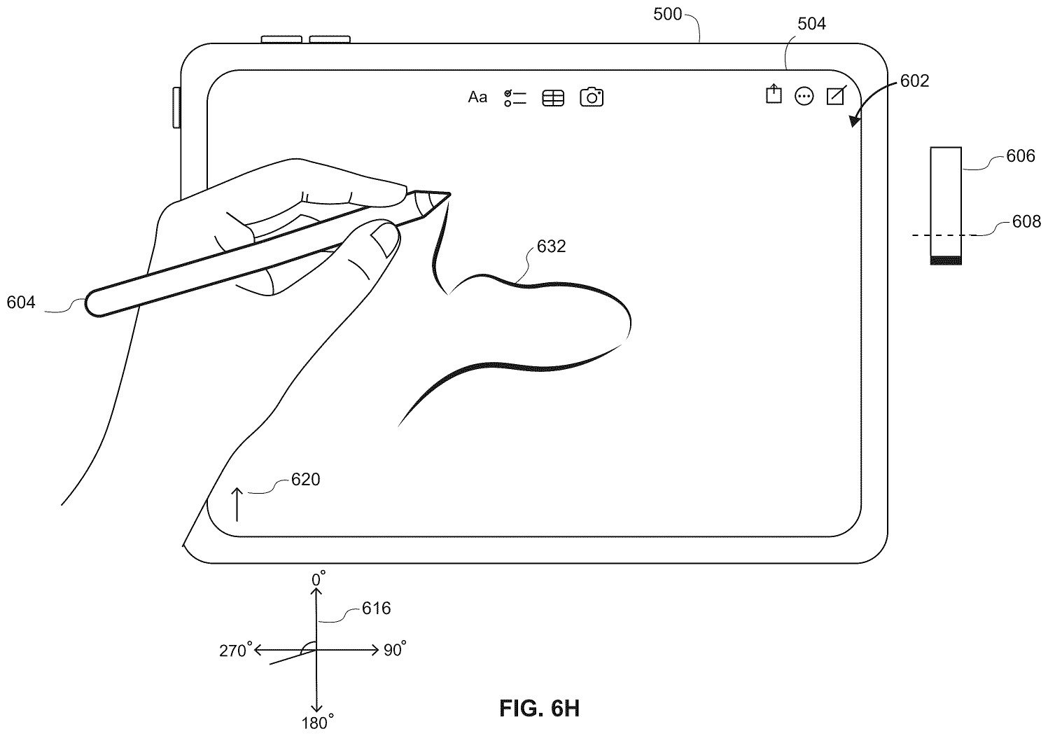

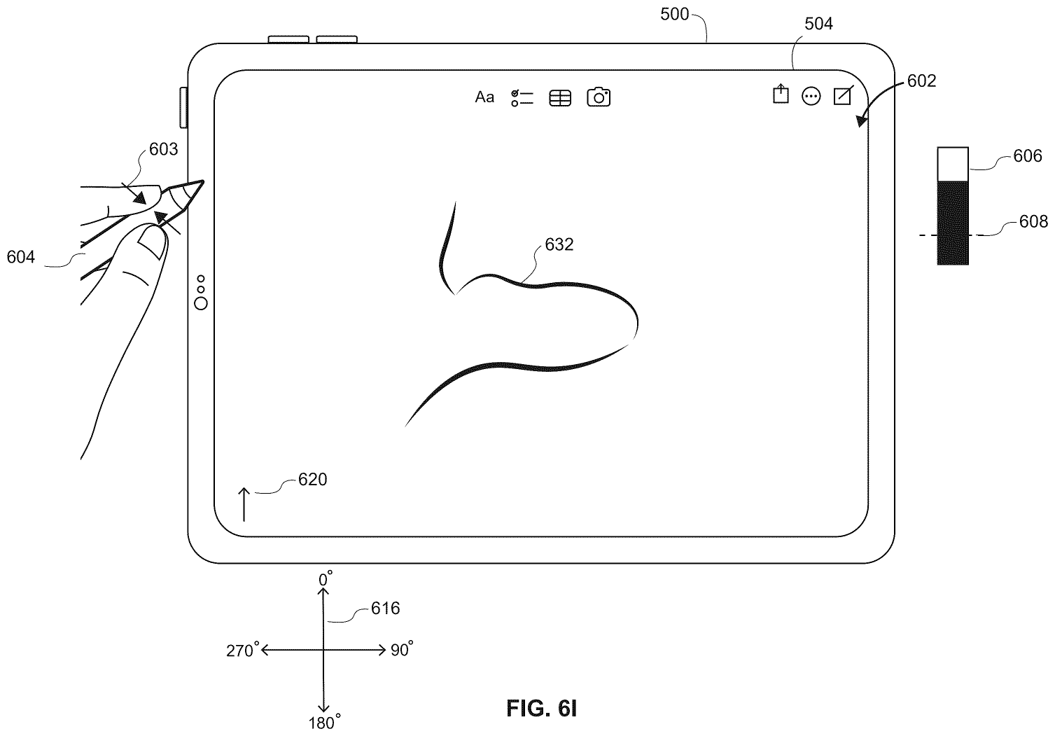

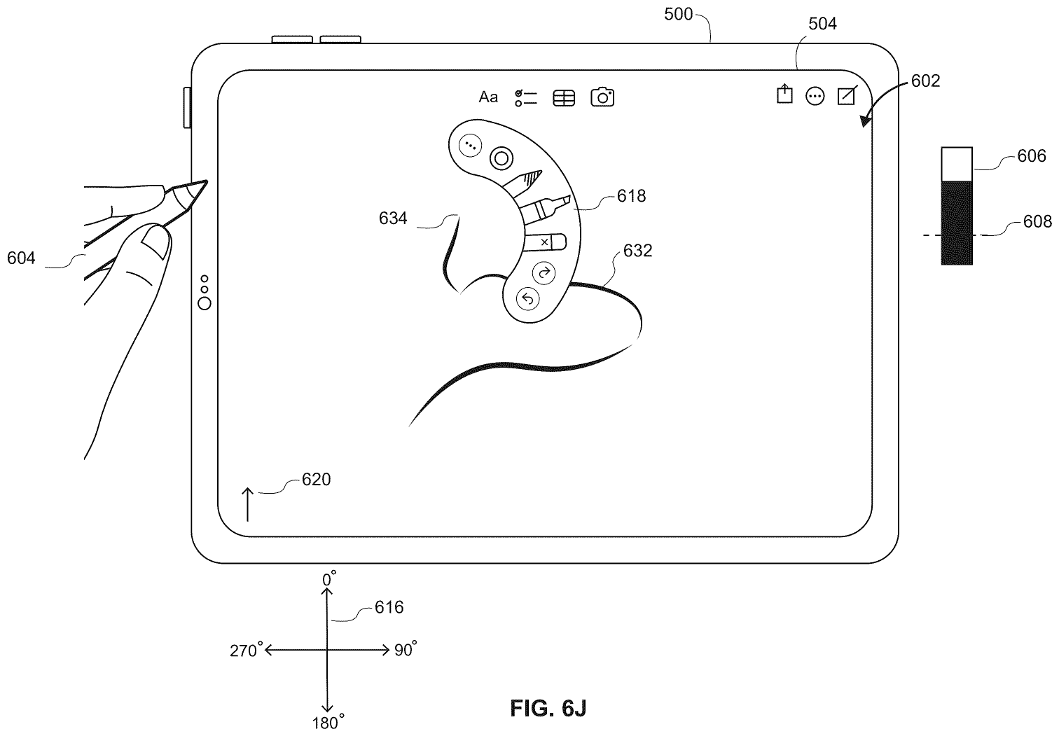

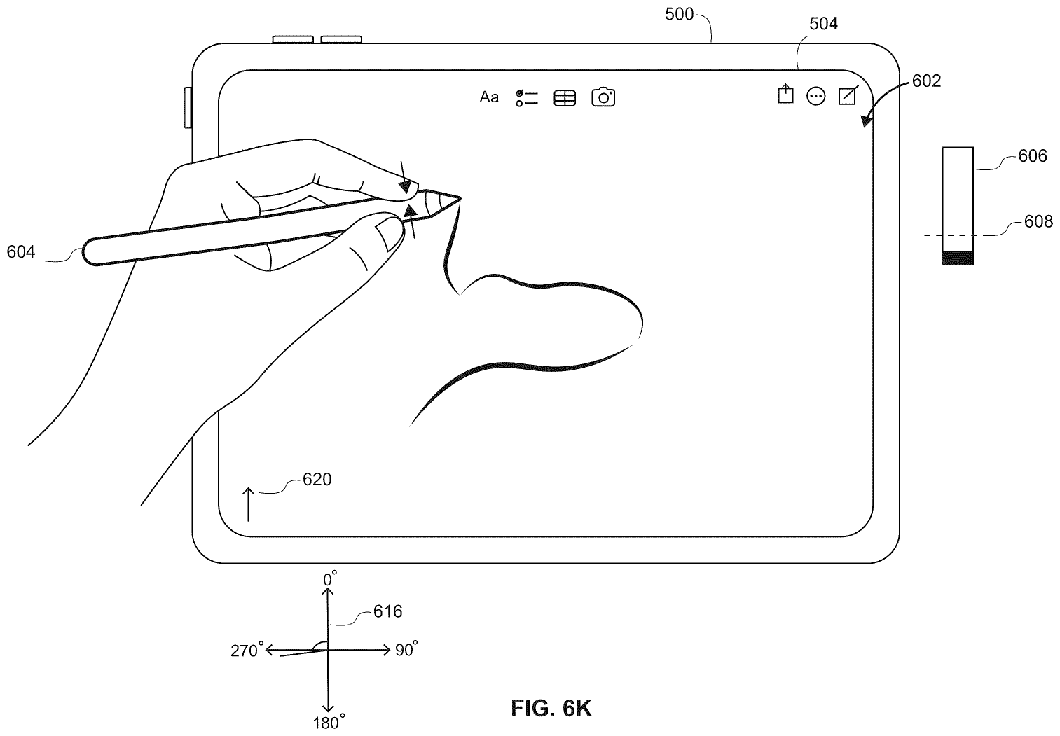

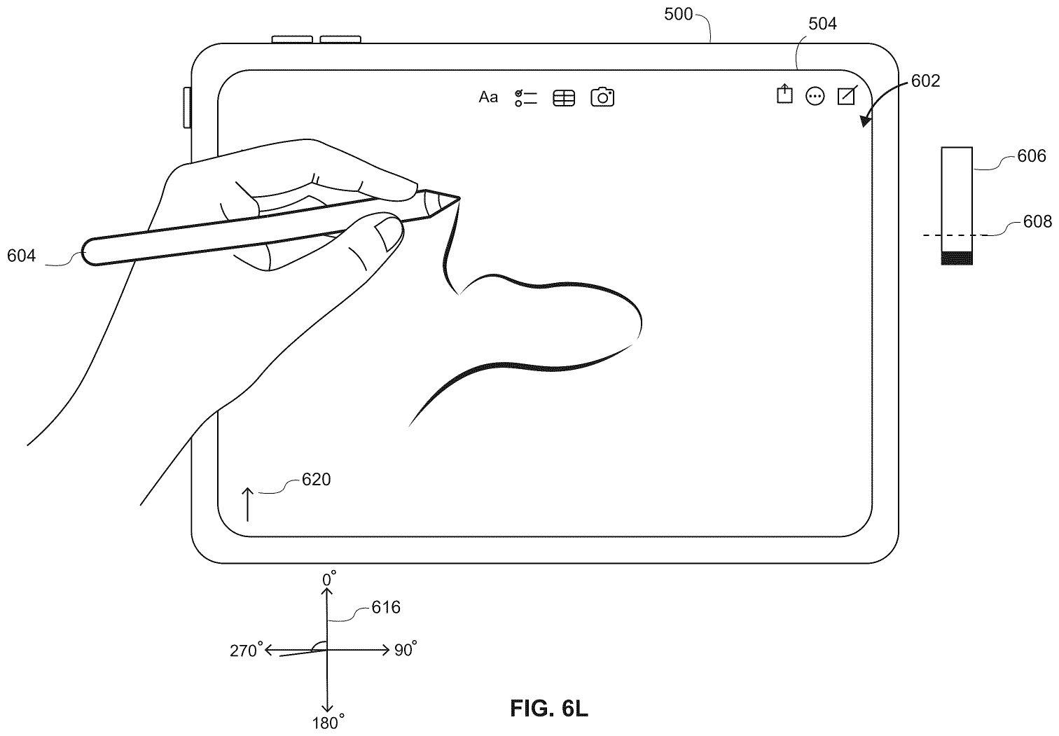

FIGS. 6A-6L illustrate examples of an electronic device displaying a mini-palette user interface on a content creation application. The embodiments in these figures are used to illustrate the processes described below, including the processes described with reference to FIG. 7. Although FIGS. 6A-6L illustrate various examples of ways an electronic device is able to perform the processes described below with respect to FIG. 7, it should be understood that these examples are not meant to be limiting, and the electronic device is able to perform one or more processes described below with reference to FIG. 7 in ways not expressly described with reference to FIGS. 6A-6L.

FIG. 6A illustrates an exemplary device 500 displaying a user interface 602. In some embodiments, the user interface 602 is displayed via a display generation component. In some embodiments, the display generation component is a hardware component (e.g., including electrical components) capable of receiving display data and displaying a user interface. In some embodiments, examples of a display generation component include a touch screen display, a monitor, a television, a projector, an integrated, discrete, or external display device, or any other suitable display device.

In some embodiments, an electronic device (e.g., device 500) includes a content creation application. The content creation application can represent visual content that is generated by a user using an electronic stylus or other input device. In some embodiments, the content creation application at user interface 602, receives inputs from an electronic stylus 604 (e.g., the electronic device detects that the electronic stylus is touching or within a predefined threshold distance from the device) and in response to the input generates visual content 632 that is commensurate with the movement of the stylus caused by hand 610 of the user when the stylus is applying an input to the content creation application. In some embodiments, device 500 as part of the content creation application, displays an expanded palette user interface 612 that includes one or more selectable options 614a-d that allow for the user to customize the output of electronic stylus (described above). For instance, expanded palette user interface 612 (referred to as expanded because it includes a larger number of selectable options than the palette user interface described below), includes one or more selectable color options 614a for setting the color of the output of stylus 604, one or more selectable measuring options 614b for using the stylus to measure distances using the electronic stylus 604, one or more tool selection options 614c for selecting the type of writing implement that device 500 will mimic when generating visual content in response to receiving inputs from the stylus, and one or more undo/redo buttons 614d that allow the user to undo and/or redo previous inputs that were applied to the content creation application.

As shown in FIG. 6A, if the user wishes to change a setting associated with the electronic stylus 604, they must life the stylus 604 away from where they are generating visual content 632 and to expanded palette user interface 612 and select one of the selectable options 614a-d. After making a selection, the user then returns to the portion of user interface 602, where they were generating visual content 632 to resume generating visual content. The process of picking up the stylus 604, bringing it to the expanded palette user interface 612, making a selection, and then returning to the visual content 632 to resume generating content can be disruptive and thus inefficient since it requires the user to abandon their attention from the content they are generating and direct their attention to the expanded palette user interface 612 that is located away from the location where they are generating visual content. Thus, in some embodiments, the user can activate a mini-palette user interface (referred to herein as a palette user interface), that is placed on the user interface 602 in response to a user input such as a squeeze input 603 (wherein the user squeezes the electronic stylus) as illustrated in FIG. 6B.

In response to squeeze input 603 (illustrated in FIG. 6A), and in accordance with a determination that the stylus is beyond a predefined distance away from display 504 (as illustrated in FIG. 6A wherein distance 606 is beyond threshold 608), the device displays palette user interface 618 as shown in FIG. 6B. In some embodiments, the location and orientation that palette user interface 618 is displayed on device 500 is based on a tilt angle/orientation and/or location of stylus 604 at the time when squeeze input 603 is received. In some embodiments, the orientation/tilt angle of the electronic stylus refers to the orientation of the electronic stylus relative to a reference vector on the X-Y plane of the device (for instance a vertical vector indicated at 620). For instance, if a vector is drawn through a central axis of the electronic stylus, and that vector is projected onto the X-Y plane of the device, then the orientation of the electronic stylus would be characterized at least in part by the orientation of the projected vector in relation to the reference vector (e.g., axis) on the X-Y plane. For instance, if a circle were drawn around the reference vector on X-Y plane, the orientation (in-part), would be defined by the orientation of the projected vector of the electronic stylus relative to the reference vector such that if the stylus were pointed in the same direction as the reference vector, the orientation (which is comprised of the tilt angle) would be 0°. If the stylus were point in the opposite direction as the reference vector, the tilt angle (which makes up a portion of the orientation) would be 180°. If the electronic stylus were facing in a direction that is perpendicular to the reference vector, the tilt angle would be 90 or 180° depending on which direction the electronic stylus was facing. Referring to the example of FIG. 6A, the orientation of the stylus is indicated as being approximately 100° relative to vector 620.

In some embodiments, the displays palette user interface 618 at an orientation that is based on the orientation of the stylus. For instance, as illustrated in FIG. 6B, palette user interface 618 is displayed such that it is orientated (e.g., facing) in the opposite orientation as electronic stylus 604 when squeeze input 603 was received (e.g., 280°). In some embodiments, the palette user interface 618 is orientated 180° (e.g., opposite) to the orientation of stylus 604 so as to not be occluded by the hand 610 of the user when it is displayed by device 500. In addition to displaying palette user interface at the same orientation as the electronic stylus 604 when squeeze input 603 is received, the device also displays palette user interface 618 at a location on user interface 602 that is based on the location of stylus 604 when squeeze input 603 is received. For instance, as illustrated in FIG. 6B, palette user interface 618 is displayed such that center 622 on the palette user interface is aligned with the tip 624 of stylus 604 as illustrated in FIG. 6B. In some embodiments, the orientation and location of stylus 604 (collectively referred to as the “pose” of the stylus) can be used by the device 500 to infer the which hand 610 of the user is operating the electronic stylus. For instance, an orientation of the stylus 604 that is between 0 to 180° indicates that the stylus is being use by the right hand 610 of the user. Thus in some embodiments, the device displays palette user interface at an orientation and location such that the palette user interface will not be visually occluded by hand 610.

In some embodiments, and in order to keep the size footprint of palette user interface 618 small (compared to expanded palette user interface 612), palette user interface 618 includes a subset of the selectable options that are available on expanded palette user interface 612. A detailed description of the selectable options displayed as part of palette user interface 618 is provided further below. In some embodiments, in response to displaying palette user interface 618, device 500 ceases display of expanded palette user interface 612 as illustrated in FIG. 6B.

In some embodiments, the user selects a selectable option 626 from the palette user interface by applying a second squeeze input 603 to stylus 604 as illustrated in FIG. 6B. In some embodiments, device 500 detects selection of selectable option 626 by detecting the proximity of stylus tip 624 to selectable option 626 (e.g., that the tip 624 is within a threshold distance from selectable option 626) at the time when squeeze input 603 is received in FIG. 6B. As illustrated in FIG. 6C, in response to detecting squeeze input 603 when palette user interface 618 is being displayed device 500 ceases display of palette user interface 618. In some embodiments, upon ceasing display of palette user interface 618, device 500 displays a tool status indicator user interface 628 that provides a visual indication of the current configuration of the stylus 604 (e.g., the current tool that is selected for generating visual content).

In some embodiments, if a squeeze input 603 is performed on the stylus 604, and the device is unable to determine the location and/or orientation of the stylus when the squeeze input is performed, the device displays palette user interface 618 at the last location it was displayed as illustrated in FIG. 6D. In the example of FIG. 6D, the stylus 604 is away from the device 500 (as indicated by distance 606 far exceeding threshold 608) such that when squeeze input 603 is applied to the stylus 604, the device 500 is unable to detect a location and/or orientation of the stylus 604 in order to determine a location at which to display palette user interface 618. Thus, in some embodiments, in response to being unable to determine the orientation/location of stylus 604 and/or in response to determining that the stylus is located away from device 500, the device displays palette user interface 618 at the last location and orientation that palette user was previously displayed (e.g., the same location and orientation illustrated in FIG. 6B).

In some embodiments, and as described above, in addition to orientation of the stylus, the device displays palette user interface 618 at location on display 504 that is based on the location of electronic stylus 604 relative to the display 504 when squeeze input 603 is received as illustrated in FIG. 6E. In the example of FIG. 6E, the hand 610 of the user is in a different position than in FIG. 6B, meaning that stylus 604 and more specifically the tip 624 of stylus 604 is at a different location than in FIG. 6B. In the example of FIG. 6E, even though stylus 604 is in a different location, its orientation 616 with respect to display 504 is the same as the orientation of stylus 604 in the example of FIG. 6B. As illustrated in FIG. 6E, in response to the same orientation but in a different location, device 500 displays palette user interface in the same orientation as it was displayed in FIG. 6B, but at a different location (e.g., such that tip 6245 is aligned with the center of the palette user interface 618).

As described above, the orientation that the palette user interface 618 is displayed in by device 500 is dependent on the orientation of the stylus 604 when a squeeze input is received, and the orientation of the stylus 604 is dependent upon which hand is operating the electronic stylus as illustrated in FIG. 6F. In the example of FIG. 6F, the left hand 630 of the user is operating stylus 604. Thus, accordingly, the stylus 604 is oriented with respect to display at 260° as indicated at orientation 616. Since the left hand 630 of the user is operating the stylus, the orientation 616 of the stylus with respect to display 504 will likely be between 180 and 360/0°. Thus, in some embodiments, in response to detecting a squeeze input 603 when the distance 606 of stylus 604 is greater than threshold 608, device 500 displays palette user interface 618 at an orientation and location illustrated in FIG. 6G. In some embodiments, the order of selectable option on palette user interface 618 is changed depending on the orientation that the palette user interface is displayed at. For instance, as illustrated in FIG. 6G, when looking at palette user interface 618 from the left side to the right side, the order of selectable options is reversed with respect to the order displayed in FIG. 6E.

In some embodiments, and as illustrated in FIG. 6G, palette user interface 618 is oriented 180° (e.g., in the opposite direct) of palette user interface 618 so that it is not visually occluded by the hand 630 of the user. Additionally, device 500 displays palette user interface 619 at a location on user interface 602 such that the center of the palette user interface 618 (as approximated by 622) is aligned with tip 624 of stylus 604 as illustrated in FIG. 6G. In some embodiments, the display of palette user interface 618 is terminated by device 500 in response to a further squeeze input as described above. Additionally or alternatively, palette user interface 618 ceases to be displayed by device 500 when the device detects that the stylus 604 is in contact with the display or within a threshold distance of the display 504 as illustrated in FIG. 6H.

In the example of FIG. 6H, palette user interface 618 is no longer displayed by device 500, in response to device 500 detecting that the distance 606 of stylus 604 is within the threshold 608. In some embodiments, the threshold 608 is predefined and is set such that it can serve to differentiate when the user is actively applying inputs to the content application on user interface 602 versus when the user is hovering over the display 504 without actually touching the display 504. In some embodiments, in order to avoid having the palette user interface 618 obstruct the ability of the user to apply inputs to the content application, the device ceases display of the palette user interface 618 upon detecting that the stylus 604 is touching or within a threshold distance from the display 504.

As discussed above, in some embodiments, if the device is unable to determine an orientation and location for the electronic stylus 604 when a squeeze input is received, the device 500 displays the palette user interface in response to detecting a squeeze input at the last location and orientation that the palette user interface was displayed. Additionally and/or alternatively, if device 500 is unable to determine an orientation and location for the electronic stylus 604 (for instance because the stylus has moved away from the device), the device 500 displays the palette user interface 618 based on the last known location and orientation of the stylus when it was in proximity to the display 504. For instance, as illustrated in FIG. 6I, when stylus 604 is away from display 504 such that the device cannot determine an orientation and/or location of the stylus with respect to display 504, and a squeeze input 603 is applied to stylus 604, the device displays palette user interface 618 at the location where the last input was applied to user interface 602 as illustrated in FIG. 6J.

As illustrated in FIG. 6J, palette user interface 618 is displayed at a location and orientation that is based on where the stylus was last detected when it was applying input to user interface 602 (e.g., at the last location where the stylus was located when it was drawing visual content 632). In some embodiments, and as illustrated in FIG. 6J, the last location where the input was applied (e.g., location 634 as shown in FIG. 6H) is used to by device 500 to determine the location and orientation at which to display palette user interface 618.

In some embodiments, if the device determines that the distance 606 of stylus 604 is below threshold 608, when a squeeze input 603 is received (as illustrated in FIG. 6K), the device forgoes displaying a palette user interface 618 as shown in FIG. 6L. In some embodiments, as illustrated in FIG. 6L, device 500 ignores a squeeze input and forgoes displaying the palette user interface 618, if the device determines that the stylus 604 is applying input to user interface 602. The determination is based on determining that the distance 606 between the stylus and the display 504 is less than the threshold 608. The device optionally forgoes displaying palette user interface 618 in order to avoid interrupting or disrupting the input that is being applied to user interface 602.

FIG. 7 is a flow diagram illustrating a method 700 for displaying a palette user interface in response to receiving an input from an electronic stylus, in accordance with some embodiments. The method 700 is optionally performed at an electronic device such as device 100, device 300, device 500 or device 580, as described above with reference to FIGS. 1A-1B, 2-3, 4A-4B and 5A-5I. Some operations in method 700 are, optionally combined and/or order of some operations is, optionally, changed.

In some embodiments, method 700 is performed at an electronic device in communication with a display generation component and one or more input devices, wherein the one or more input devices include an electronic stylus. For example, the electronic device is a mobile device (e.g., a tablet, a smartphone, a media player, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external), etc.). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, the electronic stylus is communicatively coupled to the electronic device, either via a wired or wireless communication link, and is configured to provide inputs to the electronic device. For instance, the electronic stylus optionally includes one or more components that are configured to allow the electronic device to detect when the electronic stylus is touching the display generation component or is otherwise in near proximity (e.g., within a threshold distance such as 0, 0.01, 0.05, 0.1, 0.2, 0.5, 0.8, 1, 3, 5, 10, 30, 50 or 100 cm) to the electronic device, a screen of the electronic device, and/or from the displayed user interface that the electronic stylus is interacting with. In some embodiments, the electronic stylus includes one or more components that are configured to allow for the electronic device to determine a pose of the electronic stylus with respect to electronic device, screen, and/or displayed user interface. Thus, in some embodiments, the electronic device is able to determine the position and/or the orientation of the electronic stylus with respect to the electronic device. In some embodiments, the electronic device obtains pose information including position/attitude (pitch, yaw, and/or roll), orientation, tilt, path, force, distance, and/or location of the input device relative to the electronic device, screen, and/or displayed user interface from one or more sensors of the input device, one or more electrodes in a touch-sensitive surface, and/or other input devices.

In some embodiments while displaying, via the display generation component, a user interface associated with a content creation application, and while a user of the electronic device is interacting with the user interface using the electronic stylus (702), the electronic device receives (704) a first input, via the electronic stylus, corresponding to a request to display a palette user interface in the user interface of the content creation application such as squeeze input 603 in FIG. 6A. In some embodiments, the content creation application is one or more of a word processing application, a note taking application, an image management application, a digital content management application, a drawing application, a presentation application, a spreadsheet application, a messaging application, a web browsing application, and/or an email application. In some embodiments, the user interface of the content creation application refers to any user interface that a user of the electronic device utilizes to enter content into the content creation application (e.g., a content entry field and/or region). In some embodiments, the user interface can consume all or nearly all of the viewable area of the display generation component. Alternatively, the user interface of the content creation application shares the viewable area of the display generation component with other user interfaces that can be associated with the content creation application or other applications that are also running on the electronic device. In some embodiments, the palette user interface includes one or more selectable options for configuring the electronic stylus to provide input to the content creation application. For instance, the selectable options of the palette user interface include options for adjusting the color, size, shape, width, and/or opacity of the input provided by the electronic stylus when the stylus interacts with the user interface of the content creation application to input content into the content creation application (e.g., handwriting, hand drawing, or the like). In some embodiments, the palette user interface includes selectable options for undoing prior inputs (described in further detail below) as well as selectable options that when selected configure the electronic stylus to act as an eraser that erases prior inputs made with the electronic stylus.

In some embodiments in response to receiving the first input (described in further detail below), and in accordance with one or more criteria being satisfied (described in further detail below), the electronic device displays (706), via the display generation component, the palette user interface in the user interface of the content creation application such as palette user interface 612 in FIG. 6B, including: in accordance with a determination that a pose of the electronic stylus is a first pose relative to the user interface when the first input is received, the electronic device displays (708) the palette user interface with a first spatial arrangement relative to the user interface such as the spatial arrangement of palette user interface 618 in response to the pose of user's hand 610 in FIG. 6B. In some embodiments, the pose of the electronic stylus refers to the location of the electronic stylus relative to the user interface and/or the orientation (e.g., the angle of the electronic stylus) with respect to the user interface (e.g., the user interface, electronic device, and/or display of the electronic device defines a two-dimensional plane from which the pose of the electronic stylus is defined). For instance, the first pose refers to the stylus being positioned at a first location relative the user interface, and/or orientated at a first angle relative to the user interface. In some embodiments, the first location can be defined by the location on the two-dimensional plane (described above) where a projection of a vector pointing out from a tip of the electronic stylus intersects. Additionally or alternatively, the location is defined by the intersection between the two-dimensional plane and a vector that projects from the tip of the electronic stylus intersects the two-dimensional plane perpendicularly. In some embodiments, the electronic device uses the determination of the pose of the electronic stylus to display the palette user interface such that the palette user interface is not occluded (either partially or completely) from the user's sight, such as by the electronic stylus and/or the hand of the user holding the electronic stylus. Thus, in some embodiments, the electronic device displays the palette user interface at a spatial arrangement relative to the user interface so that the palette user interface will be fully visible to the user of the electronic device without any occlusions. In some embodiments, the spatial arrangement refers to both the location at which the palette user interface is displayed relative to the user interface as well as the orientation at which the palette user interface is displayed relative to the user interface. In some embodiments, the orientation at which the palette user interface is displayed is expressed as an angle relative to the orientation of the palette user interface (e.g., relative to a horizontal or vertical axis of the palette user interface). Thus, in some embodiments, if the orientation of the palette user interface is the same as the user interface, then the top and bottom of the palette user interface will be aligned (e.g., parallel to) the top and bottom of the user interface. If the palette user interface is orientated perpendicular (e.g., 90°) with respect to the user interface, then the top and bottom of the palette user interface will be orientated 90° from the top and bottom of the user interface respectively. In some embodiments, in accordance with a determination that the pose of the electronic stylus is a second pose, different from the first pose, relative to the user interface when the first input is received, the electronic device displays the palette user interface with a second spatial arrangement, different from the first spatial arrangement, relative to the user interface such as the spatial arrangement of palette user interface 618 is response to the pose of user's hand 610 in FIG. 6G. In some embodiments, the electronic device determines the spatial arrangement relative to user interface at which to display the palette user interface based on the pose of the electronic stylus (at the time when the first input is received as described in further detail below.) Thus, in some embodiments, two different poses of the electronic stylus when the first input is received will yield two different spatial arrangements relative the user interface at which the electronic device displays the palette user interface. By determining the spatial arrangement to display the palette user interface based on the pose of the electronic stylus, the electronic device ensures that the palette user interface is not occluded by the stylus (described in detail below) when it is initially displayed. In some embodiments, the electronic device in response to two different stylus positions that nonetheless have the same orientation with respect to the user interface, display, and/or electronic device, displays the palette user interface at two different locations but at the same orientation with respect to the electronic device, display, and/or user interface. In some embodiments, the electronic device in response to two different stylus orientations that nonetheless have the same location with respect to the electronic device, display, and/or user interface, displays the palette user interface at two different orientations but at the same location respect to the electronic device, display, and/or user interface. Displaying the palette user with a spatial arrangement with respect to the user interface based on the pose of the electronic stylus allows for the palette user interface to be displayed on the electronic device at a location that minimizes the likelihood that one or more portions of the palette user interface will be visually occluded when displayed thus reducing the need for inputs to manually move/reorient the palette, thus minimizing the occurrence of erroneous user input associated with visual occlusions to the palette user interface and/or input to reorient/move the palette, and thereby conserving computing resources associated with correcting erroneous input.

In some embodiments, the first pose of the electronic stylus corresponds to a first orientation of the electronic stylus relative to the user interface (such as the pose of the electronic stylus 604 in FIG. 6B), and the first spatial arrangement of the palette user interface corresponds to a second orientation of the palette user interface relative to the user interface (such as the orientation of palette user interface 618 in FIG. 6B). In some embodiments, the second pose of the electronic stylus corresponds to a third orientation of the electronic stylus relative to the user interface (such as the orientation of the electronic stylus in FIG. 6G), and the second spatial arrangement of the palette user interface corresponds to a fourth orientation of the palette user interface relative to the user interface (such as the orientation of palette user interface 618 in FIG. 6G). In some embodiments, the orientation of the electronic stylus includes the tilt angle of the electronic stylus (described in further below). In some embodiments, the orientation of the electronic represents a component of the pose of the electronic stylus (the location of the stylus representing another component). In some embodiments, the orientation of the electronic stylus refers to the orientation of the electronic stylus relative to a reference vector on the X-Y plane of the device (for instance a vertical vector). For instance, if a vector is drawn through a central axis of the electronic stylus, and that vector is projected onto the X-Y plane of the device, then the orientation of the electronic stylus would be characterized at least in part by the orientation of the projected vector in relation to the reference vector (e.g., axis) on the X-Y plane. For instance, if a circle were drawn around the reference vector on X-Y plane, the orientation (in-part), would be defined by the orientation of the projected vector of the electronic stylus relative to the reference vector such that if the stylus were pointed in the same direction as the reference vector, the orientation (which is comprised of the tilt angle) would be 0°. If the stylus were point in the opposite direction as the reference vector, the tilt angle (which makes up a portion of the orientation) would be 180°. If the electronic stylus were facing in a direction that is perpendicular to the reference vector, the tilt angle would be 90 or 180° depending on which direction the electronic stylus was facing. In some embodiments, in order to ensure that the palette user interface is visible to the user when it is displayed, the electronic device displays the palette user interface at the second orientation such that a difference between the orientations of electronic stylus and the palette user interface is obtuse and/or perpendicular (e.g., greater than or equal to) 90°. In some embodiments, the orientation of the palette user is defined by the electronic device such that the difference between the orientations of the palette user interface when displayed and the electronic stylus is a predefined value (e.g., 90, 100, 150, 180, 270°). Displaying the palette user with a spatial arrangement with respect to the user interface based on the orientation of the electronic stylus allows for the palette user interface to be displayed on the electronic device at a location that minimizes the likelihood that one or more portions of the palette user interface will be visually occluded when displayed thus reducing the need for inputs to manually move/reorient the palette, thus minimizing the occurrence of erroneous user input associated with visual occlusions to the palette user interface and/or input to reorient/move the palette, and thereby conserving computing resources associated with correcting erroneous input.

In some embodiments, the electronic device selects the first spatial arrangement such that the palette user interface is visually unimpeded by one or more portions of the user holding the electronic stylus in the first pose relative to the user interface such as how palette user interface 618 is visually unimpeded by hand 610 in FIGS. 6B and 6G. In some embodiments, the electronic device uses information regarding the first pose (e.g., the location and orientation of the stylus) to estimate the location of the user's hand relative to the display generation component and displays the palette user interface at a location and/or orientation to minimize or reduce the likelihood that the user's hand will visually occlude the palette user interface when it is displayed on the electronic device. In some embodiments, and based on the determined first pose, the electronic device estimates the position of the user's head and/or eyes based on an assumed correspondence between the position of the user's hand and the position of the user's head. Using the estimated position, the electronic device optionally displays the palette user interface in a location and/or orientations that it determines will not be visually occluded by the user's hand. As an example, the orientation of stylus with respect to the device and/or user interface will be different depending on if the user is right-handed or left-handed. In some embodiments, the device determines (via a determination of the first pose) which hand of the user is controlling the stylus and displays the palette user interface to the opposite side of the stylus to avoid visual occlusion of the palette user interface. If the device determines that the right hand is controlling the stylus (based on the orientation of the stylus), the device optionally displays the palette user interface to the left of the determined pose of the stylus to thereby avoid visual occlusion of the palette user interface by the user's right hand. If the device determines that the left hand is controlling the stylus (based on the orientation of the stylus), the device optionally displays the palette user interface to right of the determined pose of the stylus so as to avoid visual occlusion of the palette user interface by the user's left hand. Similarly, the second spatial arrangement is similarly determined based on the orientation of the stylus in substantially the same manner as the first spatial arrangement was determined. Displaying the palette user interface so as to minimize the likelihood of visual occlusion of the palette user interface by a portion of the user reduces the need for inputs to manually move/reorient the palette, thus minimizing the occurrence of erroneous user input associated with visual occlusions to the palette user interface and/or input to reorient/move the palette, and thereby conserving computing resources associated with correcting erroneous input.

In some embodiments, determining that the pose of the electronic stylus is the first pose relative to the user interface comprises determining a tilt angle of the electronic stylus relative to the user interface and wherein the first spatial arrangement of the palette user interface is based on the determined tilt angle of the electronic stylus such as the spatial arrangement of palette user interface in response to the tilt angle (e.g., orientation 616) in FIG. 6B. In some embodiments, and as described above, the pose of the electronic stylus consists of the location of the electronic stylus relative to the user interface and/or display, as well as the orientation of the electronic stylus with respect to the user interface and/or display. In some embodiments, the orientation of the stylus is characterized by the tilt angle of the electronic relative to the user interface. The tilt angle refers to the angle between the major/central axis of the electronic stylus when projected onto the X-Y plane of the device and a reference axis that is defined by a line that is on the X-Y plane formed by the device (e.g., such as a vertical line). As described above, the tilt angle is defined using a circle around the reference axis such that the point in the circle where the central axis of the stylus (when projected onto the X-Y plane) crosses the circle defines the tilt angle (e.g., from 0 to 360°) As an example, a stylus that is oriented directed to the right side of the device would have a tilt angle of 90°, a stylus that is oriented directly towards the bottom of the user interface/device would have a tilt angle of 180°, a stylus that is orientated to the left would have a tilt angle of 270°, and stylus that is orientated away from the user would have a tilt angle of 0/360°. Additionally or alternatively, the reference axis can be defined in any orientation and is not limited to an axis that is vertical on the X-Y plane of the display of the device or the user interface. In some embodiments, the determined tilt angle of the stylus is used by the device to determine a location and orientation at which to display the palette user interface, as described in further detail below. In some embodiments, determining that the electronic stylus is the second pose relative the user interface (described above) comprises determining the tilt angle of the electronic stylus relative to the user interface, and the second spatial arrangement of the palette user interface is based on the determined tilt angle of the electronic stylus. Determining the tilt angle of the electronic stylus and using the tilt angle specifically to determine a spatial arrangement to display the palette user interface reduces the need for inputs to manually move/reorient the palette, thus minimizing the occurrence of erroneous user input associated with visual occlusions to the palette user interface and/or input to reorient/move the palette, and thereby conserving computing resources associated with correcting erroneous input.

In some embodiments, displaying the palette user interface with the first spatial arrangement relative to the palette user interface comprises: determining a first vector, wherein the first vector is based on the determined tilt angle of the electronic stylus, and determining the first spatial arrangement such that a center of the palette user interface aligns with the determined first vector such as tip 624 of stylus 604 being aligned with the center 622 of palette user interface 618 in FIG. 6B.

In some embodiments, the device after determining the pose of the electronic stylus including the location and tilt angle, uses the determination to orient the palette user interface such that the palette user interface is aligned with the pose of the electronic stylus. For example, the central axis of the electronic stylus is determined based on the determined tilt angle and is projected onto the X-Y plane of the device, display, and/or user interface thereby forming the first vector, which will be a line on the X-Y plane. In some embodiments, the first vector extends from the portion of the X-Y plane where the tip of the electronic stylus is above, through the entire X-Y plane formed by the display and/or user interface. The location of the stylus (the location of the tip of the stylus) is then used in conjunction with the first vector to determine the spatial arrangement of the palette user interface such that the first vector goes through a center (or other predefined portion) of the palette user interface. For instance, using the first vector and the location of the tip of the stylus, the device will display the palette user interface such that it is on one side of the stylus tip (the side being determined by the tilt angle as described above) and such that the center of the palette user interface aligns with the first vector (e.g., the first vector runs through the center of the palette user interface.) In some embodiments, the center of the palette user interface refers to the centroid of the palette user interface, the center of a circle or other shape that bounds the palette user interface, or any portion or point that is part of the palette user interface. In some embodiments, displaying the palette user interface with the second spatial arrangement relative to the palette user interface comprises determining a second vector, different from the first vector that is based on the determined tilt angle of the electronic stylus, and determining the second spatial arrangement such that the center of the palette user interface aligns with the determined second vector. Aligning the center of the palette user interface with the first vector reduces the need for inputs to manually move/reorient the palette and also ensure consistent placement of the palette user interface, thus minimizing the occurrence of erroneous user input associated with visual occlusions to the palette user interface and/or input to reorient/move the palette, and thereby conserving computing resources associated with correcting erroneous input.

In some embodiments, displaying the palette user interface with the first spatial arrangement relative to the user interface comprises: in accordance with a determination that a first hand of the user is holding the electronic stylus (such as the right hand 610 of the user is holding stylus 604 in FIG. 6B), the electronic device displays the palette user interface at a first orientation relative to the user interface, and in accordance with a determination that second hand of the user (such as the left hand 630 of the user holding stylus 604 in FIG. 6G), different from the first hand, is holding the electronic stylus, the electronic device displays the palette user interface at a second orientation, different from the first orientation, relative to the user interface (compare the orientation of palette user interface 618 in FIG. 6B versus FIG. 6G). In some embodiments, the tilt angle (described above) is used to determine which hand of the user (right or left) is being used to operate the electronic stylus. For instance, if the tilt angle is between 0 and 180° (e.g.) towards the right of the device/user interface, the device determines that the user is using their right hand to operate the electronic stylus. In the case where the tilt angle is between 18° and 360°, the device determines that the device determines that the user is using their left hand to operate the electronic stylus. In some embodiments, and as described above, in the case of the device determining that the user is using their right hand, the first orientation arrangement will be to the left of the stylus location to ensure that the user's right hand does not visually occlude the palette user interface. Similarly, if the device determines that that the user is using their left hand, the second orientation will be to the left of the stylus' location to ensure that the user's left hand does not visually occlude the palette user interface. In some embodiments, displaying the palette user interface with the second spatial arrangement relative to the user interface similarly comprises determining that a first or second hand of the user is holding the electronic stylus, and displaying the palette user interface at a third and/or fourth orientation, different from the first/second orientation relative to the user interface, based on which hand is determined to be holding the stylus. In some embodiments, the determination as to which hand is holding the electronic stylus is based on a setting on the electronic device (indicating which hand the user prefers to use) and/or sensor(s) on the electronic stylus (e.g., touch sensors) that detect how the stylus is being held. Determining which hand the user is using to operate the stylus and setting the spatial arrangement of the palette user interface accordingly to ensure that the hand does not visually occlude the electronic stylus, reduces the need for inputs to manually move/reorient the palette, thus minimizing the occurrence of erroneous user input associated with visual occlusions to the palette user interface and/or input to reorient/move the palette, and thereby conserving computing resources associated with correcting erroneous input.

In some embodiments, displaying the palette user interface with the first spatial arrangement comprises displaying one or more selectable options of the palette user interface in a first order (such as the order of the selectable options of palette user interface 618 in FIG. 6B), and displaying the palette user interface with the second spatial arrangement comprises displaying the one or more selectable options of the palette user interface in a second order (such as the order of the selectable options of palette user interface 618 in FIG. 6G), different from the first order. In some embodiments, the order in which the selectable options are displayed refers to the order, starting from the left side of the palette user interface to the right side of the palette user interface, that the selectable options are displayed in. Additionally or alternatively, the order in which the selectable options are displayed refers to the order, starting from a first end of the palette user interface to a second end of the palette user interface, that the selectable options are displayed in. In some embodiments, the electronic device displays the selectable options of the palette user interface such that a first selectable option (such as an undo button described in further detail below) is closest to the tip of the stylus, a second selectable option (such as a selectable option to select a tool) is displayed second closes to the tip of the stylus, a third selectable option is displayed the third closest. This means that if the palette user interface is displayed to the right of the tip of the stylus, the selectable options will be displayed in a first order (e.g., from left to right the first selectable option, the second selectable option, and the third selectable option), however if the palette user interface is displayed to the left of the tip of the stylus, the selectable options will be displayed in an order that is a mirror image of the order that the selectable options were displayed in when the palette user interface was displayed to the right (e.g., from left to right—the third selectable option, the second selectable option, and the first selectable option.) In some embodiments, reordering of the selectable options includes modifying the order of the undo button and the redo button such that the undo button is always to the left of the redo button no matter the orientation at which the palette user interface is displayed. In some embodiments, only the undo and redo buttons are reordered based on the orientation of the stylus, while other buttons are not (e.g., only a first subset of the buttons is reordered while a second subset of buttons is not). Reordering the selectable options of the palette user interface based on the spatial arrangement of the palette user interface with respect to the device/user interface, reduces the likelihood of erroneous input associated with displaying the selectable options in different orders corresponding to different spatial arrangements, and thereby conserving computing resources associated with correcting erroneous input.

In some embodiments, the one or more criteria include a criterion that is satisfied when the electronic stylus is within a first threshold distance from the user interface when the first input is received and in response to receiving the first input: in accordance with a determination that the one or more criteria are not satisfied because the electronic stylus is beyond the first threshold distance from the user interface of the content creation application when the first input is received: the electronic device displays the palette user interface with a third spatial arrangement relative to the user interface of the content creation application, wherein the third spatial arrangement is based on a third pose of the electronic stylus relative to the user interface prior to when the first input was received and wherein the electronic stylus was within the first threshold distance from the user interface when the electronic stylus was at the third pose as illustrated by the orientation of palette user interface 618 in FIG. 6E in response to squeeze input 603. In some embodiments, if the electronic stylus is beyond a threshold distance away from the device/user interface (e.g., beyond 0, 0.01, 0.05, 0.1, 0.2, 0.5, 0.8, 1, 3, 5, 10, 30, 50 or 100 cm) when the first input is received, the device, instead of using the tilt angle (e.g., orientation) and/or location of the stylus at the time the first input was received, instead uses the last known pose of the stylus when the electronic stylus was within the threshold distance away from the device/user interface for placing the palette user interface. For instance, if the user has pulled the stylus away from the device, but performs a squeeze gesture at the stylus (as described above), then there is a minimal chance that the user's hand will visually occlude the palette user interface when it is displayed (since the user's hand is likely not covering a portion of the device) thus obviating the need to display the palette user interface at a spatial arrangement that is based on the orientation/location of the stylus (e.g., pose) at the time the first input is received. Thus, in some embodiments, when the electronic stylus is beyond a threshold hold distance away from the device/user interface, the device displays the palette user interface at a spatial arrangement based on the pose of the stylus at the last known moment in time when the stylus was within the threshold distance, thus placing the palette user interface at a location this likely based on the last input to the user interface (e.g., the content creation application) that was applied by the electronic stylus. Displaying the palette user interface at a spatial arrangement that is based on the last known pose of the stylus when the stylus is beyond a threshold distance away from the device/user interface minimizes the likelihood that the user will manually move/reorient the palette user interface, thus minimizing the occurrence of erroneous user input associated input to reorient/move the palette, and thereby conserving computing resources associated with correcting erroneous input.

In some embodiments, the one or more criteria include a criterion that is satisfied when the electronic stylus is within a first threshold distance from the user interface when the first input is received. In some embodiments, in response to receiving the first input: in accordance with a determination that the one or more criteria are not satisfied because the electronic stylus is beyond the first threshold distance from the user interface of the content creation application when the first input is received: the electronic device displays the palette user interface with a third spatial arrangement relative to the user interface of the content creation application, wherein the third spatial arrangement is based on a previous spatial arrangement of the palette user interface relative to the user interface displayed by the electronic device prior to receiving the first input such as the orientation of palette user interface 618 in FIG. 6J in response to squeeze input 603 illustrated in FIG. 6I. In some embodiments, when the electronic stylus is beyond a threshold distance away from the device/user interface (as described above), the device displays the palette user interface at the last location the palette user interface was displayed (and subsequently removed from being displayed) previous to receiving the first input. In some embodiments, in the event that the palette user interface had not been previously displayed, the device displays the palette user interface (when the electronic stylus is beyond the threshold distance) at a default location such as in the center of the device/display. In some embodiments, displaying the palette user interface at the last location it was displayed prior to receiving the first input when the electronic stylus is beyond a threshold distance away from the device/user interface minimizes the likelihood that the user will opt to manually move the palette user interface once it is displayed by the device. Displaying the palette user interface at a spatial arrangement that is based on the last known location that the palette user interface was displayed when the stylus is beyond a threshold distance away from the device/user interface minimizes the likelihood that the user will manually move/reorient the palette user interface, thus minimizing the occurrence of erroneous user input associated input to reorient/move the palette, and thereby conserving computing resources associated with correcting erroneous input.

In some embodiments, the one or more criteria include a criterion that is satisfied when the electronic is within a first threshold distance from the user interface when the first input is received. In some embodiments, and in response to receiving the first input: in accordance with a determination that the one or more criteria are not satisfied because the electronic stylus is beyond the first threshold distance from the user interface of the content creation application when the first input is received, the electronic device forgoes display of the palette user interface such as if in response to the squeeze input 603 illustrated in FIG. 6I, the palette user interface was not displayed. In some embodiments, when the electronic stylus is beyond the threshold distance away from the device/user interface (as described above), in response to receiving the first input, the device ignores the first input and does not display the palette user interface. Additionally or alternatively, the device performs an action in response to the first input that is pre-determined to be performed when the first input is received and the electronic stylus is beyond the threshold distance away from the device/user interface for instance changing the tool associated with the electronic stylus to a previously used tool (as an example). Forgoing display of the palette user interface when the first input is received and when the stylus is beyond a threshold distance away from the device/user interface avoids the inputs required to manually orient the palette once it is displayed, thus minimizing the occurrence of erroneous user input associated input to reorient/move the palette, and thereby conserving computing resources associated with correcting erroneous input.

In some embodiments, the one or more criteria include a criterion that is satisfied when the electronic stylus is beyond a first threshold distance from the user interface when the first input is received. In some embodiments, in response to receiving the first input: in accordance with a determination that the one or more criteria are not satisfied because the electronic stylus is touching (e.g., in contact with) the user interface of the content creation application when the first input is received, the electronic device forgoes display of the palette user interface such as in FIG. 6L in response to squeeze input 603 being received when the stylus 604 is below the threshold distance in FIG. 6K. In some embodiments, the palette user interface is only displayed by the device when the stylus is not actively providing input to the content creation application, and thus, the palette user interface is only displayed or caused to be displayed when the electronic stylus is hovering above the user interface without touch it. In some embodiments, “touching” the display generation component refers to the electronic stylus being within a second threshold distance (e.g., 0, 0.1, 1 cm) away from the electronic device, such that hovers with the stylus that are very near to but not technically touching the device/user interface will be considered touching the user interface for the purposes of deciding to forgo display of the palette user interface in response to the first input. In some embodiments, the second threshold distance is less than the first threshold distance. Forgoing display of the palette user interface when the first input is received and when the stylus is touching the device/user interface minimizes the likelihood that display of the palette user interface will interrupt or disturb inputs to the content creation application, thus minimizing the occurrence of erroneous user input associated input to correct erroneous input, and thereby conserving computing resources associated with correcting erroneous input.

In some embodiments, receiving the first input comprises determining that the user of the electronic device is performing a squeeze input on a surface of the electronic stylus such as squeeze input 603 illustrated in FIG. 6A. In some embodiments, a squeeze input refers to the user tightening and then relaxing their grip on the electronic stylus. In some embodiments, the electronic stylus comprises one or more components that are configured to detect a user's application of manual pressure or squeeze of a specified/predetermined area on the surface of the stylus. Optionally, the pressure detection components are configured to detect the application of pressure, the release of pressure, the force of the pressure, and the duration of the pressure. In some embodiments, the one or more components are located along a portion of the electronic stylus such that a squeeze input along the portion will cause the device to display the palette user interface, whereas a squeeze input that is outside of the portion will not cause the device to display the palette user interface. In some embodiments, the squeeze input consists of a predefined number of squeezes of the electronic stylus, such that the palette user interface is displayed when the user squeezes the electronic stylus the predefined number of times (with each squeeze occurring within a predefined time of one another.) Additionally or alternatively, in addition to and/or alternatively to a squeeze (as described above), the squeeze input comprises other tactile inputs to the electronic stylus such as a tap (with the user's finger), a barrel roll (turning the electronic stylus between the fingers of the user), and a swipe (running a portion of the user's finger across the electronic stylus). In some embodiments, the squeeze input includes squeezing and/or pushing mechanical button that is located along the side of the electronic stylus. In some embodiments, the squeeze required for the device to determine that a squeeze input has been performed is a squeeze that includes a squeeze intensity above a predefined squeeze strength/intensity threshold. If the squeeze is below the predefined threshold, the device optionally does not register a squeeze input as having occurred. Using squeeze inputs to determine the user's intent to open the palette user interface, minimizes the likelihood of the device erroneously displaying the palette users interface when the user does not intend to do so thus reducing the need for inputs to manually minimize or cease display of the palette user interface, thus minimizing the occurrence of erroneous user input associated with input to minimize/cease display of the palette user interface, and thereby conserving computing resources associated with correcting erroneous input.

In some embodiments, displaying the palette user interface with the first spatial arrangement relative to the user interface comprises: in accordance with a determination that a squeeze intensity associated with the first input is a first squeeze intensity, the electronic device displays the palette user interface at a first animation speed, and in accordance with a determination that the squeeze intensity associated with the first input is a second squeeze intensity, different from the first squeeze intensity, the electronic device displays the palette user interface at a second animation speed, different from the first animation speed such as if the speed at which palette user interface 618 in FIG. 6B were dependent on the squeeze intensity. In some embodiments, receiving a squeeze input (described above) includes receiving information about the squeeze intensity associated with the squeeze input. In some embodiments, the squeeze intensity refers to a quantitative measure of the strength of the squeeze (e.g., the amount of force applied to the electronic stylus when the squeeze input is performed). In some embodiments, the display speed of the palette user interface refers to the amount of time between when a portion of the palette user interface is first displayed by the device until the entirety of the palette user interface is displayed (e.g., the speed corresponds to the length of the animation for displaying the palette). A faster speed indicates that the time from when an initial portion of the palette user interface is displayed to the entire palette user interface is displayed is shorter than a slower speed. In some embodiments, the palette user interface is displayed by the device according to an animation sequence. For instance, as part of the animation sequence, initially only a center portion of the palette user interface is displayed and gradually over time the display of the palette user interface expands out (gradually revealing more of the palette user interface) from the center portion until eventually the entirety of the palette interface is displayed. The speed of the display, using the above example, refers to the speed of the animation, and specifically the time it takes from when the center portion is initially displayed until the entirety of the palette user interface is displayed. In some embodiments, the display speed is proportional to the squeeze intensity associated with the first input, such that a harder squeeze will cause the device to display the palette user interface at a faster speed than if the squeeze intensity was softer. In some embodiments, and similarly to the first spatial arrangement, displaying the palette user interface with the second spatial arrangement (described above) comprises determining that the second input has a third or fourth squeeze intensity, such the palette user interface is displayed at a third or fourth animation speed that is based on the third or fourth squeeze intensity, respectively. Using squeeze intensity to determine the speed at which the palette user interface, provides another method of communication between the user and the device about the user's intent, thus minimizing the likelihood of the device erroneously displaying the palette users interface abruptly when the user does not intend to do so thus reducing the need for inputs to manually minimize or cease display of the palette user interface, thus minimizing the occurrence of erroneous user input associated with input to minimize/cease display of the palette user interface, and thereby conserving computing resources associated with correcting erroneous input.

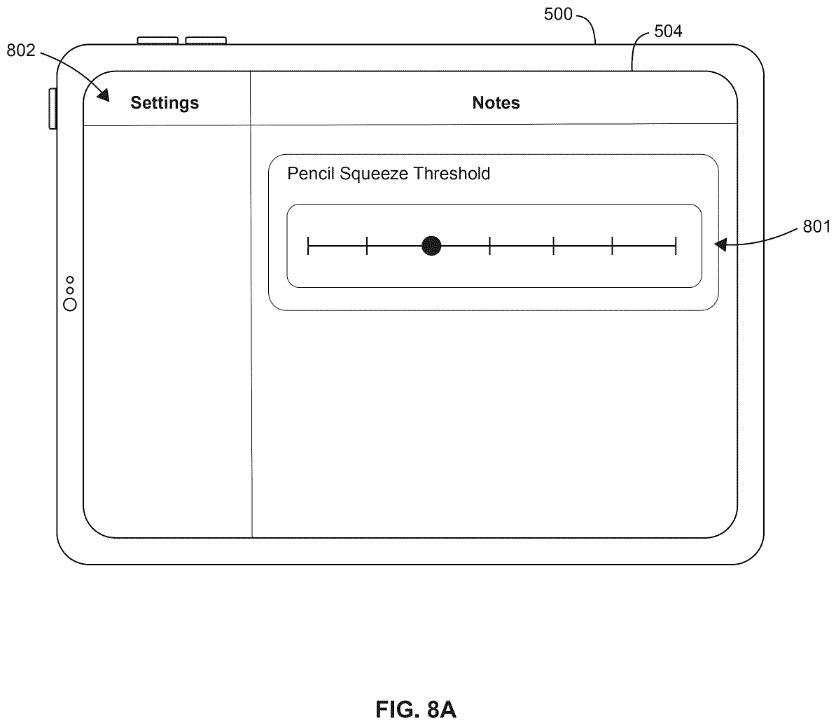

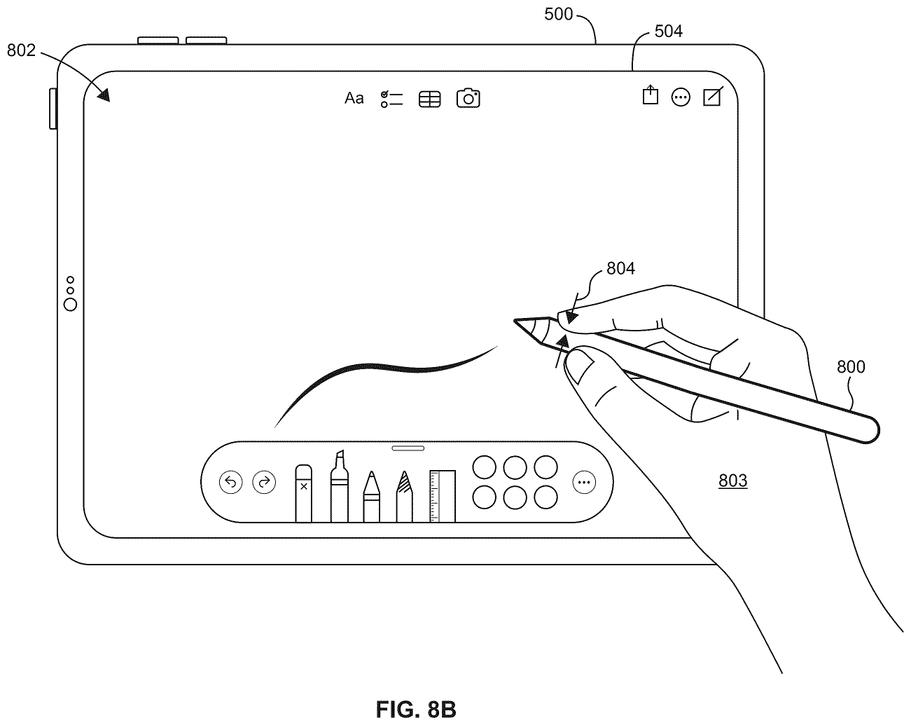

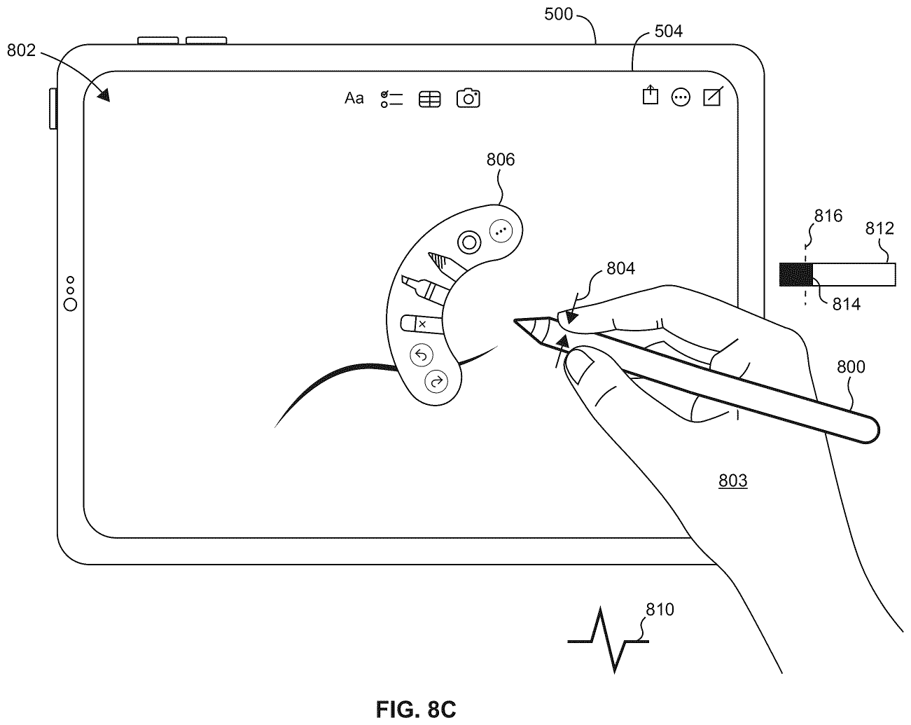

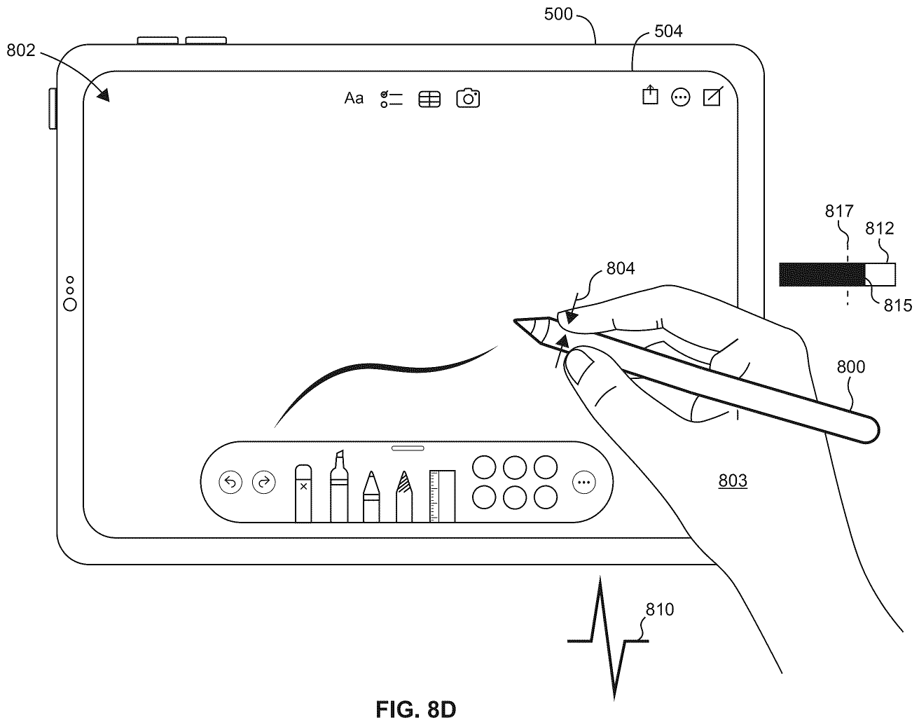

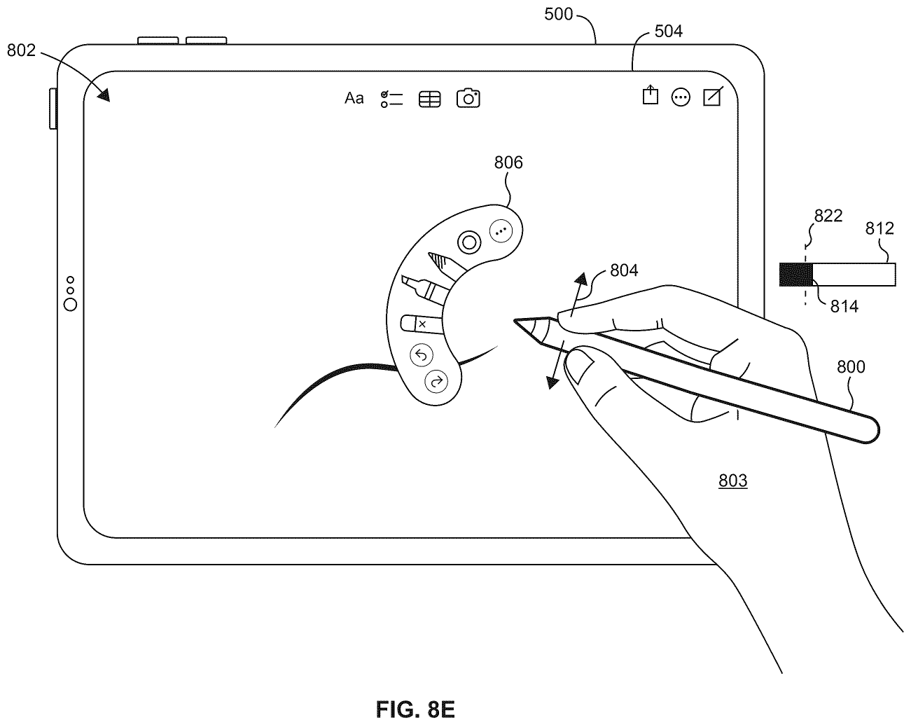

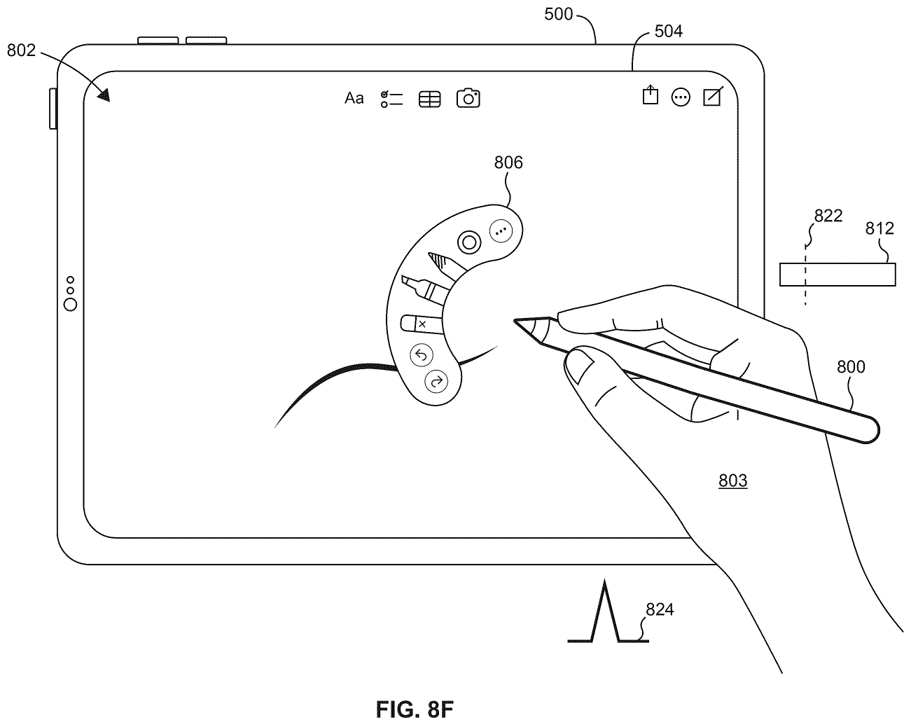

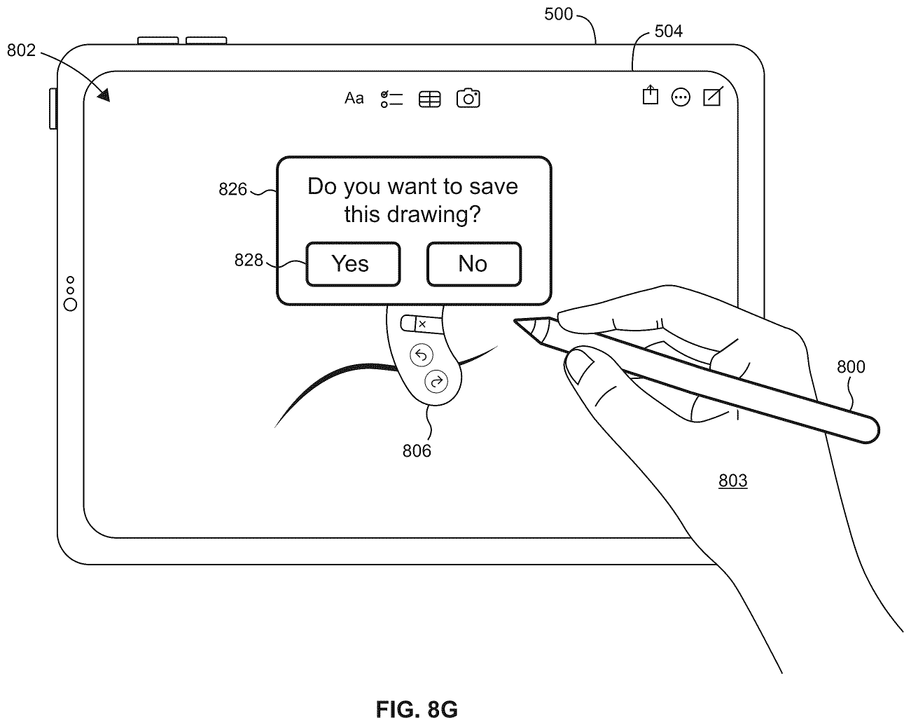

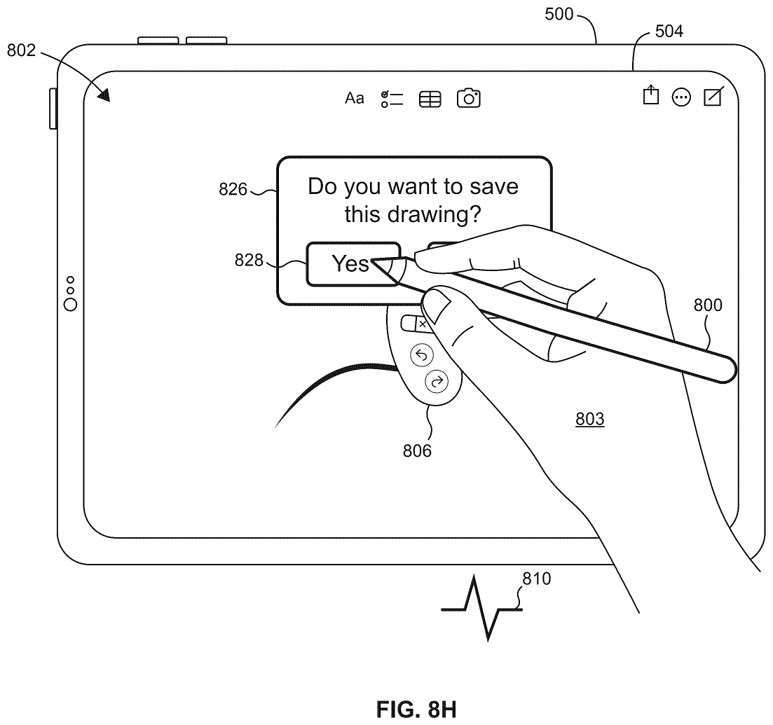

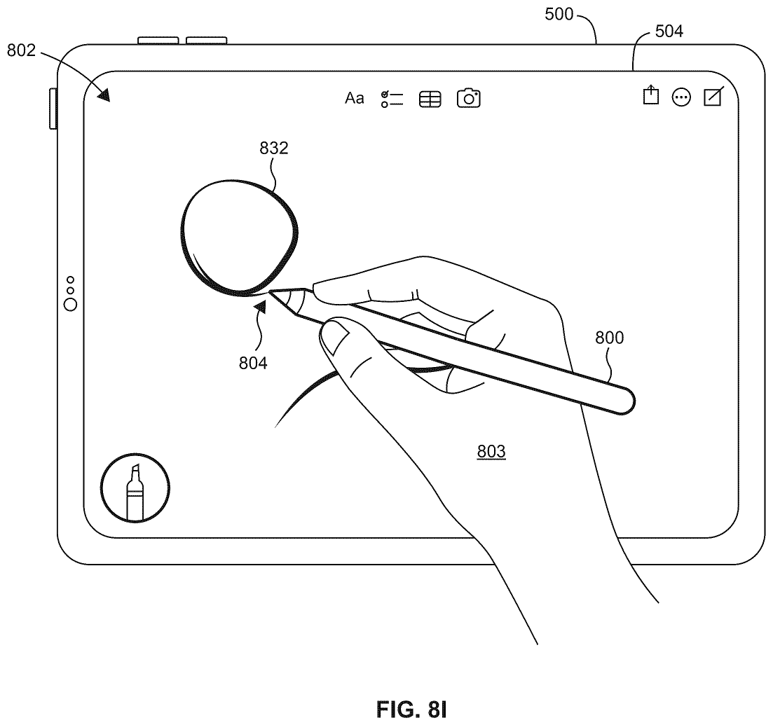

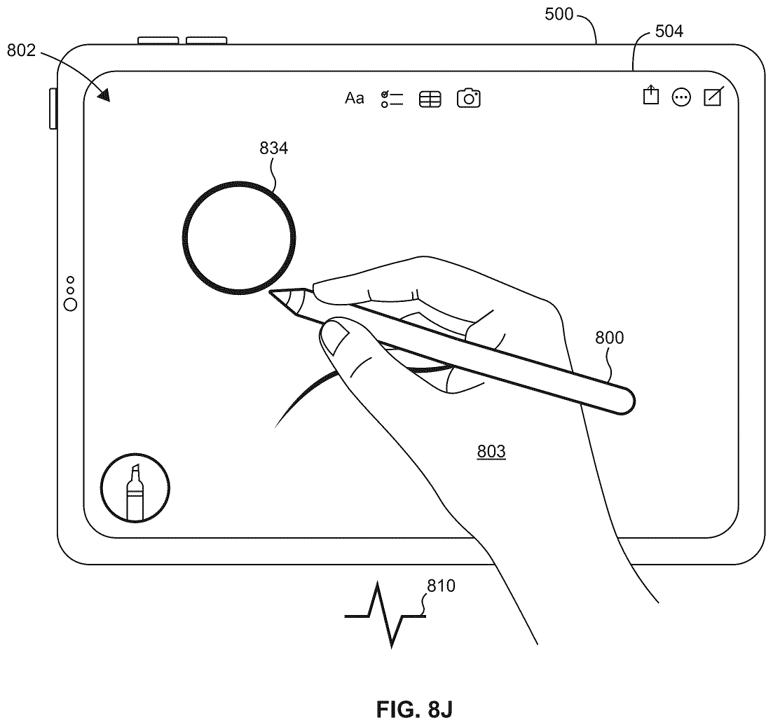

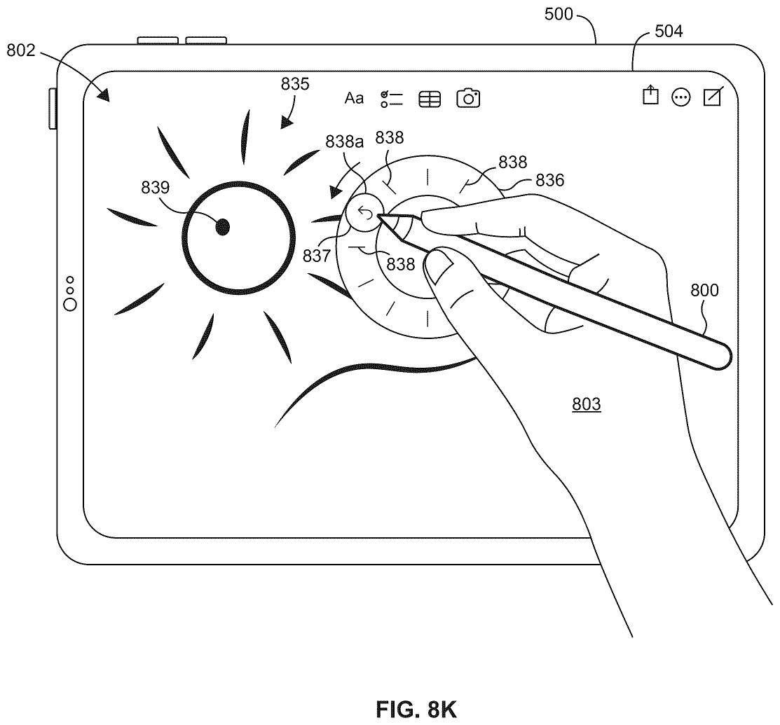

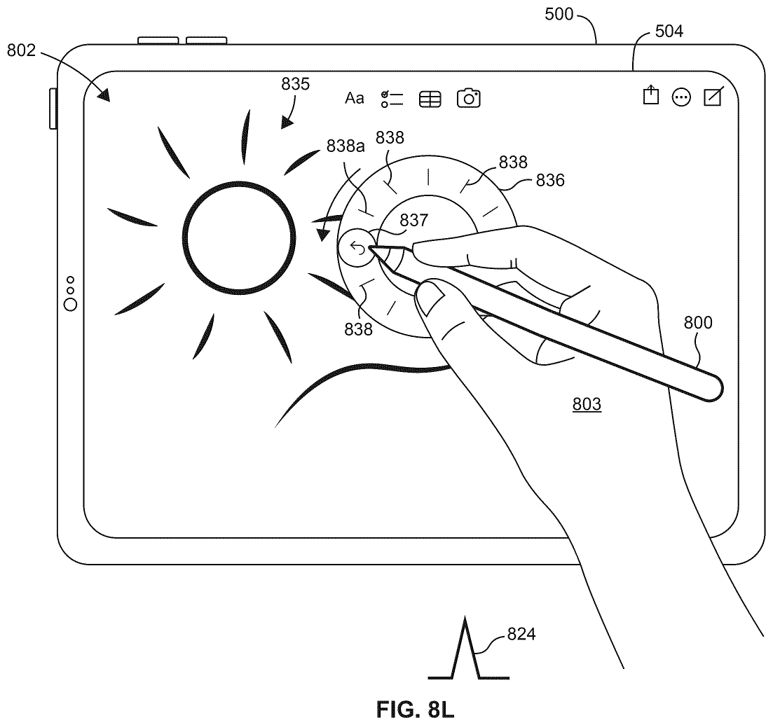

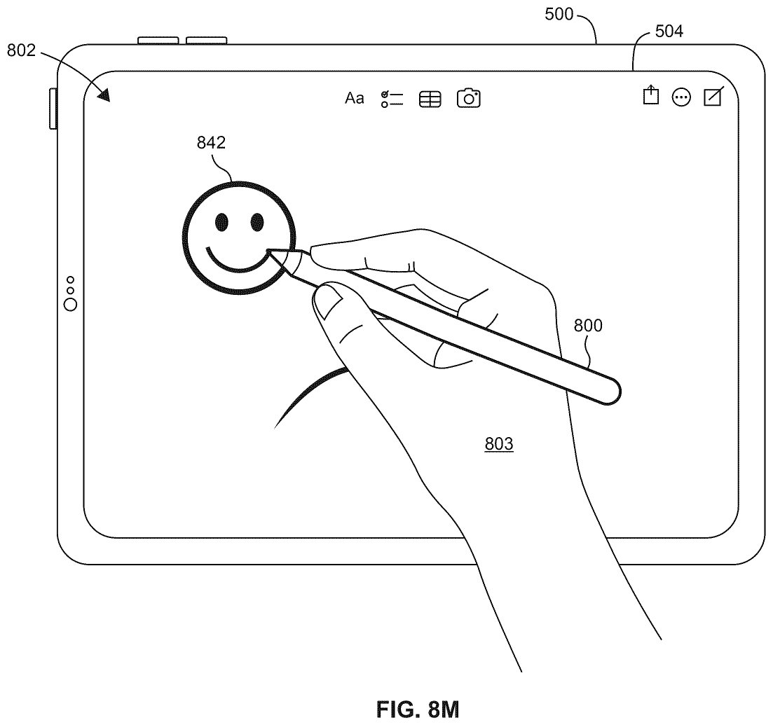

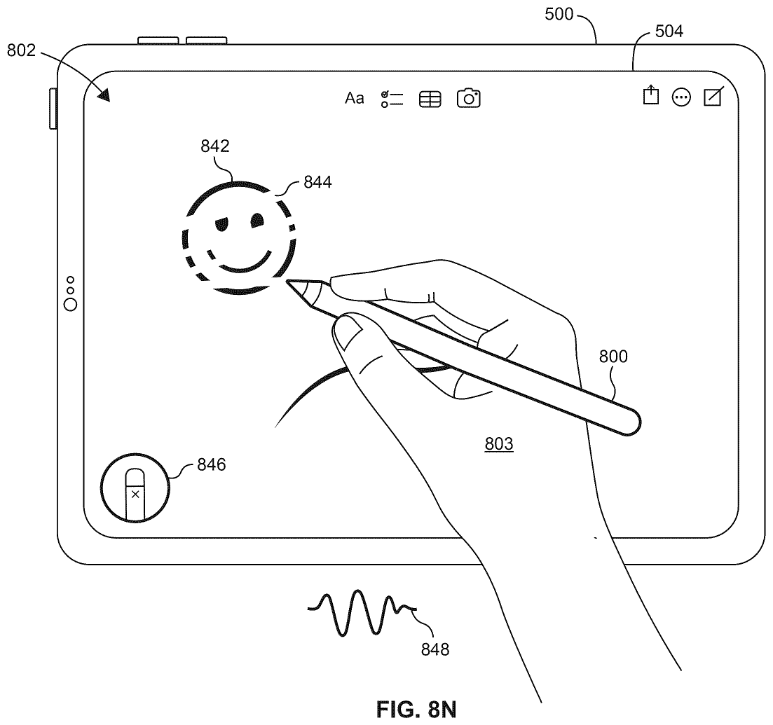

In some embodiments, the one or more criteria include a criterion that is satisfied when a squeeze intensity of the first input is above a squeeze intensity threshold, wherein the squeeze intensity threshold is user-defined for instance using a squeeze intensity threshold interface 801 in FIG. 8A. In some embodiments, the user-defined squeeze intensity threshold defines a threshold for squeeze intensity (described above) that when exceeded causes the palette user interface to be displayed by the device. In some embodiments, if the squeeze intensity is below the squeeze intensity threshold, the device will forgo display of the palette user interface despite the user having performed the physical act (e.g., a squeeze on the stylus) associated with the squeeze input. In some embodiments, the user defines the squeeze intensity threshold using a squeeze intensity threshold user interface configured to facilitate the user entering a threshold (described with respect to method 1100 below). In some embodiments, receiving the user-defined squeeze threshold includes receiving an input from the user at the squeeze intensity threshold user interface indicating a preferred threshold. Using a user-defined squeeze intensity threshold to determine when to open the palette user interface, minimizes the likelihood of the device erroneously displaying the palette users interface when the user does not intend to do so thus reducing the need for inputs to manually minimize or cease display of the palette user interface, thus minimizing the occurrence of erroneous user input associated with input to minimize/cease display of the palette user interface, and thereby conserving computing resources associated with correcting erroneous input.

In some embodiments, the first input is a first type of input. In some embodiments, while the palette user interface is being displayed by the display generation component, the electronic device receives a second input, via the electronic stylus, wherein the second input is the first type of input; and in response to receiving the second input, the electronic device ceases display of the palette user interface on the display generation component such as in FIG. 6C in response to the squeeze input 603 provided in FIG. 6B. In some embodiments, the same squeeze input (e.g., the first type of input) that was used to cause the palette user interface to be displayed is also used to close the palette user interface (e.g., cause the palette user interface to cease being displayed). In some embodiments, the same squeeze intensity threshold, described above, is used to determine that a squeeze input has occurred causing the palette user interface to cease being displayed. Thus, in some embodiments, the requirements and elements of a squeeze input described above that are used to determine when to display the palette user interface are also used to determine when to cease displaying the palette user interface. In some embodiments, the palette user interface closes irrespective of where the stylus is located relative to the user interface (e.g., far/close) when the second input is received and/or irrespective of whether the one or more criteria are satisfied when the second input is received. Using squeeze inputs to determine the user's intent to close the palette user interface, minimizes the likelihood of the device erroneously closing the palette users interface when the user does not intend to do so thus reducing the need for inputs to manually cause the display of the palette user interface, thus minimizing the occurrence of erroneous user input associated with input to minimize/cease display of the palette user interface, and thereby conserving computing resources associated with correcting erroneous input.

In some embodiments, while the palette user interface is being displayed by the display generation component, the electronic device detects that the electronic stylus is being used to provide handwritten input to the user interface of the content creation application, and in response to detecting that the electronic stylus is being used to provide handwritten input to the user interface of the content creation application, the electronic device ceases display of the palette user interface and displaying a representation of the handwritten input in the user interface of the content creation application such as in FIG. 6H in response to stylus 604 coming into contact with display 504. In some embodiments, the handwritten input refers to drawing or writing on the content creation application thereby causing new visual outputs by the content creation application. In some embodiments, determining that the electronic stylus is being used to generate handwritten input comprises determining that the electronic stylus is within a threshold distance (e.g., 0.1 mm, 1 mm, 10 mm, 1 cm) from the display/user interface (described above with respect to examples of “touching”) and/or in contact with the user interface and/or that the stylus is moving across the user interface of content creation application thereby signaling the intent of the user to generate a visual output on the device using the electronic stylus. In some embodiments, when the device determines that the user is applying an input to the device consistent with handwritten input in the content creation application, the device ceases display of the palette user interface so that the palette user interface does not disturb or interfere with the user's input to the electronic device. Ceasing display of the palette user interface when the device determines that user is generating handwritten input on the user interface of the content creation application minimizes the likelihood that display of the palette user interface will interrupt or disturb inputs to the content creation application, thus minimizing the occurrence of erroneous user input associated input to correct erroneous input, and thereby conserving computing resources associated with correcting erroneous input.

In some embodiments, while displaying, via the display generation component, the user interface associated with the content creation application and before receiving the first input, the electronic device displays an expanded palette user interface and in response to displaying the palette user interface, the electronic device ceases display of the expanded palette user interface such as expanded palette user interface 612 in FIG. 6A no longer being displayed in FIG. 6B in response to palette user interface 618 being displayed. In some embodiments, when the palette user interface is not being displayed, the device displays an expanded palette user interface (for instance at the bottom of the user interface of the content creation application). In some embodiments the expanded palette user interface is larger in size than the palette user interface and includes more selectable options pertaining to various functions of the electronic stylus than the palette user interface. In some embodiments, when the palette user interface is not being displayed, the expanded palette user interface is displayed so as to visually occlude a portion of the user interface of the content creation application that accepts inputs from the electronic stylus. In some embodiments, the user when engaging with the user interface of the content creation application, can select one or more of the selectable options on the expanded palette user interface (rather than invoking display of the palette user interface). Optionally, the expanded palette user interface includes a plurality of selectable options, including but not limited to the selectable options described above with respect to the palette user interface. In some embodiments, when the device displays the palette user interface, the device simultaneously ceases display of the expanded palette user interface. Since the palette user interface is closer to the stylus (due to the palette user interface being displayed at a spatial arrangement that is based on the pose of the stylus as described above), ceasing display of the expanded palette user interface makes more of the user interface of the content creation visible to the user. In some embodiments, the expanded palette user interface immediately ceases to be displayed when the palette user interface is displayed. Additionally or alternatively, the expanded palette user interface is faded out (e.g., ceases to be displayed gradually over time) in response to the palette user interface being displayed. In some embodiments, the time over which the expanded palette user interface is faded out is based on the display speed that the palette user interface is displayed at (described above). Ceasing display of the expanded palette user interface when the palette user interface is displayed causes more of the user interface of the content creation application to be visible thus minimizing the likelihood of erroneous input caused by visual occlusions to the user interface of the content creation application, thus minimizing the occurrence of user input to correct erroneous input, and thereby conserving computing resources associated with correcting erroneous input.

In some embodiments, while displaying the palette user interface and while the expanded palette user interface is not displayed, the electronic device receives, via the one or more input devices, an indication to cease displaying the palette user interface, and in response to receiving the indication to cease displaying the palette user interface, the electronic device displays the expanded palette user interface such as if expanded palette user interface 612 being displayed in response to squeeze input 603 being received in FIG. 6B. In some embodiments, the speed at which the expanded palette user interface is re-displayed in response to ceasing display of the palette user interface is based on the speed at which the palette user interface removed from being displayed by the electronic device. For instance, if the palette user interface abruptly and/or instantly ceased being displayed, the expanded palette user interface will abruptly and/or instantly be re-displayed by the device. Displaying the expanded palette user interface when the palette user interface ceases to be displayed, ensures that the user can efficiently access various settings and options associated with the electronic stylus without always requiring the user to initiate the display of the palette user interface, thus minimizing the likelihood of erroneous input caused having to always re-initiate display of the palette user interface every time the user wants to change a setting or access a feature associated with the electronic stylus, thus minimizing the occurrence of user input to correct erroneous input, and thereby conserving computing resources associated with correcting erroneous input.

In some embodiments, displaying the expanded palette user interface in response to receiving the indication to cease displaying the palette user interface comprises displaying the expanded palette user interface in a compressed state such as the state illustrated at 628 in FIG. 6C. In some embodiments, the compressed state of the expanded palette user interface refers to a state in which less selectable options are visible on the expanded palette user interface than when the expanded palette user interface is displayed in its full and uncompressed state. For instance, the compressed stated can include displaying the current tool setting (described above) of the electronic stylus so that the user can visually confirm what type of output the electronic stylus is providing to the content creation application when being used to enter input, optionally without displaying the other selectable options that are normally displayed in the expanded palette user interface. In some embodiments, the compressed state is displayed in a corner of the user interface of the content creation application (different from the location that the explained palette user interface was displayed in the expanded state), thereby minimizing the amount of space on the user interface that is visually occluded by the expanded palette user interface. In some embodiments, the device expands the expanded palette user interface from its compressed state to the fully expanded state in response to detecting the user applying an input with the electronic stylus to the expanded palette user interface when it is in the compressed state (e.g., a tap or selection input of the compressed state of the expanded palette). In some embodiments, when the expanded palette user interface is re-expanded the expanded palette user interface is displayed in the same location as described above (e.g., at the bottom of the user interface of the content creation application.) In some embodiments, when the first input was detected, the expanded palette user interface was displayed in the expanded state. Displaying the expanded palette user interface in a compressed state when the palette user interface ceases to be displayed, minimizes the amount of user interface space that is visually occluded by the expanded palette user interface, thus minimizing the likelihood of erroneous input caused by visual occlusions to the user interface, thus minimizing the occurrence of user input to correct erroneous input, and thereby conserving computing resources associated with correcting erroneous input.

In some embodiments, while displaying the palette user interface with the first spatial arrangement relative to the user interface, the electronic device detects that the pose of the electronic stylus has changed from the first pose relative to the user interface to a third pose relative to the user interface, different from the first pose relative to the user interface, and in response to detecting that the pose of the electronic stylus has changed from the first pose relative to the user interface to the third pose relative to the user interface, the electronic device displays the palette user interface with a third spatial arrangement relative to the user interface, different from the first spatial arrangement relative to the user interface such as if palette user interface 618 moved orientations and locations in response to stylus 604 moving from its pose in FIG. 6B to its pose in FIG. 6G. In some embodiments, the palette user interface moves with the movement of the electronic stylus. For instance, if electronic stylus is within the threshold distance (described above) of the device/user interface and is not touching the device/user interface (also described above), then the device moves the palette user interface in response to movement of the electronic stylus. In some embodiments, movement of the electronic stylus includes (but is not limited to) changing the location of the electronic stylus and/or changing the orientation of the stylus (e.g., the tilt angle) with respect to the display/user interface. In some embodiments, the device continuously moves the palette user interface in response to continual movement of the electronic stylus. Additionally or alternatively, the device periodically updates the spatial arrangement of the palette user interface, such that the palette user interface is displayed based on the pose of the stylus at the time that the spatial arrangement is being updated. Thus, the direction and/or amount of the movement of the palette user interface optionally corresponds to the direction and/or amount of the stylus. In some embodiments, if the user moves the electronic stylus beyond the threshold distance, the device will cease moving the palette user interface with the electronic stylus. Moving the palette user interface with movement of the electronic stylus minimizes the likelihood of visual occlusion of the palette user interface by a portion of the user thus reducing the need for inputs to manually move/reorient the palette, thus minimizing the occurrence of erroneous user input associated with visual occlusions to the palette user interface and/or input to reorient/move the palette, and thereby conserving computing resources associated with correcting erroneous input.

It should be understood that the particular order in which the operations in FIG. 7 have been described, optionally including the additional and/or alternatives operations to the illustrated operations in FIG. 7 described herein, is merely exemplary and is not intended to indicate that the described order is the only order in which the operations could be performed. One of ordinary skill in the art would recognize various ways to reorder the operations described herein.

### Stylus Haptics and Associated User Interfaces

In addition to gestures that involve touching the stylus on or near a screen of the electronic device, the electronic device can further facilitate interaction between the user of the device and the content creation application using an electronic stylus that enables the user to provide an input by squeezing the stylus and provides a tactile output to the user. Such an electronic stylus is able to provide an input to the electronic device when the user applies, maintains, or releases pressure on or from a predetermined pressure-sensitive portion of the stylus. The electronic device is able to detect a variety of squeeze inputs from the electronic stylus based on the application of pressure, the release of pressure, the force of the pressure, and duration of pressure, among other characteristics of the input. The electronic device is further able to provide a tactile output to the user at the electronic stylus. The tactile outputs include a plurality of mutually distinguishable vibrations that the user is able to perceive at the electronic stylus. The electronic device generates the tactile outputs at the electronic stylus to communicate with or alert the user to a change of state in the electronic device or the user interface, such as in response to various interactions between the electronic stylus and the electronic device. The ability to provide an input to the electronic device by squeezing the stylus facilitates the use of the device by extending the range of inputs that the electronic device is able to receive. The tactile outputs generated at the electronic stylus provide the user with an additional feedback mechanism for interacting with the electronic device.

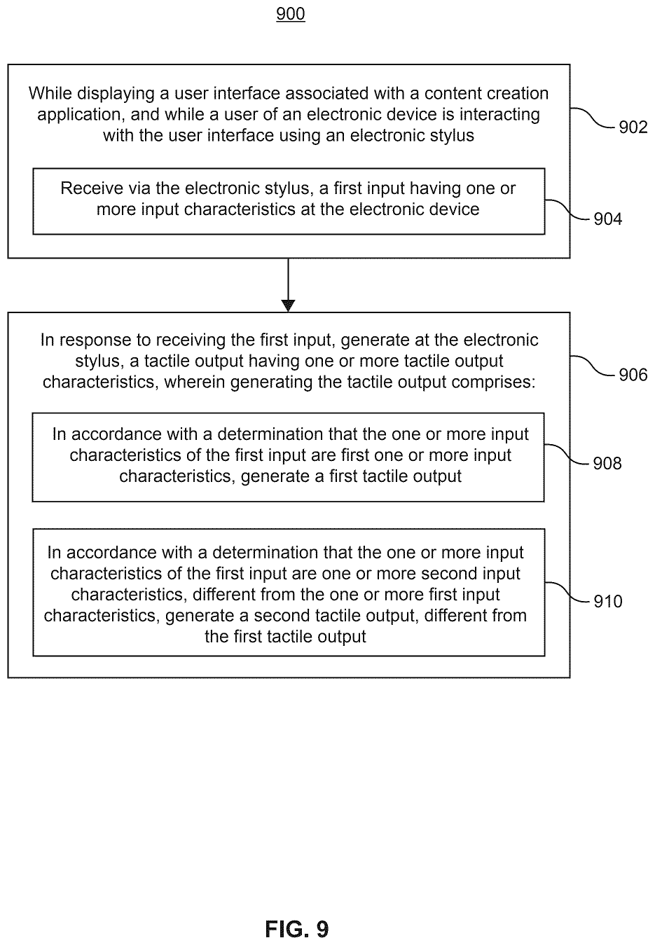

FIGS. 8A-8N illustrate various examples of the operation of the electronic device using an electronic stylus configured to enable stylus squeeze inputs and provide tactile outputs. The embodiments in these figures are used to illustrate the processes described below, including the processes described with reference to FIG. 9. Although FIGS. 8A-8N illustrate various examples of ways an electronic device is able to perform the processes described below with respect to FIG. 9, it should be understood that these examples are not meant to be limiting, and the electronic device is able to perform one or more processes described below with reference to FIG. 9 in ways not expressly described with reference to FIGS. 8A-8N.

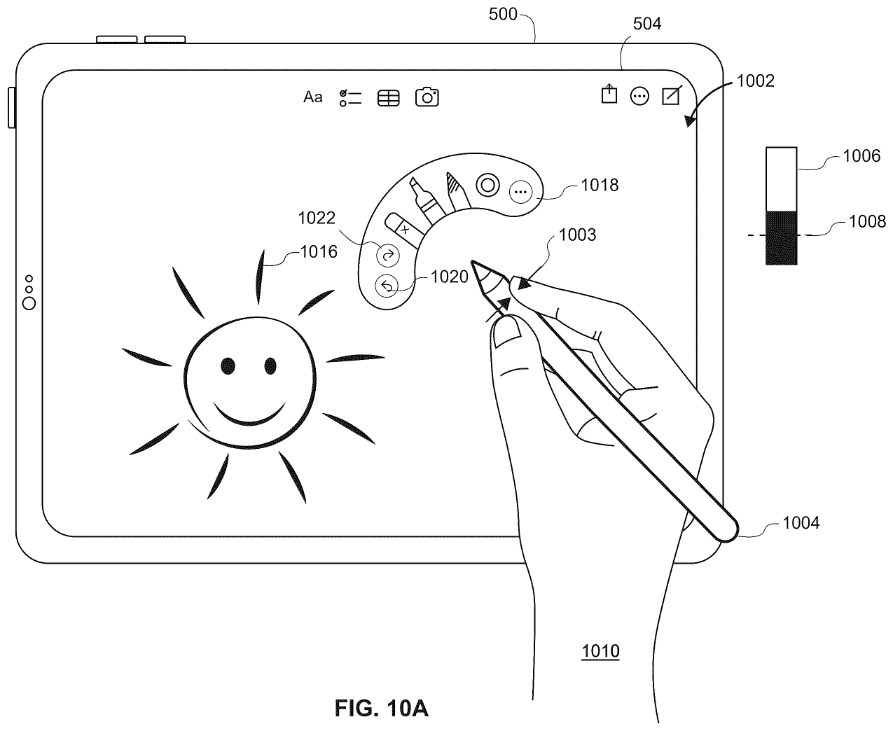

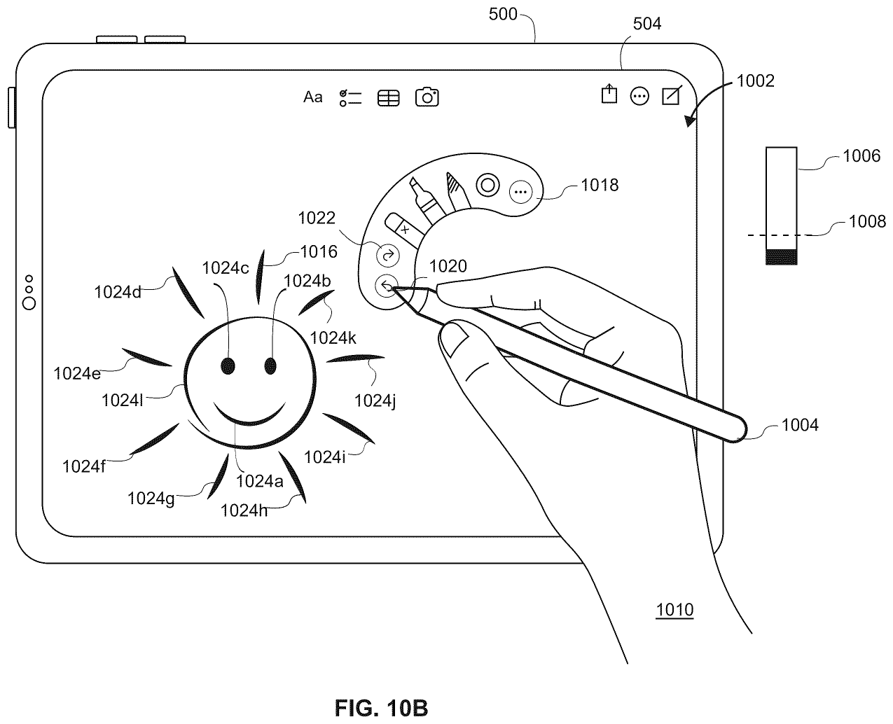

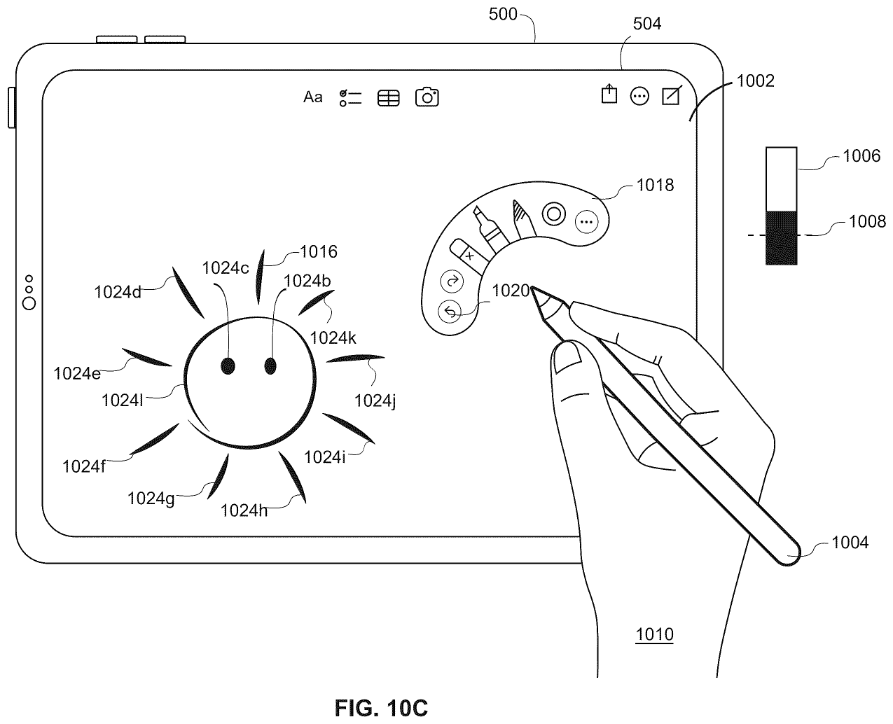

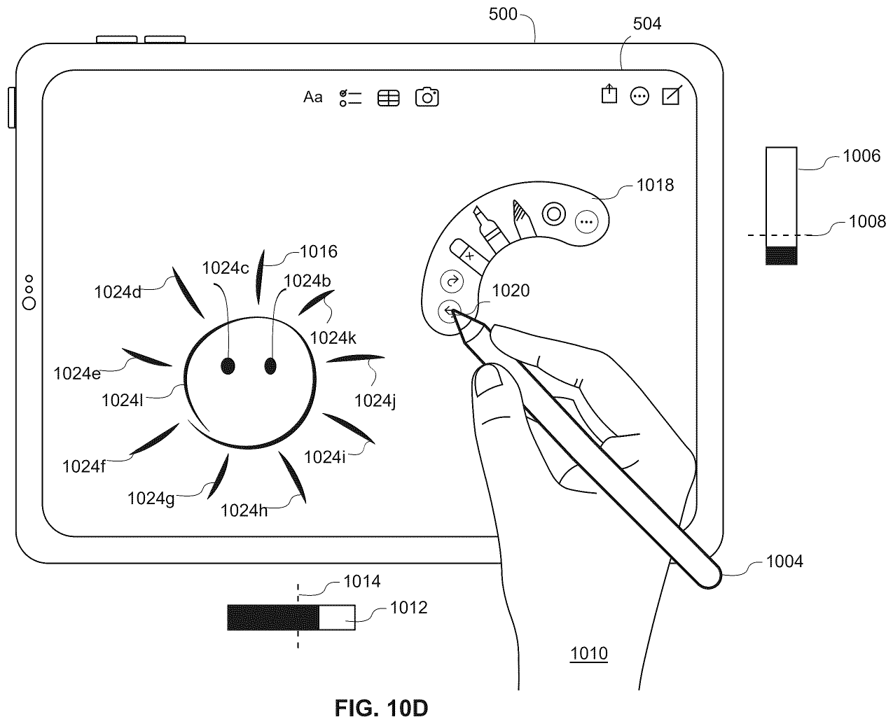

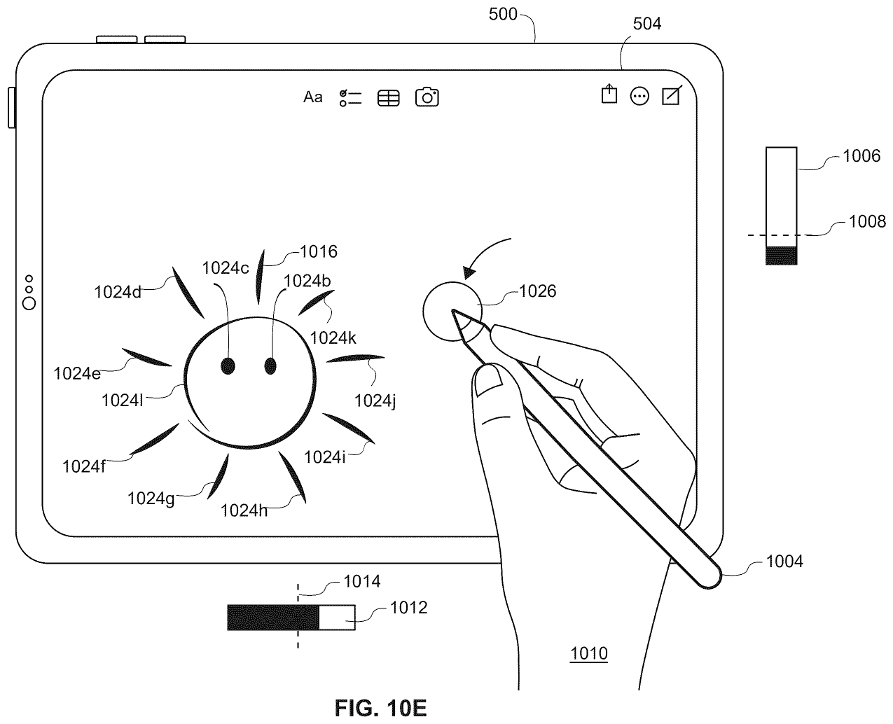

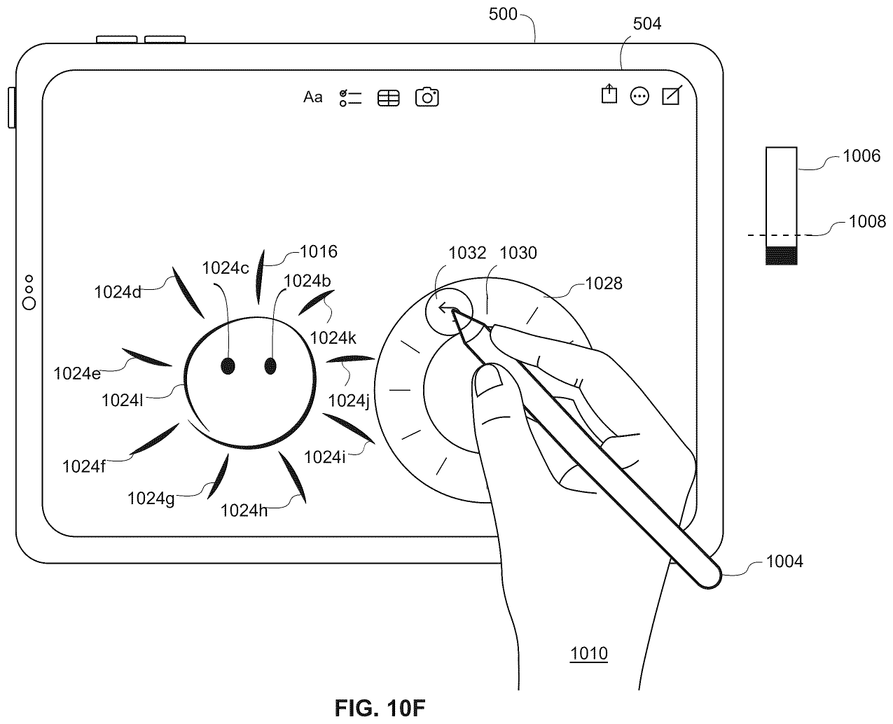

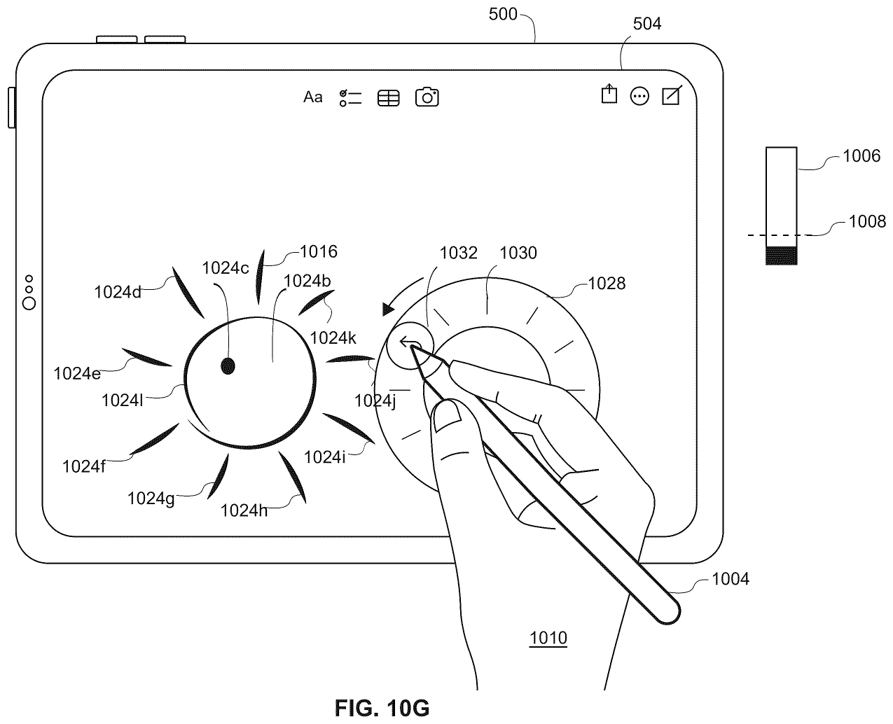

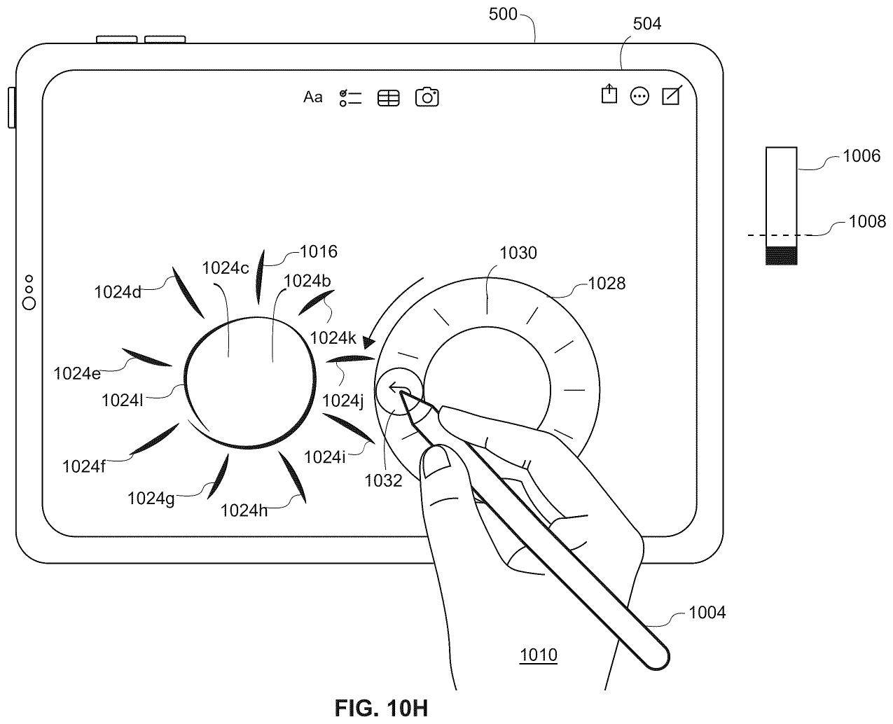

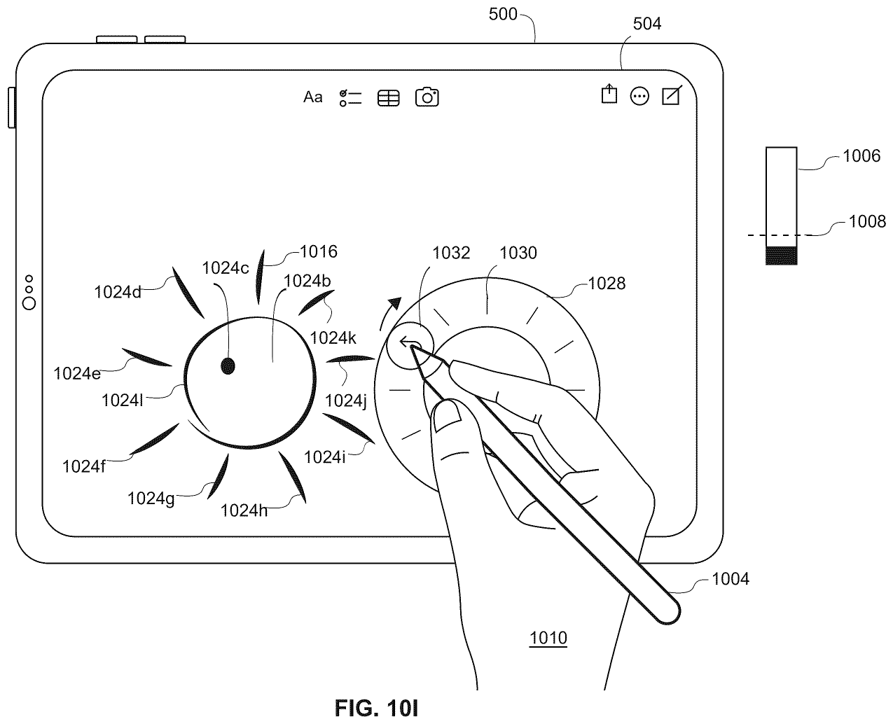

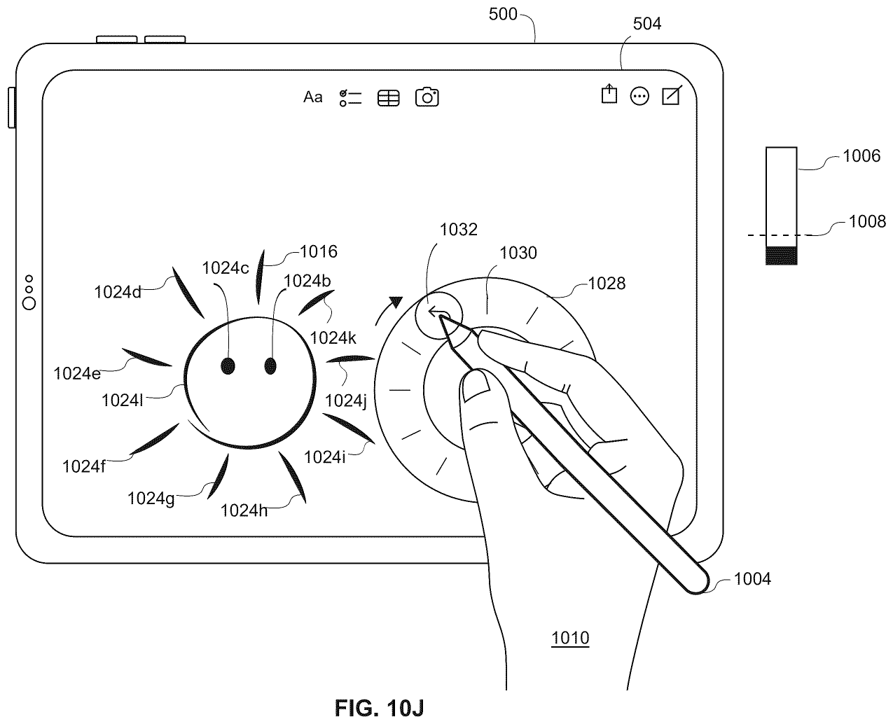

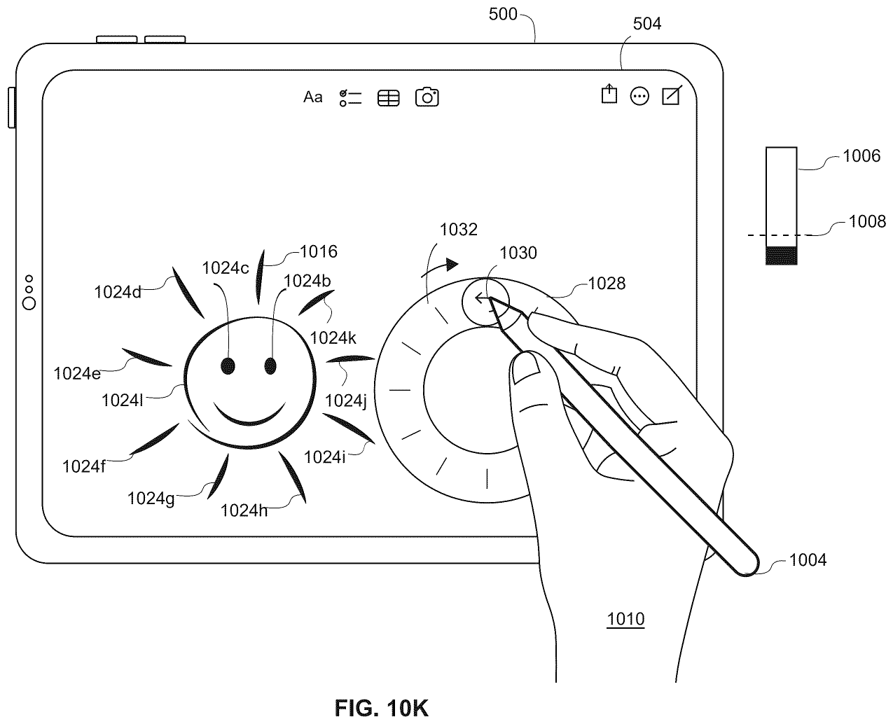

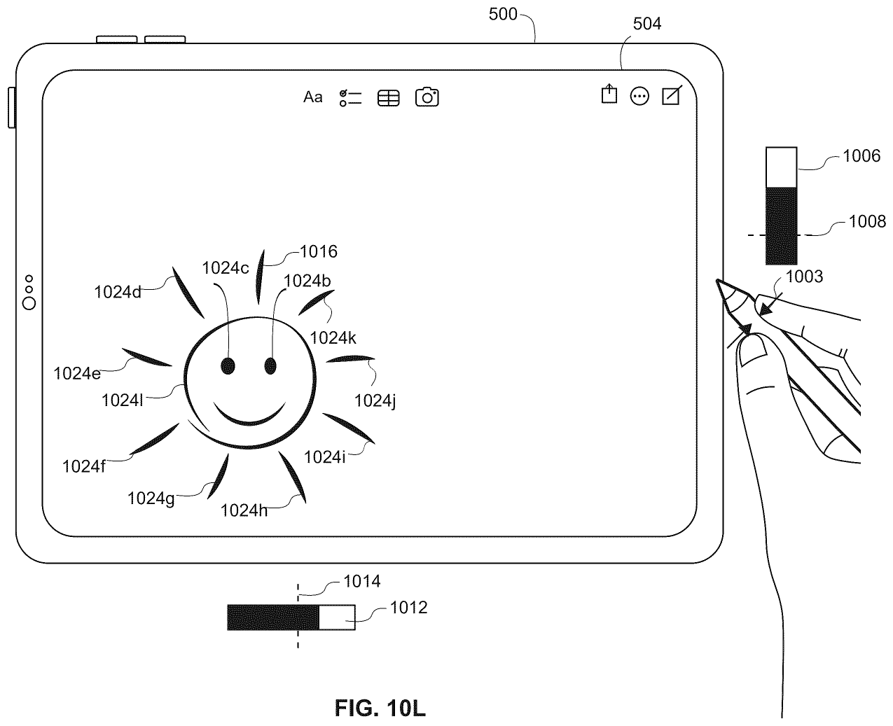

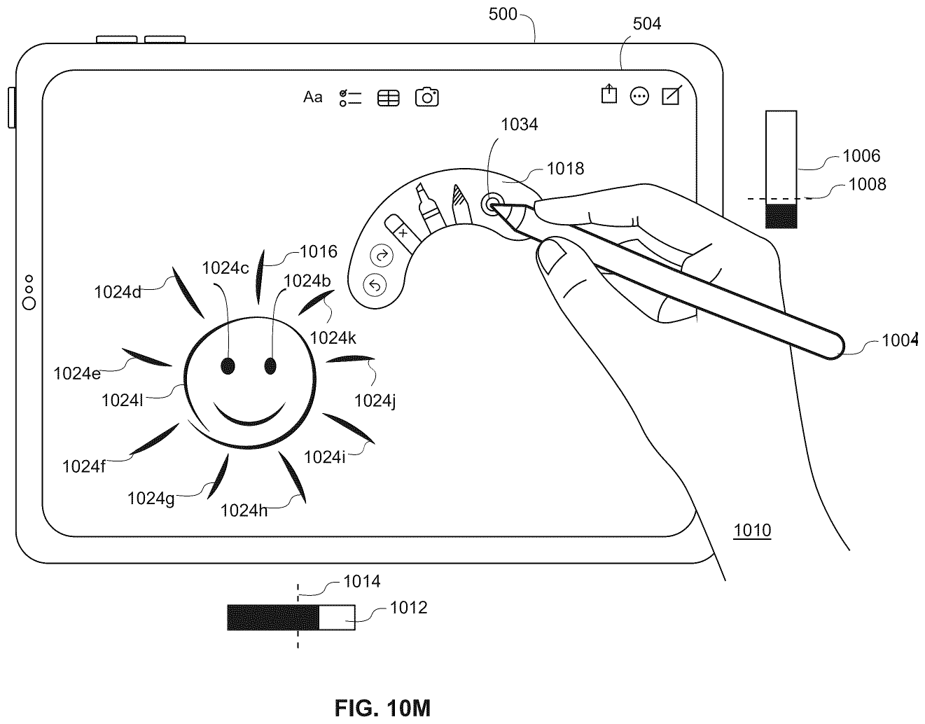

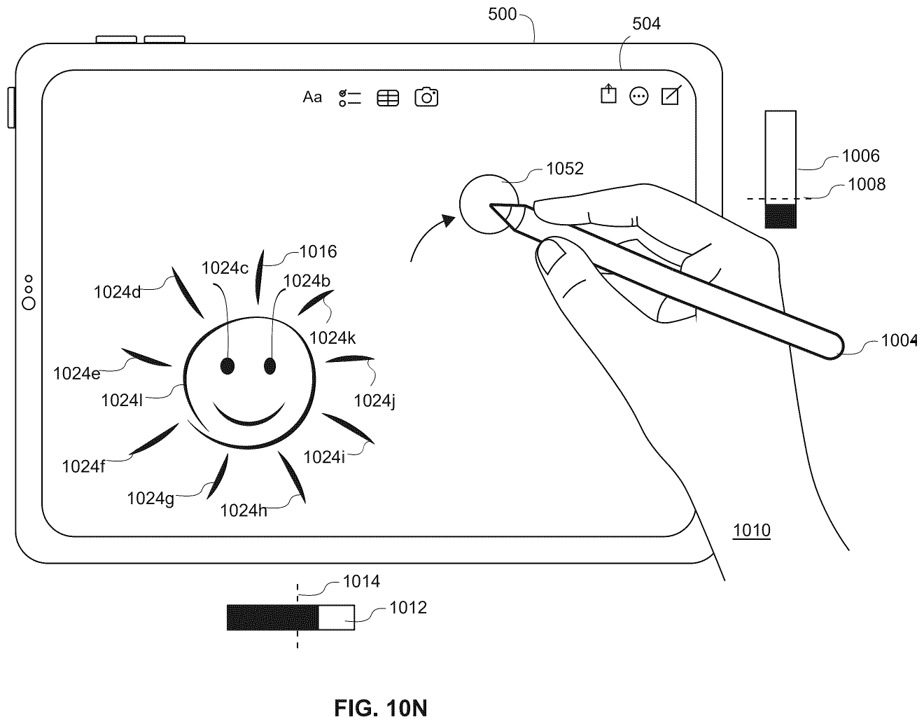

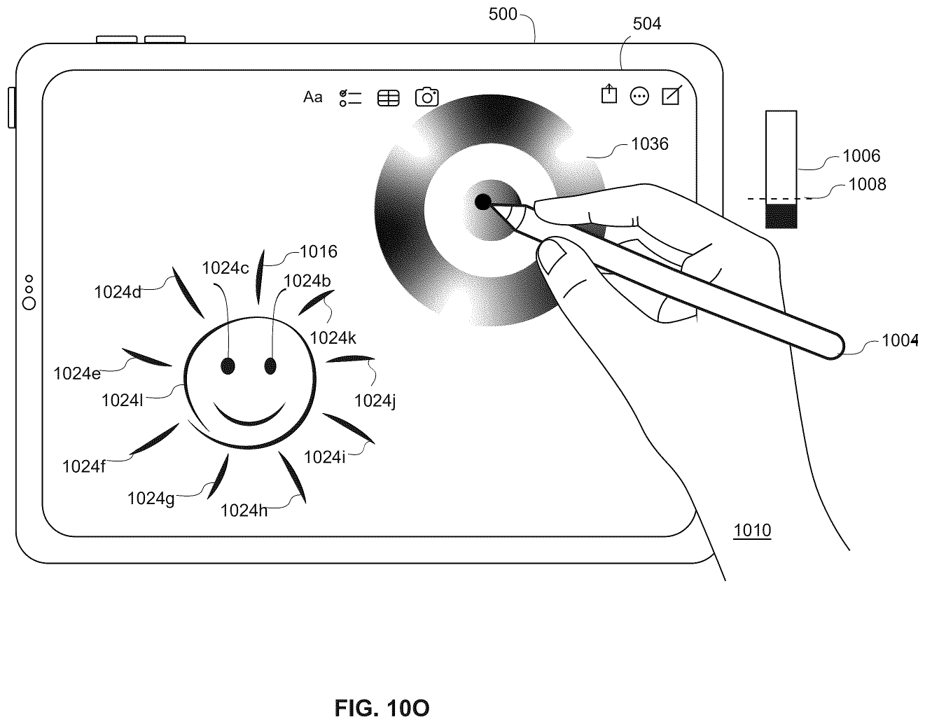

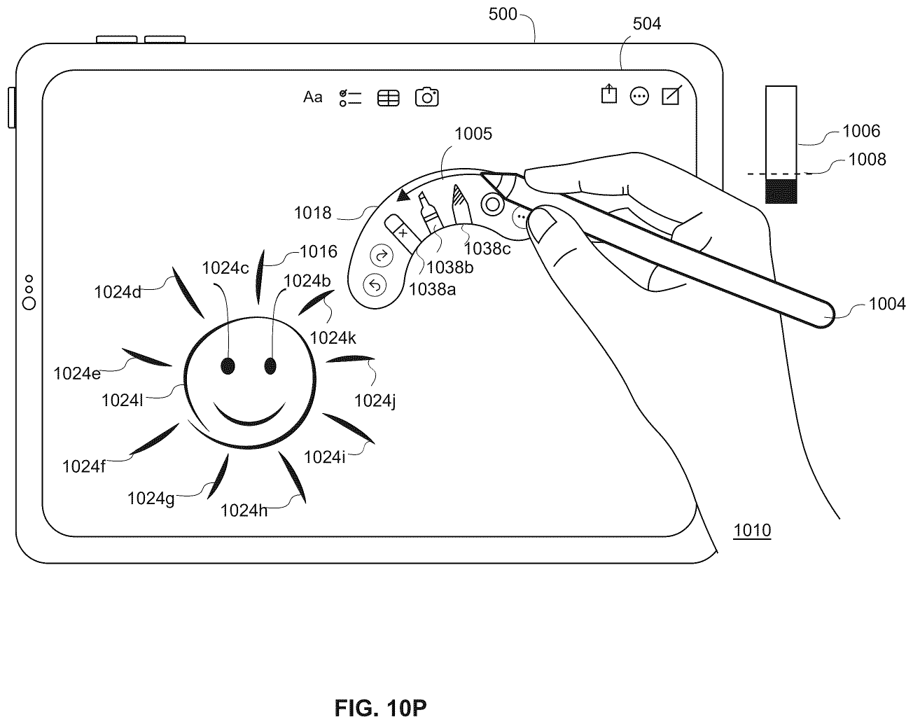

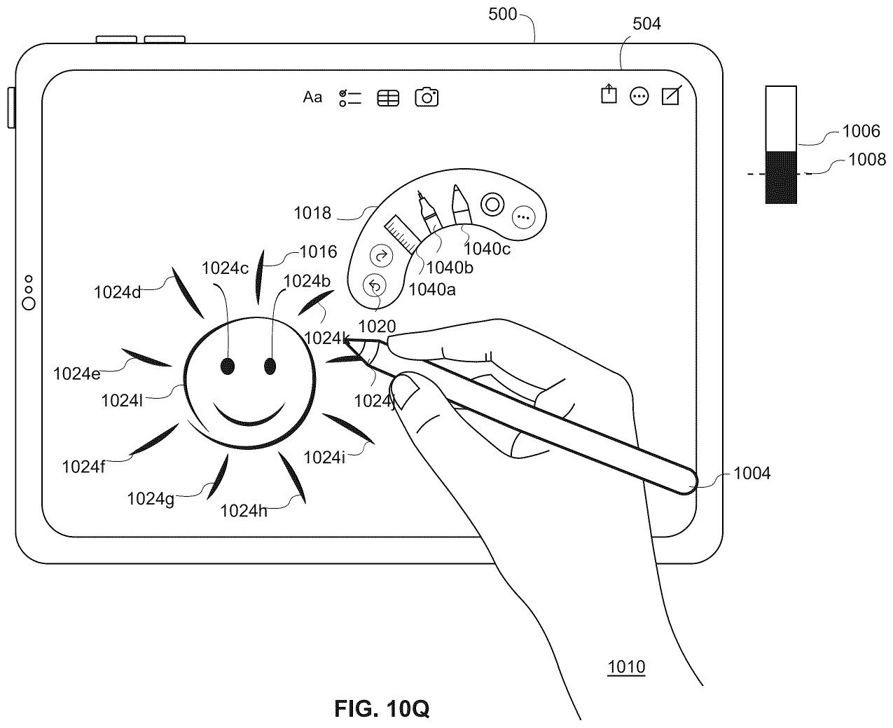

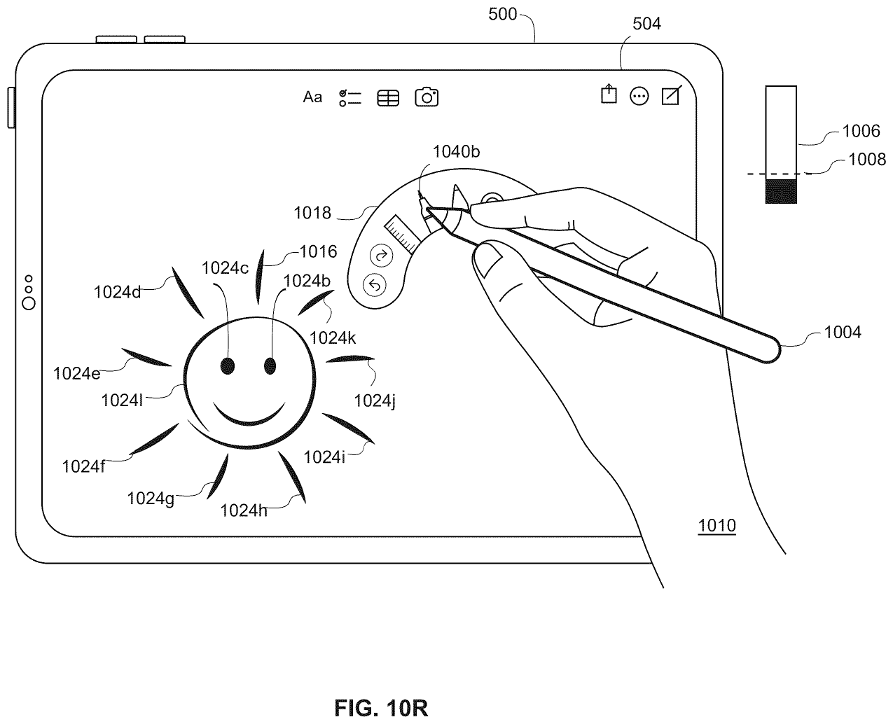

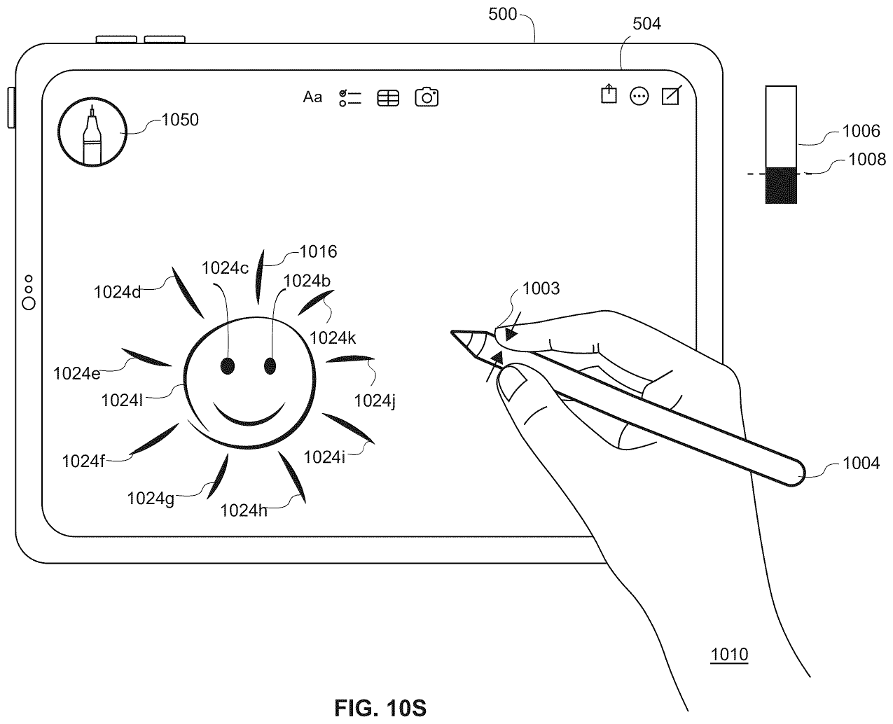

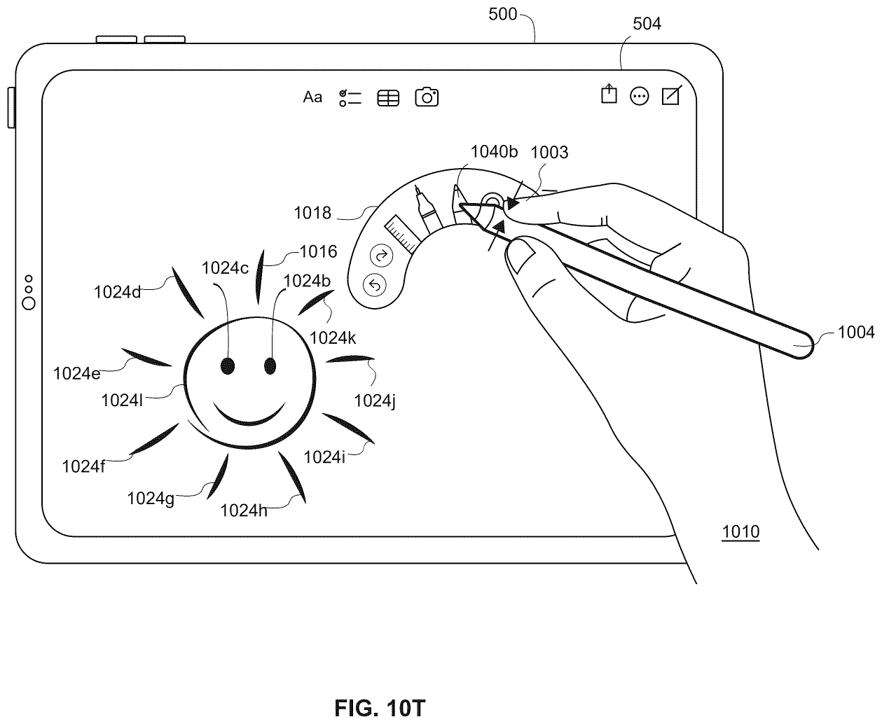

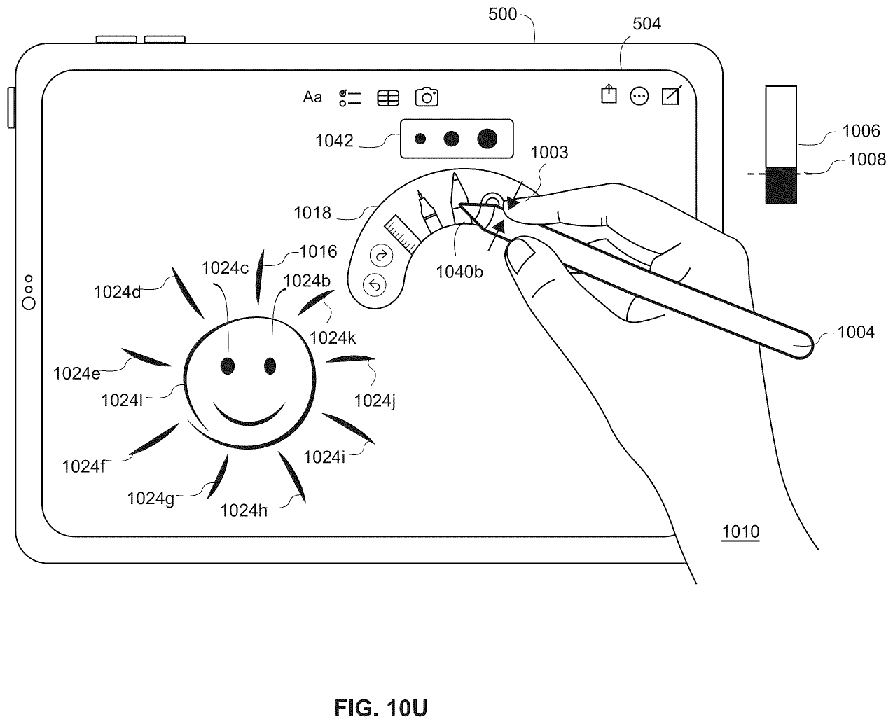

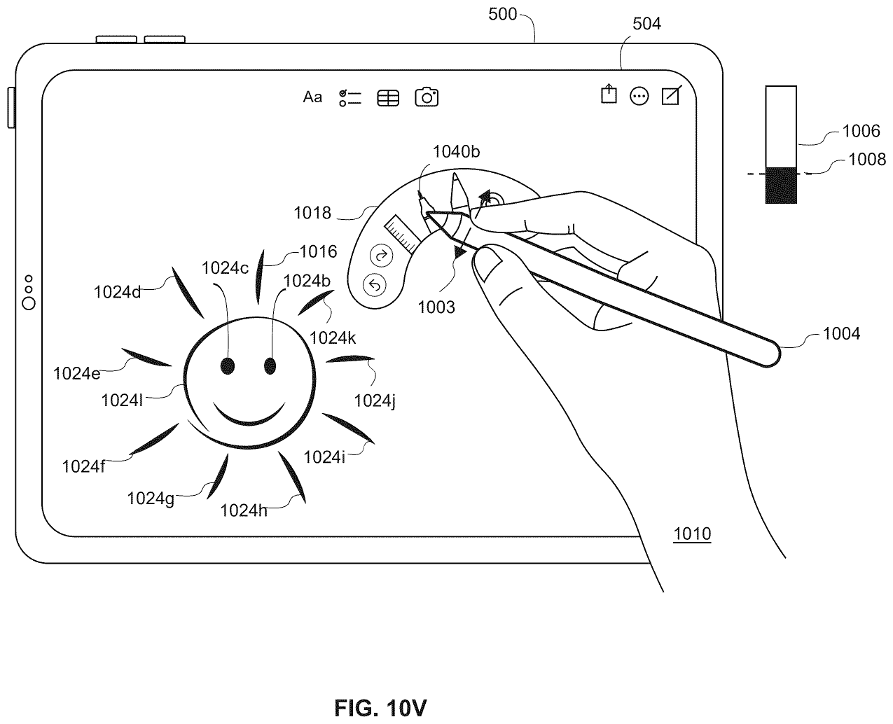

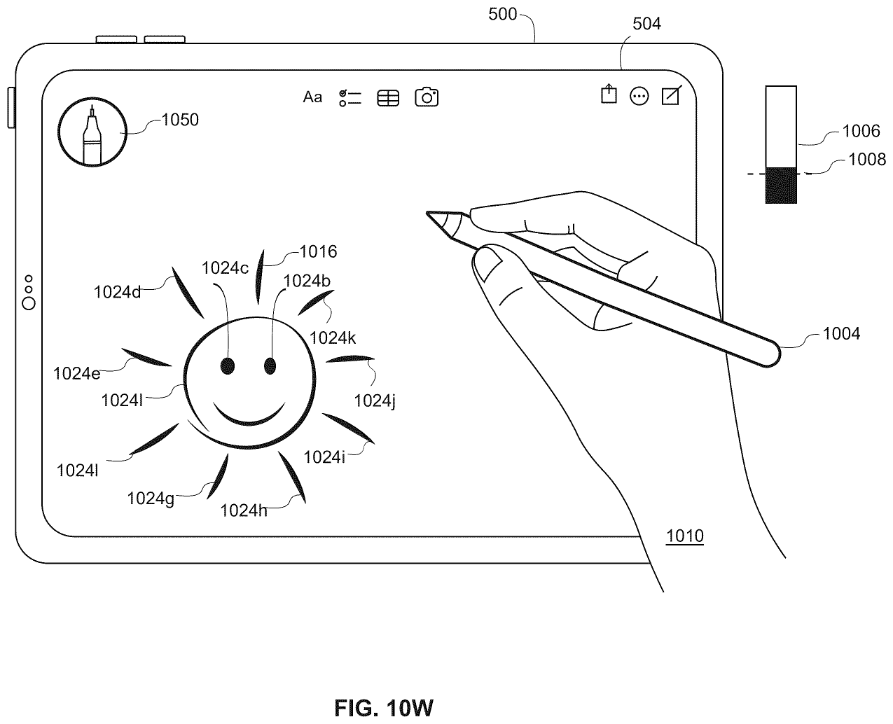

In some embodiments, and as described above with respect to FIGS. 6 and 10, a palette user interface is displayed by device 500 in response to a squeeze input. In some embodiments, a squeeze input is detected when an electronic stylus is squeezed (e.g., two opposing forces are applied to the body of the stylus in a squeeze) while the stylus is at a distance that is above a predefined threshold. In some embodiments, in addition to the conditions described above, device 500 can detect a squeeze input when a squeeze intensity (e.g., the strength of the squeeze) is above a predefined threshold. In some embodiments, the user of the electronic device can set the predefined squeeze threshold that will be used to determine whether or not to display a palette user interface, by interacting with a stylus squeeze threshold configuration interface as illustrated in FIG. 8A. In some embodiments, and as illustrated in FIG. 8A, the device includes a settings configuration user interface that includes one or more user interfaces for configuring the content creation application including a squeeze intensity threshold user interface 801. In some embodiments, squeeze intensity threshold user interface 801 includes a slide bar that the user can slide a button on that sets the predefined intensity threshold at which the device will register a squeeze input as described above. In some embodiments, as the button is moved to the right, the predefined intensity threshold is increased, and as the button is moved to the left, the predefined intensity threshold is decreased.

FIG. 8B illustrates an exemplary device 500 displaying a user interface 802 and a user 803 interacting with the electronic device using an electronic stylus 800. In some embodiments, the user interface 802 is displayed via a display generation component 504. In some embodiments, the display generation component 504 is a hardware component (e.g., including electrical components) capable of receiving display data and displaying a user interface. In some embodiments, examples of a display generation component 504 include a touch screen display, a monitor, a television, a projector, an integrated, discrete, or external display device, or any other suitable display device.

The electronic device 500 is in communication with an electronic stylus 800. In some embodiments, the electronic stylus 800 is communicatively coupled to the electronic device 500 either via a wired or wireless communication link and is configured to provide inputs to the electronic device 500. For instance, the electronic stylus 800 optionally includes one or more components that are configured to allow the electronic device 500 to detect when the electronic stylus 800 is touching the display generation component 504 or is otherwise in near proximity to the electronic device 500, a display/screen 504 of the electronic device, and/or from the displayed user interface 802 that the electronic stylus 800 is interacting with. In some embodiments, the stylus input is a stylus gesture against the display generation component 504 such as a tap, a swipe, or a lift off. In some embodiments, the electronic stylus 800 comprises one or more components that are configured to detect a user's application of manual pressure or squeeze on a specified/predetermined area on the surface of the stylus. In some embodiments, the pressure detection components are configured to detect the application of pressure, the release of pressure, the force of the pressure, and the duration of the pressure.

In some embodiments, the user interface 802 is associated with a content creation application. In some embodiments, the content creation application is one or more of a word processing application, a note taking application, an image management application, a digital content management application, a drawing application, a presentation application, a spreadsheet application, a messaging application, a web browsing application, and/or an email application. As shown in the example of FIG. 8B, the content creation application is a drawing application that occupies all the viewable area of the electronic display 504. In some embodiments, the content creation application and/or the user interface of the content creation application share one or more characteristics with the content creation application and user interface described with respect to methods 700, 900, and 1100.

In some embodiments, the electronic device 500 detects a user 803 of the electronic device interacting with the screen 504 of the device using the electronic stylus 800. Such interactions are recognized as inputs when they are interpreted as commands or requests to perform a function on the electronic device 500 in accordance with one or more conditions being satisfied. In the example shown in FIG. 8B, the user interaction is a squeeze of the electronic stylus 800 or a stylus squeeze input 804 (indicated by a pair of opposing arrows) showing the user's application of pressure on a pressure-sensitive portion of the stylus 800. In some embodiments, the squeeze input 804 shares one or more characteristics of the squeeze inputs described with respect to methods 700, 900, and 1100. In some embodiments, the device 500 receives a communication from the electronic stylus when a squeeze is applied by the user 803 to the stylus, and then determines whether the received input satisfies the conditions for a stylus squeeze input 804. In some embodiments, the electronic device receives the stylus squeeze as a squeeze input 804 when an intensity of the squeeze exceeds a predefined threshold (e.g., as further described below in this specification) and/or when a duration of the squeeze exceeds a threshold, among other conditions. In response to receiving the stylus squeeze input 804, electronic device 500 displays a palette user interface 806, and the electronic device 500 generates a tactile output at the electronic stylus 800 as illustrated in FIG. 8C. FIG. 8C illustrates the exemplary device 500 displaying a palette user interface 806 in response to detecting a squeeze input 804 on the electronic stylus 800. In response to the stylus squeeze input 804, the electronic device 500 displays a palette user interface 806 on user interface 802. The palette user interface 806 includes one or more selectable options for configuring the electronic stylus 800 to provide input to the content creation application. Palette user interface 806 is substantially similar to palette user interface 618, previously described. Further, the electronic device generates a tactile output in response to receiving the stylus squeeze input 804. The tactile output generated by the electronic device 500 in response to the stylus squeeze input 804 is a “tap tactile output” (e.g., tap tactile output 810). The tap tactile output 810 is characterized by a vibration perceived by the user 803 as a quick or short burst or a sudden tap of the electronic stylus 800 against the user's hand. The tap tactile output is one of a plurality of mutually distinguishable tactile outputs that the electronic stylus 800 is configured to generate based on stylus input and/or an operation performed by the electronic device 500. As such, the vibration of the tap tactile output has a moderate duration and a moderate intensity in relation to other types of tactile output described further down in this disclosure, in some embodiments. The tactile outputs generated at the electronic stylus serve to alert the user to a change of state in the electronic device or the user interface and provide the user with an additional feedback mechanism for interacting with the electronic device.

In some embodiments, the electronic device 500 only determines that the stylus squeeze is a squeeze input 804, if a threshold squeeze intensity is exceeded on the electronic stylus 800 (e.g., the strength of the squeeze is above a predefined threshold). In some embodiments, the squeeze intensity or squeeze strength refers to a quantitative measure of the strength of the squeeze (e.g., the amount of force applied to the electronic stylus when the squeeze input is performed). Squeeze intensity bar 812 is depicted in FIG. 8C to illustrate the squeeze intensity 814 in relation to the squeeze intensity threshold 816. If the electronic device 500 detects that the squeeze intensity 814 of the stylus squeeze 804 is below squeeze intensity threshold 816, the device does not register the stylus squeeze as an input and device forgoes performing a corresponding operation and generating a tactile output. When the squeeze intensity 814 matches or exceeds the squeeze intensity threshold 816, the electronic device 500 receives the stylus squeeze 804 as an input and in response displays palette user interface 806 and generates tap tactile output 810 at the electronic stylus 800. In some embodiments, the user defines the squeeze intensity threshold 816 using a squeeze intensity threshold user interface configured to facilitate the user entering a threshold such as described with respect to method 700 and illustrated in FIG. 8A.

In some embodiments, an intensity of the tactile output generated by the electronic stylus 800 in response to the input corresponds to or is consistent with the squeeze intensity threshold. FIG. 8D illustrates an electronic device 500 receiving a stylus squeeze 804 from an electronic stylus 800. The squeeze intensity threshold 817 is set higher than the squeeze intensity threshold 816 of FIG. 8C, which means that more squeeze intensity or strength is required from the user for the electronic device 500 to detect the stylus squeeze as an input. As shown in the figure, the squeeze intensity 815 exceeds intensity threshold 817, and in response, the electronic device 500 generates a tap tactile output 810 at the electronic stylus 800 (along with performing an operation corresponding to the stylus squeeze such as displaying a palette as described above). However, the tap tactile output 810 generated has a higher intensity than the tactile output generated in reference to FIG. 8C (as illustrated by the larger symbol for the tap tactile output 810 in FIG. 8D), and thus corresponds to the higher squeeze intensity threshold required for the electronic device 500 to detect squeeze 804 as an input.

FIG. 8E illustrates an exemplary device 500 displaying a user interface 802 and a user interacting with the electronic device using an electronic stylus 800. In the example of FIG. 8E, device 500 detects that the user is performing a release of a stylus gesture or a stylus release 804. A release of a squeeze gesture (indicated by a pair of arrows) refers to the user relaxing their grip on the electronic stylus 800 following the user's application of and/or maintenance of a squeeze input 804 or long press (described further below) on the pressure sensitive area of the electronic stylus 800. As such, the electronic device 500 detects the release gesture 804 as an input when the squeeze strength drops below intensity threshold 822. FIG. 8F illustrates the exemplary electronic device after a stylus gesture is performed. In response to the stylus release gesture, the electronic device 500 generates a “detent tactile output” at the electronic stylus 800. The detent tactile output 824 is characterized by a vibration perceived by the user's hand as a detent, a sudden release or snapping from mechanical tension, or an unlocking. The detent tactile output is one of a plurality of mutually distinguishable tactile outputs that the electronic stylus 800 is configured to generate based on stylus input and/or an operation performed by the electronic device 500. In some embodiments, the stylus release intensity threshold 822 is the same as stylus squeeze intensity threshold 816. In some embodiments, the stylus release intensity threshold 822 is higher than the stylus squeeze intensity threshold 816, and in some embodiments and the stylus release intensity threshold 822 is lower than the stylus squeeze intensity threshold 816.

In some embodiments, the electronic device 500 generates a tap tactile output 810 at the electronic stylus 800 in response to the electronic stylus providing an input associated with a confirmation. In particular, the tap tactile output 810 is generated when the stylus input is received as a confirmation by the electronic device. FIG. 8G illustrates an exemplary device 500 displaying a user interface 802 and a user interacting with the electronic device using an electronic stylus 800. As shown, the electronic device 500 displays a prompt user interface 826 on user interface 802. The prompt user interface 826 is a window that asks the user “Do you want to save this drawing?” and further features a “Yes” button 828 and a “No” button. FIG. 8H illustrates the user providing a confirmation to the electronic device and the content creation application by clicking the “Yes” button 828 with the stylus. The electronic device 500 receives the stylus input as an input providing a confirmation for the user interface prompt 826. In response, the electronic device generates a tap tactile output 810 at the electronic stylus 800. The tap tactile output 810 in this case thus serves as an acknowledgement provided by the electronic device 500 via the electronic stylus 800 for the received confirmation.

In some embodiments, the electronic device 500 generates a tap tactile output 810 at the electronic stylus 800 in response a stylus input associated with the recognition of a smart shape. In particular, the electronic device 500 generates a tap tactile output 810 when the electronic device 500 determines that a shape drawn by the electronic stylus 800 in the content creation application corresponds to a pre-defined shape stored in the application, and displays the pre-defined shape in response to the drawing. FIG. 8I illustrates an exemplary device 500 displaying a user interface 802 and a user interacting with the electronic device using an electronic stylus 800. As shown, the electronic device 500 displays a hand-drawn shape 832 drawn on the canvas of the content creation application by the user using the electronic stylus 800. Hand-drawn shape 832 approximates a complete circle but exhibits many imperfections as a hand-drawn circle. FIG. 8J illustrates the electronic device displaying the user interface 802 after hand-drawn shape stylus input. The electronic device 500 has determined that the hand-drawn shape provided by the stylus input corresponds to a circle and in response displays the circle 834 in place of the hand-drawn shape 832 on the user interface 802, and further generates a tap tactile output 810 at the electronic stylus. The circle 834 is displayed in substantially the same location and has substantially the same size of the hand-drawn shape 832 that it replaced. The tap tactile output in response to the electronic device's recognition of a hand-drawn shape 832 thus serves as an acknowledgement provided by the electronic device 500 via the electronic stylus 800 for the recognition of the pre-defined shape.

In some embodiments, the electronic device 500 generates a detent tactile output in response to a stylus input associated with crossing the tick marks on a state slider bar. FIG. 8K illustrates an exemplary device 500 displaying a user interface 802 and a user 803 interacting with the electronic device using an electronic stylus 800. The electronic device displays a visual content 835 or drawing made by the user on the canvas of the content creation application using the electronic stylus 800, which includes portion 839 representing the most recent portion that was added to visual content 835. The device further displays a state slider bar 836 as a continuous (e.g., ring shaped) state slider bar 836. The state slider bar 836 is substantially similar to the state slider 1028, previously described. As such, state slider bar 836 includes one or more tick marks 838, with each tick mark (e.g., 838a) representing a portion (e.g., portion 839) of one or more portions of visual content 835 that can be undone and/or redone based on inputs that are applied to state slider bar 836. State slide bar further includes current state button 837 that the user slides across state slider bar 836 to undo/redo various portions of visual content 835. In some embodiments, a portion of visual content 835 is undone/deleted when current state button 837 is moved over a tick mark that corresponds that portion. In FIG. 8K, the device 500 detects that the user is providing stylus input to drag the current state button 837 across tick mark 838a, which corresponds to portion 839 of visual content 835. FIG. 8L illustrates the aftermath of dragging current state button 837 across the state slider bar 836 in the counterclockwise direction. The electronic device 500 has detected that current state button 837 has been dragged across tick mark 838a, which corresponds to the most recent portion 839 of the visual content 835. In response, the electronic device performs an undo operation on the visual content 835 or drawing, undoing the portion 839 which is now removed. Further, the electronic device generates a detent tactile output 824 at the electronic stylus as tick mark 838a is crossed and portion 839 is deleted. In this case, the detent tactile output 824 serves to provide an acknowledgment to the user that a tick mark 838 of the state slider bar 836 has been crossed.

In some embodiments, the electronic device 500 generates a “round tap tactile output” in response to a stylus input associated with an eraser. FIG. 8M illustrates an exemplary device 500 displaying a user interface 802 and a user 803 interacting with the electronic device using an electronic stylus 800. The electronic device displays a drawing 842 drawn by the user on the canvas of the content creation application using the electronic stylus 800. In FIG. 8M the electronic stylus 800 is configured by the electronic device to operate as an eraser, as indicated by the eraser icon 846 displayed on the user interface. Device 500 displays drawing 842 exhibits with one or more erased portions or erasures 844 that were made by detecting the electronic stylus 800 swiping across the drawing 842 when the electronic stylus configured as an eraser. In response to each erasure of portion of drawing 842, the electronic device generates a round tap tactile output 848 at the electronic stylus 800. In some embodiments, the round tap tactile output 848 is generated for the duration of the erasure of the portion of drawing 842, or for the duration of the engagement of the electronic stylus 800 with the portion of drawing 842. In some embodiments, the round tap tactile output 848 begins when the electronic stylus 800 configured to function as an eraser touches down on the canvas or user interface 802 of the contact creation application and stops when the stylus lifts off from the canvas or user interface. The round tap tactile output is one of a plurality of mutually distinguishable tactile outputs that the electronic stylus 800 is configured to generate based on stylus input and/or an operation performed by the electronic device 500. As such, the round tap tactile output is characterized by a vibration of the stylus perceived by the user as longer yet weaker against the user's hand compared to the tap tactile output and the detent tactile output. In the example of FIG. 8N, the round tap tactile output 848 serves to provide a tactile feel of an erasing pencil to the user, as well as provide an additional notification of the erasure to the user, in some embodiments.

FIG. 9 is a flow diagram illustrating a method 900 for providing a tactile output at an electronic stylus in response to an input received by the electronic device, in accordance with some embodiments. The method 900 is optionally performed at an electronic device such as device 100, device 300, device 500 or device 580, as described above with reference to FIGS. 1A-1B, 2-3, 4A-4B and 5A-5I. Some operations in method 900 are, optionally combined and/or order of some operations is, optionally, changed.

In some embodiments, method 900 is performed at an electronic device in communication with a display generation component and one or more input devices, wherein the one or more input devices include an electronic stylus. For example, the electronic device is a mobile device (e.g., a tablet, a smartphone, a media player, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external), etc.). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, the electronic stylus is communicatively coupled to the electronic device, either via a wired or wireless communication link, and is configured to provide inputs to the electronic device. For instance, the electronic stylus optionally includes one or more components that are configured to allow the electronic device to detect when the electronic stylus is touching the display generation component or is otherwise in near proximity (e.g., within a threshold distance such as 0, 0.01, 0.05, 0.1, 0.2, 0.5, 0.8, 1, 3, 5, 10, 30, 50 or 100 cm) to the electronic device, a screen of the electronic device, and/or from the displayed user interface that the electronic stylus is interacting with. In some embodiments, the electronic stylus includes one or more components that are configured to allow for the electronic device to determine a pose of the electronic stylus with respect to electronic device, screen, and/or displayed user interface. Thus, in some embodiments, the electronic device is able to determine the position and/or the orientation of the electronic stylus with respect to the electronic device. In some embodiments, the electronic device obtains pose information including position/attitude (pitch, yaw, and/or roll), orientation, tilt, path, force, distance, and/or location of the input device relative to the electronic device, screen, and/or displayed user interface from one or more sensors of the input device, one or more electrodes in a touch-sensitive surface, and/or other input devices. In some embodiments, the electronic stylus comprises one or more components that are configured to detect a user's application of manual pressure or squeeze of a specified/predetermined area on the surface of the stylus. In some embodiments, the pressure detection components are configured to detect the application of pressure, the release of pressure, the force of the pressure, and the duration of the pressure. In some embodiments, the electronic device as well and the electronic stylus include one or more characteristics of the electronic device described with respect to methods 700 and 1100.

In some embodiments while displaying, via the display generation component, a user interface associated with a content creation application, and while a user of the electronic device is interacting with the user interface using the electronic stylus (902), the electronic device receives (904) via the electronic stylus, a first input having one or more input characteristics at the electronic device such as squeeze input 804 in FIG. 8B. In some embodiments, the content creation application is one or more of a word processing application, a note taking application, an image management application, a digital content management application, a drawing application, a presentation application, a spreadsheet application, a messaging application, a web browsing application, and/or an email application. In some embodiments, the user interface of the content creation application refers to any user interface that a user of the electronic device utilizes to enter content into the content creation application (e.g., a content entry field and/or region). In some embodiments, the user interface can occupy all or nearly all of the viewable area of the display generation component. Alternatively, the user interface of the content creation application shares the viewable area of the display generation component with other user interfaces that can be associated with the content creation application or other applications that are also running on the electronic device. In some embodiments, the content creation application and/or the user interface of the content creation application share one or more characteristics with the content creation application and user interface described above with respect to methods 700 and 1100. In some embodiments, the electronic device detects a user of the electronic device interacting with a screen (e.g., display generation component) of the device using the electronic stylus. The user interaction using the stylus, and as detected by the electronic device optionally comprises a variety of motions of the stylus relative to the screen of the electronic device. In some embodiments, the user interacts with the display generation component using a gesture performed at the screen using the electronic stylus (e.g., an input characteristic). Examples of gestures include a tap, a swipe, and/or a lift off. In some embodiments, the user interaction includes an action performed on the stylus that is communicated to the electronic device, such as a stylus squeeze and/or a release of the squeeze. User interactions with the display generation device using the electronic stylus are received as inputs by the electronic device, in some examples. Such interactions are recognized as inputs when they are interpreted as commands or requests to perform a function on the electronic device. In some embodiments, the first input comprises or more input characteristics. Such input characteristics include any aspect of user interaction that the electronic device recognizes as an input such as those described above. In some embodiments, with regards to stylus gestures, input characteristics include the contact patterns of the gesture, e.g., different motions, timings, and/or intensities of detected contacts, as well as their locations. For example, the input characteristics or contact patterns of a click include a stylus down event followed by a stylus up (lift off) event at the same position of the display. In another example, drawing a line has input characteristics such as a stylus down event, followed by a stylus dragging event, followed by a stylus up event at a different location of the display. With regards to a stylus squeeze, input characteristics may include the application of pressure, the release of pressure, the force of the pressure, and the duration of the pressure, in some examples. In some embodiments, the first input includes one or more characteristics of the inputs described above with respect to methods 700 and 1100.

In some embodiments in response to receiving the first input, the electronic device generates (906) at the electronic stylus, a tactile output having one or more tactile output characteristics such as tap tactile output 810 in FIG. 8C. The electronic stylus further comprises one or more components configured to generate tactile outputs on the stylus. The “tactile output” refers to physical displacement of the electronic stylus relative to a previous position of the stylus, physical displacement of a component (e.g., a touch-sensitive surface) of the stylus relative to another component (e.g., housing) of the stylus, or displacement of the component relative to a center of mass of the stylus that will be detected by a user with the user's sense of touch. A cycle of displacement or oscillation is thus a single displacement of the component away from and back to an original position. In some embodiments, the tactile output includes optionally a vibration of a component of the stylus, e.g., a rhythmic or cyclical physical displacement of the component of the stylus or the vibrating component that will be detected by the user with the user's sense of touch. A vibration has a variety of characteristics. In some embodiments, a vibration optionally has a quantity of cycles, a duration, a frequency, and an intensity. Further, in some embodiments, a frequency and intensity of a vibration optionally varies with the duration of vibration, forming a frequency profile and an intensity profile, respectively. In some embodiments, a vibration comprises a single cycle of displacement or a single oscillation. In some embodiments, a vibration includes two or more oscillations. In some embodiments, a vibration includes two or more vibrations separated by one of more time intervals. A vibration is optionally thus also characterized by a vibration pattern, which is formed by a combination the duration, frequency profile, and intensity profile of a vibration, in some embodiments. Each characteristic of a tactile output that is detectable by the user and can be interpretated by the user as a tactile sensation constitutes an output characteristic of the tactile output, in some embodiments. In some embodiments, output characteristics of the one or more tactile output optionally include the perceived intensity, pattern, or duration of the physical displacement of the electronic stylus or a component thereof. Output characteristics of the tactile outputs optionally further include a duration, frequency, frequency profile, intensity, intensity profile, or pattern of a vibration that a tactile output comprises, in some embodiments. Output characteristics optionally further include the user's overall sensory perception of the tactile output. In some embodiments, the generated vibration is a “tap tactile output.” The tap tactile output is characterized by a vibration perceived by the user as a quick or short burst or a sudden tap of the stylus against the user's hand. The tap tactile output is optionally configured to exhibit a set of output characteristics that distinguish it from other tactile output generated by the stylus such that a user is unlikely to confuse the tap tactile output with the other tactile outputs. As such, the vibration of the tap tactile output optionally has a moderate duration and a moderate intensity in relation to other types of tactile output described further down in this disclosure. A tap tactile output optionally further has a vibration frequency of about 100 Hz, in some embodiments. A moderate duration is understood to mean (as an example) a duration of time between 10 ms and 30 ms, in some embodiments, which means that a tap tactile output can comprise between one to three cycles of displacement of the vibrating component, each lasting 10 ms each. In some embodiments, a tap tactile output optionally has a vibration pattern that includes two or more vibrations. In some embodiments, the generated vibration is a “detent tactile output.” The detent tactile output is optionally characterized by a vibration perceived by the user's hand as a detent, a sudden release or snapping from mechanical tension, or an unlocking. The detent tactile output is optionally configured to exhibit a set of output characteristics that distinguish it from other tactile output generated by the stylus such that a user is unlikely to confuse the detent tactile output with the other tactile outputs such as the tap tactile output. As such, the vibration of the detent tactile output optionally has a duration shorter than that of the other tactile outputs described herein, including the tap tactile output. In some embodiments, a duration of the detent tactile output or vibration is less than 10 ms. In some embodiments, the detent tactile output optionally comprises a cycle of displacement of the vibrating component of the electronic stylus. Further, the intensity of the vibration of the detent tactile output is optionally greater than that of the other tactile outputs described herein including the tap tactile output. In some embodiments, the generated vibration is a “round tap tactile output.” The round tap tactile output is optionally characterized by a vibration of the stylus perceived by the user as longer yet weaker against the user's hand. The round tap tactile output is optionally configured to exhibit a set of output characteristics that distinguish it from other tactile output generated by the stylus such that a user is unlikely to confuse the round tap tactile output with the other tactile outputs. As such, the vibration of round the tap tactile output optionally has a duration of at least 100 ms and low intensity in relation to other types of tactile output described in this disclosure. In particular, the vibration of the round tap optionally has a duration greater than those of both the tap and the detent tactile outputs. However, the intensity of the round tap vibration is optionally lower than those of both the tap and the detent tactile outputs. Further, in some embodiments, the round tap tactile output optionally comprises two of more cycles of displacement of the vibrating component of the electronic stylus. In some embodiments, the electronic device optionally causes a tactile output to be generated at the electronic stylus. In some embodiments, the tactile out is optionally localized in that the vibration is generated a particular surface of the electronic stylus. Optionally or alternatively, the vibration is generated at the touch-sensitive or pressure-sensitive surface or predetermined surface whose depression by the user generates a squeeze input. In some embodiments, the tactile output is optionally localized outside of that surface on the stylus. In some embodiments, the tactile output is optionally generated on the whole stylus or can be felt by the user on any surface of the stylus. The tactile outputs are optionally generated at the stylus to communicate with or alert the user to a change of the state in the electronic device or the user interface. In some embodiments, the tactile outputs are optionally generated at the stylus in response to a stylus input. In some embodiments, the electronic device optionally causes a tactile output to be generated at the electronic stylus in response to various interactions between the electronic stylus and the electronic device (described in further detail below) thus providing the user with a feedback mechanism for interacting with the content creation application.

In some embodiments, in accordance with a determination that the one or more input characteristics of the first input are first one or more input characteristics, the electronic device generates (908) a first tactile output such as tap tactile output 810 in FIG. 8C. In some embodiments, the electronic device generates a particular tactile output at the electronic stylus based on a characteristic of the stylus input. In some embodiments, an input characteristic optionally includes any aspect of user interaction that the electronic device recognizes as an input. As previously explained, an input characteristic optionally includes the contact pattern of a gesture that the electronic display recognizes as an input. The gesture may be a stylus click gesture, a line drawing gesture, a stylus tap gesture, and the like, in some embodiments. In some embodiments, with regards to a stylus squeeze, input characteristics optionally include the application of pressure, the release of pressure, the force of the pressure, and the duration of the pressure. The tactile output generated by the electronic device is provided as feedback to the user in response to the user input. In some embodiments, the generated tactile output optionally includes a vibration. For example, the electronic device determines that an input characteristic consisting of a stylus squeeze is consistent with an interface element displayed on the user interface, and in response, cause a tactile output to be generated at the electronic stylus as an acknowledgment of the gesture input to the user. The tactile output generated in this case optionally has a set of characteristics that are understood to convey an acknowledgment. For example, the tactile output that represents an acknowledgment of the input may optionally comprise a vibration having a particular vibration pattern, that is, a vibration having a particular combination of duration, frequency profile, and intensity profile. For example, the tactile output generated by the stylus in response to a stylus squeeze to indicate an acknowledgement may consist of a stylus vibration of a short duration and strong intensity as perceived by the user.

In some embodiments, in accordance with a determination that the one or more input characteristics of the first input are one or more second input characteristics, different from the one or more first input characteristics, the electronic generates (910) a second tactile output such as detent tactile output 824 in FIG. 8F, different from the first tactile output. Additionally, the electronic device optionally generates a different tactile output at the electronic stylus in response to an input having different input characteristics than the illustrative stylus squeeze input described above. A gesture such as a stylus swipe has a different input characteristic than a stylus squeeze, and thus is optionally received as an input that is different from a stylus squeeze. In response, the electronic device causes the electronic stylus to generate a tactile output that is different from the tactile output generated in response to the stylus squeeze, in that this second tactile output exhibits different output characteristics from the first. This second tactile optionally includes a vibration. In some embodiments, the vibration of the second tactile output exhibits a different vibration pattern from that generated in response to the input having a first input characteristic, and thus has at least one of a different duration, frequency profile, or intensity profile, in some embodiments. For example, the tactile output generated by the stylus in response to a stylus squeeze optionally consist of a stylus vibration of a longer duration and weaker intensity than the first vibration, as perceived by the user. Although particular combinations of stylus input, one or more input characteristics, responses of the electronic device, tactile outputs, and one or more characteristics of tactile outputs are described herein, it should be understood that the disclosure is not limited to specifically described combinations and that such combinations are merely exemplary. As such, depending on the embodiment, any tactile output described herein may be generated in response to any stylus input named or described herein or stylus inputs not named or described herein. Further, tactile outputs not named or described herein may be generated in response to stylus inputs named and described herein and stylus inputs not named and described herein. Providing the user with a tactile output at the stylus based on the stylus input facilitates the use of the electronic device by providing another channel of communication with the user in addition to the user interface, audio interface, and any tactile output of the device itself. The availability of another communication channel with the user helps unclutter the user interface by alleviating the need to display messages and notifications that instead, can be transmitted to the user through tactile output at the stylus for instance to help the user avoid erroneous inputs, thereby minimizing user input errors and thus conserving computing resources associated with correcting erroneous input.

In some embodiments, receiving the first input comprises determining that the user of the electronic device is performing a squeeze input on a surface of the electronic stylus such as squeeze input 804 in FIG. 8B. In some embodiments, the squeeze input shares one or more characteristics of the squeeze inputs described with respect to methods 700 and 1100. In some embodiments, a squeeze input refers to the user tightening and then relaxing their grip on the electronic stylus. In some embodiments, the electronic stylus comprises one or more components that are configured to detect a user's application of manual pressure or squeeze of a specified/predetermined area on the surface of the stylus. Optionally, the pressure detection components are configured to detect the application of pressure, the release of pressure, the force of the pressure, and the duration of the pressure. In some embodiments, the one or more components are located along a portion of the electronic stylus such that a squeeze input along the portion will cause the device receiving an input and optionally performing an operation in response, whereas a squeeze input that is outside of the portion will not cause the device to receive an input. In some embodiments, the squeeze input consists of a predefined number of squeezes of the electronic stylus, such that the operation is performed when the user squeezes the electronic stylus the predefined number of times (with each squeeze occurring within a predefined time of one another.) Additionally or alternatively, in addition to and/or alternatively to a squeeze (as described above), the squeeze input comprises other tactile inputs to the electronic stylus such as a tap (with the user's finger), a barrel roll (turning the electronic stylus between the fingers of the user), and a swipe (running a portion of the user's finger across the electronic stylus). In some embodiments, the squeeze input optionally includes squeezing and/or pushing mechanical button that is located along the side of the electronic stylus. As previously described, the electronic device is in wired or wireless communication with the electronic stylus and the electronic device employs information received from the stylus including any one or more of application of pressure, release of pressure, force of the pressure, and duration of the pressure to determine that a user has performed a stylus squeeze on the surface of the stylus. Using squeeze inputs to determine the user's intent to perform an operation minimizes the likelihood of the device erroneously performing the operation when the user does not intend to do so, thus reducing the need for inputs to manually perform the operation, thus minimizing the occurrence of erroneous user input associated with input to perform the operations, and thereby conserving computing resources associated with correcting erroneous input.

In some embodiments, generating the first tactile output comprises generating a tap tactile output at the electronic stylus such as tap tactile output 810 in 8C. In some embodiments, in response a stylus squeeze input, the electronic device causes the stylus to generate a tactile output comprising a vibration. In some embodiments, the generated vibration is a tap tactile output. As previously described, the tap tactile output is optionally characterized by a vibration perceived by the user as a quick or short burst or a sudden tap of the stylus against the user's hand. The tap tactile output is configured to exhibit a set of output characteristics that distinguish it from other tactile output generated by the stylus such that a user is unlikely to confuse the tap tactile output with the other tactile outputs. As such, the vibration of the tap tactile output optionally has a moderate duration and a moderate intensity in relation to other types of tactile output described further down in this disclosure. A tap tactile output optionally further has a vibration frequency of about 100 Hz, in some embodiments. A moderate duration is understood to mean (as an example) a duration of time between 10 ms and 30 ms, in some embodiments, which means that a tap tactile output can comprise between one to three cycles of displacement of the vibrating component, each lasting 10 ms each. In some embodiments, a tap tactile output optionally has a vibration pattern that includes two or more vibrations. In some embodiments, the electronic device optionally causes the tap tactile output to be generated to provide an acknowledgement of the squeeze input. Providing the user with a tap tactile output at the stylus based on the stylus input facilitates the use of the electronic device by providing another channel of communication with the user in addition to the user interface, audio interface, and any tactile output of the device itself. The availability of another communication channel with the user helps unclutter the user interface by alleviating the need to display messages and notifications that instead, can be transmitted to the user through tactile output at the stylus for instance to help the user avoid erroneous inputs, thereby minimizing user input errors and thus conserving computing resources associated with correcting erroneous input.

In some embodiments, in response to receiving the first input, and in accordance with the determination that the one or more input characteristics of the first input are the first one or more input characteristics, the electronic device displays, via the display generation component, a palette user interface such as palette user interface 806 in FIG. 8C on the user interface associated with a content creation application on the electronic device. In some embodiments, the palette user interface shares one or more characteristics of the palette user interface described with respect to methods 700 and 1100. In some embodiments, the content creation application is one or more of a word processing application, a note taking application, an image management application, a digital content management application, a drawing application, a presentation application, a spreadsheet application, a messaging application, a web browsing application, and/or an email application. In some embodiments, the user interface of the content creation application refers to any user interface that a user of the electronic device utilizes to enter content into the content creation application (e.g., a content entry field and/or region). In some embodiments, the user interface can occupy all or nearly all of the viewable area of the display generation component. Alternatively, the user interface of the content creation application shares the viewable area of the display generation component with other user interfaces that can be associated with the content creation application or other applications that are also running on the electronic device. In some embodiments, the palette user interface includes one or more selectable options for configuring the electronic stylus to provide input to the content creation application. For instance, the selectable options of the palette user interface include options for adjusting the color, size, shape, width, and/or opacity of the input provided by the electronic stylus when the stylus interacts with the user interface of the content creation application to input content into the content creation application (e.g., handwriting, hand drawing, or the like). In some embodiments, the palette user interface includes selectable options for undoing prior inputs (described in further detail below) as well as selectable options that when selected configure the electronic stylus to act as an eraser that erases prior inputs made with the electronic stylus. In some embodiments, the placement of the palette user interface has one or more characteristics of the placement of the palette user interface described with respect to methods 700 and 1100. Using squeeze inputs to determine the user's intent to display a palette user interface minimizes the likelihood of the device erroneously displaying the palette user interface when the user does not intend to do so, thus reducing the need for inputs to manually initiate display of the palette user interface, thus minimizing the occurrence of erroneous user input associated with input to display the interface, and thereby conserving computing resources associated with correcting erroneous input.

In some embodiments, the first one or more input characteristics of the first input corresponds to a squeeze input longer than a threshold amount of time, as if in FIG. 8D, bar 812 represented a squeeze time bar, threshold 817 represented a squeeze time threshold, and intensity 815 represented the duration of the squeeze. In some embodiments, the stylus input is a stylus long press or a long press (e.g., a squeeze input longer than the threshold amount of time). A long press refers to the user maintaining pressure on the specified/predetermined area or pressure sensitive portion on the surface of the electronic stylus past a pre-determined threshold amount of time. Pressure is optionally detected as a long press input when it exceeds the pre-determined threshold amount of time. In some embodiments, the threshold amount of time for pressure upon the stylus to be detected as a long press is duration such as 0.1, 0.3, 0.5, 0.8, 1, 3, or 5 seconds or any duration in between. In an embodiment where the threshold duration is 0.5 s, stylus squeeze lasting 0.6 s is detected by the electronic device as a long press. The duration of the pressure constitutes at least one of the one or more input characteristics of the first input. In some embodiments, a long press is detected when pressure sufficient to register as a tap input by the electronic device is maintained beyond the predetermined threshold duration. When the pressure is relieved before the threshold duration, the electronic device does not register a long press input. Accordingly, for an exemplary threshold duration of 0.5 s, a stylus squeeze lasting 0.4 s is not detected by the electronic device as a stylus long press. In some embodiments, the stylus long press or long press has one or more characteristics of the stylus long press or long press described with respect to methods 700 and 1100. Providing a long press facilitates the determination of the user's intent to perform an operation due to the additional duration of squeeze required, which minimizes the likelihood of the device erroneously performing the operation when the user does not intend to do so, thus reducing the need for inputs to manually perform the operation, thus minimizing the occurrence of erroneous user input associated with input to perform the operations, and thereby conserving computing resources associated with correcting erroneous input.

In some embodiments, receiving the first input further comprises determining a squeeze intensity associated with the first input such as squeeze intensity 814 of FIG. 8C, and in accordance with a determination that the squeeze intensity associated with the first input is above a squeeze intensity threshold such as the squeeze intensity threshold 816 of FIG. 8C, the electronic device generates the tactile output having one or more tactile output characteristics. In some embodiments, the receiving a squeeze input (described above) includes receiving information about the squeeze intensity associated with the squeeze input. In some embodiments, the squeeze intensity or squeeze strength refers to a quantitative measure of the strength of the squeeze (e.g., the amount of force applied to the electronic stylus when the squeeze input is performed). As previously described, the tactile output includes a vibration in some embodiments, and an intensity of the tactile output comprises an intensity of the generated vibration. The intensity of the tactile output or vibration refers to a combination of the speed of displacement and distance of displacement of a surface of the stylus expressing the generated tactile output. The intensity of the tactile output also refers to the user's sensory perception of the combination of speed and displacement of the surface of the stylus. In some embodiments, an amount of squeeze intensity defines a threshold for squeeze intensity that when exceeded causes the electronic device to receive the squeeze intensity as an input and in response to the received input, generate a tactile output. In response to the received input, the electronic device performs an operation corresponding to the received input, in some embodiments. In some embodiments, if the determined and/or received squeeze intensity is below the squeeze intensity threshold, the device will forgo generating the tactile output despite the user having performed the physical act (e.g., a squeeze on the stylus) associated with the squeeze input. Using a squeeze intensity threshold to determine when to perform an operation and generate a tactile output minimizes the likelihood of the device erroneously performing the operation when the user does not intend to do so, thus minimizing the occurrence of erroneous user input associated with input to perform the operation, and thereby conserving computing resources associated with correcting erroneous input.

In some embodiments, the squeeze intensity threshold is a user-defined squeeze intensity threshold, such as illustrated by the squeeze intensity threshold user interface 801 in FIG. 8A. In some embodiments, the threshold for squeeze intensity is user-defined. In some embodiments, the user defines the squeeze intensity threshold using a squeeze intensity threshold user interface configured to facilitate the user entering a threshold such as described with respect to method 700. In some embodiments, receiving the user-defined squeeze threshold includes receiving an input from the user at the squeeze intensity threshold user interface indicating a preferred threshold. Using a user-defined squeeze intensity threshold to determine when to perform an operation and generate a tactile output minimizes the likelihood of the device erroneously performing the operation when the user does not intend to do so, thus minimizing the occurrence of erroneous user input associated with input to perform the operation, and thereby conserving computing resources associated with correcting erroneous input.

In some embodiments, the first one or more input characteristics corresponds to a squeeze intensity associated with the first input exceeding a first squeeze intensity threshold such as squeeze intensity 814 exceeding squeeze intensity threshold 816 in FIG. 8C, and the first tactile output has a first intensity such as tap tactile output 810 in FIG. 8C, and the second one or more input characteristics corresponds to the squeeze intensity associated with the first input exceeding a second squeeze intensity threshold such as squeeze intensity 815 exceeding squeeze intensity threshold 817 in FIG. 8D, different from the first squeeze intensity such as squeeze intensity 814 of FIG. 8C, and the second tactile output has a second intensity such as tap tactile output 810 of FIG. 8D, different from the first intensity. In some embodiments, an intensity of the tactile output generated by the electronic stylus in response to the input corresponds to or is consistent with the squeeze intensity threshold. As previously described, optionally or alternatively, the user sets the threshold squeeze intensity that enables a stylus squeeze to be received as an input by the electronic device. In some embodiments, the user defines the squeeze intensity threshold using a squeeze intensity threshold user interface configured to facilitate the user entering a threshold such as described with respect to method 700. In some embodiments, receiving the user-defined squeeze threshold includes receiving an input from the user at the squeeze intensity threshold user interface indicating a preferred threshold. In some embodiments, one or more of the input characteristics corresponds to a squeeze intensity associated with the input. When a user provides a squeeze intensity that exceeds the threshold intensity, a tactile output is generated at the electronic stylus. An intensity of the tactile output is optionally consistent with the set threshold in that the smaller the threshold and the weaker the intensity of squeeze required for an input, the weaker the tactile output generated at the stylus. Similarly, the larger the intensity threshold, the stronger the intensity of squeeze required for an input, the stronger the generated tactile output. In some embodiments, an intensity of the generated vibration is proportional to the intensity threshold. Correlating an intensity of the tactile output with a squeeze intensity threshold minimizes the likelihood of the device erroneously performing the operation when the user does not intend to do so, thus minimizing the occurrence of erroneous user input associated with input to perform the operation, and thereby conserving computing resources associated with correcting erroneous input.

In some embodiments, receiving the first input comprises detecting a release of a squeeze gesture on the electronic stylus such as the release of a squeeze gesture 804 of FIG. 8E. In some embodiments, a release of a squeeze gesture refers to the user relaxing their grip on the electronic stylus following the user's application of and/or maintenance of a squeeze or long press on the specified/predetermined or pressure sensitive area of the stylus or a mechanical button located along the side of the stylus. As previously described, the pressure detection components of the stylus are configured to detect a release of pressure following application of pressure. The release of pressure is received by the electronic device as an input, in some embodiments. In some embodiments, a predetermined squeeze intensity defines a threshold for squeeze intensity that when crossed causes the device to detect a drop of squeeze intensity below that threshold as a release of a stylus squeeze. In some embodiments, a threshold intensity above which a stylus squeeze is detected as an input is different from a threshold intensity below which a release of a stylus squeeze gesture is detected as an input. That is, the threshold intensity for detecting a squeeze as an input may be greater or smaller than the threshold intensity for detecting a release as an input, such that the squeeze intensity for generating a squeeze input may be greater or smaller than the squeeze intensity below which a release of a squeeze is detected as an input. In some embodiment, the release of the stylus squeeze is detected when no pressure is applied to the stylus following an application of pressure (i.e., when the user's grip on the pressure sensitive area of the stylus is relaxed entirely following a squeeze or a long press). Using squeeze release as inputs to determine the user's intent to perform an operation, minimizes the likelihood of the device erroneously performing the operation when the user does not intend to do so thus reducing the need for inputs to manually minimize or cease a display associated with the operation or operation user interface, thus minimizing the occurrence of erroneous user input associated with input to minimize/cease display of the operation user interface, and thereby conserving computing resources associated with correcting erroneous input.

In some embodiments, generating the tactile output comprises generating a detent tactile output at the electronic stylus such as detent tactile output 824 of FIG. 8F. In some embodiments, in response a stylus release input, the electronic device causes the stylus to generate a tactile output comprising a vibration. In some embodiments, the generated vibration in response to the release from a stylus squeeze is a detent tactile output. As previously described, the detent tactile output is characterized by a vibration perceived by the user's hand as a detent, a sudden release or snapping from mechanical tension, or an unlocking. The detent tactile output is optionally configured to exhibit a set of output characteristics that distinguish it from other tactile output generated by the stylus such that a user is unlikely to confuse the detent tactile output with the other tactile outputs such as the tap tactile output. As such, the vibration of the detent tactile output optionally has a duration shorter than that of the other tactile outputs described herein, including the tap tactile output. In some embodiments, a duration of the detent tactile output or vibration is less than 10 ms. In some embodiments, the detent tactile output optionally comprises a cycle of displacement of the vibrating component of the electronic stylus. Further, the intensity of the vibration of the detent tactile output is greater than that of the other tactile outputs described herein including the tap tactile output. Providing the user with a detent tactile output at the stylus in response to a stylus release facilitates the use of the electronic device by providing another tactile output from the device different from the tap tactile output. The availability of another tactile output helps unclutter the user interface by alleviating the need to display messages and notifications that instead, can be transmitted to the user through tactile output at the stylus for instance to help the user avoid erroneous inputs, thereby minimizing user input errors and thus conserving computing resources associated with correcting erroneous input.

In some embodiments, generating the tactile output comprises generating a tap tactile output at the electronic stylus such as the tap tactile output 810 of FIG. 8C. In some embodiments, the generated vibration is a “tap tactile output.” (previously described). As described, tactile output is generated based on one of more characteristics of the stylus input. In some embodiments, the one or more characteristics of the stylus optionally include characteristics of a response to the stylus input generated by the electronic device, or an operation performed by the electronic device in response to the stylus input. For example, the one or more characteristics of the stylus input may include the display of a user interface element in response to the stylus input, such as a prompt asking a question or asking for a further input, in some embodiments. Providing the user with a tap tactile output at the stylus in response to a stylus release facilitates the use of the electronic device by providing another tactile output from the device different from the detent tactile output. The availability of another tactile output helps unclutter the user interface by alleviating the need to display messages and notifications that instead, can be transmitted to the user through tactile output at the stylus for instance to help the user avoid erroneous inputs, thereby minimizing user input errors and thus conserving computing resources associated with correcting erroneous input.

In some embodiments, the first one or more input characteristics corresponds to an input providing a confirmation for a prompt, such as prompt user interface 826 of FIGS. 8G and 8H. In some embodiments, the tap tactile output is generated in response to a stylus input associated with a confirmation. In particular, the tap tactile output is optionally generated when the stylus input is received as a confirmation by the electronic device. The tap tactile output in such a case thus serves as an acknowledgement provided by the electronic device via the electronic stylus for the received confirmation. In some embodiments, one or more of the input characteristics correspond to the input providing the confirmation. The stylus input may be received as a confirmation by the electronic device in a variety of ways. For example, the input may be provided in response to a prompt user interface asking for a confirmation for a previous input providing a command to perform an operation at the electronic device. For example, a user may provide an input to delete an object, and the electronic device may display a prompt interface to the user asking “Are you sure you want to delete this object?” The prompt interface may be a pop up windows displaying the prompt as well as an “OK” button for confirmation and a “Cancel” button for cancelling the command to delete. If the user clicks on the OK button with the stylus, the input is received as a confirmation and a tap tactile output is generated at the electronic stylus to acknowledge the confirmation to the user. Optionally or alternatively, the stylus input received by the electronic device as a confirmation is provided to the electronic device in a variety of ways. In some embodiments, the input is a stylus squeeze such as squeeze, a long press, or a release. In some embodiments, the stylus input is a gesture such as a tap, a swipe, or a lift off. Any other means of providing an input to the electronic device using the stylus can constitute the stylus input associated with the confirmation. Providing the user with a tap tactile output at the stylus in response to a confirmation facilitates the use of the electronic device by providing another channel of communication with the user in addition to the user interface, audio interface, and any tactile output of the device itself. The availability of another communication channel with the user helps unclutter the user interface by alleviating the need to display messages and notifications that instead, can be transmitted to the user through tactile output at the stylus for instance to help the user avoid erroneous inputs, thereby minimizing user input errors and thus conserving computing resources associated with correcting erroneous input.

In some embodiments, the first one or more input characteristics corresponds to an operation performed at the electronic device in response to the first input being successful, as if in FIG. 8H, the drawing was successfully saved. In some embodiments, the tap tactile output is generated in response to a stylus input associated with a success. In particular, the tap tactile output is generated when an operation performed in response to the stylus input was successful. The tap tactile output in such a case thus serves as an acknowledgement provided by the electronic device via the electronic stylus for the successful operation. In some embodiments, one or more of the input characteristics correspond to the operation performed at the electronic device in response to the first input being successful. Successful operations at the electronic device can include opening a file, saving a file, or deleting content. For example, in the case described above where the electronic device prompts the user with whether they are sure they want to delete an object and the user confirms the deletion by clicking “OK” with the stylus, the electronic device generates a tap tactile output after the deletion to indicate that the file was successfully deleted or that the deletion operation was successful. Optionally or alternatively, the stylus input received by the electronic device and associated with the success is provided to the electronic device in a variety of ways. In some embodiments, the input is a stylus squeeze such as squeeze, a long press, or a release. In some embodiments, the stylus input is a gesture such as a tap, a swipe, or a lift off. Any other means of providing an input to the electronic device using the stylus can constitute the stylus input associated with the success. Providing the user with a tap tactile output at the stylus in response to a successful operation facilitates the use of the electronic device by providing another channel of communication with the user in addition to the user interface, audio interface, and any tactile output of the device itself. The availability of another communication channel with the user helps unclutter the user interface by alleviating the need to display messages and notifications that instead, can be transmitted to the user through tactile output at the stylus for instance to help the user avoid erroneous inputs, thereby minimizing user input errors and thus conserving computing resources associated with correcting erroneous input.

In some embodiments, the first one or more input characteristics corresponds to an operation performed in response to the first input being performed at a location outside of the user interface of the content creation application as if in FIG. 8L, such as if in FIG. 8H, the drawing was successfully saved. In some embodiments, the tap tactile output is generated in response to a stylus input associated with an off-screen response. In particular, the tap tactile output is generated after in response to the stylus input, an operation was performed outside of the user interface of the content creation application. The operation performed outside of the interface may be invisible to the user or off-screen, in some embodiments. The tap tactile output in such a case thus serves as an acknowledgement provided by the electronic device via the electronic stylus for the completion of the off-screen operation or to a response to the input that is not displayed on the screen. In some embodiments, one or more of the input characteristics correspond to operation performed off screen in response to the input. Off-screen operations can include file saving operation in response to an input, or the electronic device establishing a wireless connection, among other examples, in some embodiments. Optionally or alternatively, the tap tactile output is generated when in response to the input, an operation was performed on a part of the user interface of the content creation application that is not visible to the user and/or extends beyond the screen. For example, the electronic device optionally displays only a portion of the canvas of the content creation application (e.g., when the canvas is zoomed in) and portions of the canvas may be off-screen. A stylus input on the visible portion of the canvas can affect interface elements located on the invisible portion of the canvas. A tap tactile output is optionally generated if the operation is performed on an off-screen portion of the displayed canvas or user interface. Optionally or alternatively, the stylus input received by the electronic device and associated with the off-screen response is provided to the electronic device in a variety of ways. In some embodiments, the input is a stylus squeeze such as squeeze, a long press, or a release. In some embodiments, the stylus input is a gesture such as a tap, a swipe, or a lift off. Any other means of providing an input to the electronic device using the stylus can constitute the stylus input associated with the off-screen response. Providing the user with a tap tactile output at the stylus in response to an off-screen operation facilitates the use of the electronic device by providing another channel of communication with the user in addition to the user interface, audio interface, and any tactile output of the device itself. The availability of another communication channel with the user helps unclutter the user interface by alleviating the need to display messages and notifications that instead, can be transmitted to the user through tactile output at the stylus for instance to help the user avoid erroneous inputs, thereby minimizing user input errors and thus conserving computing resources associated with correcting erroneous input.

In some embodiments, receiving the first input having one or more input characteristics comprises detecting a shape drawn by the electronic stylus on the user interface such as the hand-drawn shape 832 of FIG. 8I, and the first one or more input characteristics corresponds to the shape corresponding to a pre-defined shape, and in response to receiving the first input and in accordance with the determination that the one or more input characteristics of the first input are the first one or more input characteristics, the electronic device displays the pre-defined shape such as the predefined shape (e.g., circle 834) of FIG. 8J. In some embodiments, the tap tactile output is generated in response to a stylus input associated with the recognition of a smart shape. In particular, the tap tactile output is generated when the electronic device determines that a shape drawn by the electronic stylus in the content creation application corresponds to a pre-defined shape stored in the application, and displays the pre-defined shape in response to the drawing. The tap tactile output in such a case thus serves as an acknowledgement provided by the electronic device via the electronic stylus for the recognition of the pre-defined shape. In some embodiments, one or more of the input characteristics correspond to the predefined shape. In some embodiments, the content creation application stores a variety of pre-defined shapes that can be recognized by the application when partially drawn using the electronic stylus. The pre-defined shapes include a square, a rectangle, a triangle, a pentagon, hexagon, and other polygons, a circle, a star, or a straight line, in some embodiments. The content creation application is configured to recognize a stylus-drawn shape when it is substantially completed such that it approximates a pre-defined shape. The stylus-drawn shape is optionally recognized when it is a substantially imperfect approximation of the predefined shape. For example, a hand-drawn approximation of a square with unequal sides and angles and non-straight lines may be recognized as or determined to be a square by the content creation application. When such a determination is made, the content creation application modifies the partially drawn shape to display the pre-defined shape in the same location, and the electronic device generates the tap tactile output at the electronic stylus to mark the recognition. Providing the user with a tap tactile output at the stylus in response to the recognition of a smart shape facilitates the use of the electronic device by providing another channel of communication with the user in addition to the user interface, audio interface, and any tactile output of the device itself. The availability of another communication channel with the user helps unclutter the user interface by alleviating the need to display messages and notifications that instead, can be transmitted to the user through tactile output at the stylus for instance to help the user avoid erroneous inputs, thereby minimizing user input errors and thus conserving computing resources associated with correcting erroneous input.

In some embodiments, receiving the first input having one or more input characteristics comprises detecting a line drawn by the electronic stylus on the user interface such as if in FIG. 8I, hand-drawn shape 832 were a hand-drawn line, and the first one or more input characteristics corresponds to the line corresponding to a straight line, and in response to receiving the first input and in accordance with the determination that the one or more input characteristics of the first input are the first one or more input characteristics, the electronic device displays the straight line such as if in FIG. 8J, the predefined shape (e.g., circle 834) were a straight line. In some embodiments, the tap tactile output is generated in response to a stylus input associated with the recognition of a straight line. In particular, the tap tactile output is generated when the electronic device determines that a line drawn by the electronic stylus in the content creation application corresponds to a straight line, and displays the straight line in response to the drawing. The tap tactile output in such a case thus serves as an acknowledgement provided by the electronic device via the electronic stylus for the recognition of the straight line. In some embodiments, one or more of the input characteristics correspond to the straight line. The content creation application is configured to recognize a line as a straight line when it is substantially straight such that it approximates a straight line. The stylus-drawn line is optionally recognized when it is a substantially imperfect approximation of the straight line. For example, a stylus-drawn line having one or more curves deviating from an imaginary straight line may be recognized as or determined to be the straight line by the content creation application. When such a determination is made, the content creation application modifies the line to display the straight line having a length in accordance with the length of the line drawn by the user, and in the same location as the line drawn by the user. The electronic device generates the tap tactile output at the electronic stylus to mark the recognition. Providing the user with a tap tactile output at the stylus in response to the recognition of a straight line facilitates the use of the electronic device by providing another channel of communication with the user in addition to the user interface, audio interface, and any tactile output of the device itself. The availability of another communication channel with the user helps unclutter the user interface by alleviating the need to display messages and notifications that instead, can be transmitted to the user through tactile output at the stylus for instance to help the user avoid erroneous inputs, thereby minimizing user input errors and thus conserving computing resources associated with correcting erroneous input.

In some embodiments, generating the tactile output comprises generating a round tap tactile output at the electronic stylus such as the round tap tactile output 848 of FIG. 8N. In some embodiments, the generated vibration is a round tap tactile output. As previously described, the round tap tactile output is optionally characterized by a vibration of the stylus perceived by the user as longer yet weaker against the user's hand. The round tap tactile output is optionally configured to exhibit a set of output characteristics that distinguish it from other tactile output generated by the stylus such that a user is unlikely to confuse the round tap tactile output with the other tactile outputs. As such, the vibration of round the tap tactile output optionally has a duration of at least 100 ms and low intensity in relation to other types of tactile output described in this disclosure. In particular, the vibration of the round tap optionally has a duration greater than those of both the tap and the detent tactile outputs. However, the intensity of the round tap vibration is optionally lower than those of both the tap and the detent tactile outputs. Further, in some embodiments, the round tap tactile output optionally comprises two of more cycles of displacement of the vibrating component of the electronic stylus. As described, round tap tactile output is optionally generated based on one of more characteristics of the stylus input. In some embodiments, the one or more characteristics of the stylus optionally include characteristics of a response to the stylus input generated by the electronic device, or an operation performed by the electronic device in response to the stylus input. For example, the one or more characteristics of the stylus input may include an association with an animation, a failure, an eraser, limits of a slider, in some embodiments and will be described further below. Providing the user with a round tap tactile output at the stylus in response to a stylus release facilitates the use of the electronic device by providing another tactile output from the device different from the tap and the detent tactile outputs. The availability of another tactile output helps unclutter the user interface by alleviating the need to display messages and notifications that instead, can be transmitted to the user through tactile output at the stylus for instance to help the user avoid erroneous inputs, thereby minimizing user input errors and thus conserving computing resources associated with correcting erroneous input.

In some embodiments, the first one or more input characteristics corresponds to an input resulting in an interface element of the content creation application being displayed according to an animation sequence as if in FIG. 8H, prompt user interface 826 ceased being displayed gradually according to an animation sequence. In some embodiments, the round tap tactile output is generated in response to a stylus input associated with an animation. In particular, the tap tactile output is generated when in response to the stylus input, an interface element of the content creation application initiates an animation sequence having a duration. The round tap tactile output is optionally generated concurrently with the animation sequence, in some embodiments. For example, the palette user interface is displayed by the device according to an animation sequence. In some embodiments, as part of the animation sequence, initially on a center portion of the palette user interface is displayed and gradually over time the display of the palette user interface expands out (gradually revealing more of the palette user interface) from the center portion until eventually the entirety of the palette interface is displayed (similar to the example described with respect to method 700). In some embodiments, the round tap tactile output is generated concurrently with such an animation sequence. For example, the round tap tactile output is generated concurrently with a cursor animation or an animation of an interface element or a selected drawing disappearing into a trash can during an exemplary deletion operation. In some embodiments, the round tap tactile output is generated during a subset of the duration of the animation sequence. For example, with the exemplary deletion operation, the round tap tactile output is optionally generated at the beginning of the motion of the deleted interface element toward the trash can, but not at the end of the animation sequence showing the element reaching the trash can. In some embodiments, the round tap tactile output is generated continuously through the duration of the animation sequence (e.g., from the start of the motion toward the trash can to the disappearance into the can) and thus matches the duration of the animation sequence. In some embodiments, the stylus input that launched the animation sequence has a duration, and the round tap tactile output is generated concurrently with the stylus input and ends when the stylus input stops. In such a case, the animation sequence optionally continues after both the stylus input and the round tap tactile output have ended. In some embodiments, the round tap tactile output is generated concurrently with the stylus input and continues past the end of the duration of the stylus input and concurrently with the animation sequence. Optionally or alternatively, the stylus input received by the electronic device and associated with the animation sequence is provided to the electronic device in a variety of ways. In some embodiments, the input is a stylus squeeze such as squeeze, a long press, or a release. In some embodiments, the stylus input is a gesture such as a tap, a swipe, or a lift off. Any other means of providing an input to the electronic device using the stylus can constitute the stylus input associated with the animation response. Providing the user with a round tap tactile output at the stylus in response to an animation sequence facilitates the use of the electronic device by providing another tactile output from the device different from the tap and the detent tactile outputs. The availability of another tactile output helps unclutter the user interface by alleviating the need to display messages and notifications that instead, can be transmitted to the user through tactile output at the stylus for instance to help the user avoid erroneous inputs, thereby minimizing user input errors and thus conserving computing resources associated with correcting erroneous input.

In some embodiments, the first one or more input characteristics corresponds to an input for which an operation performed at the electronic device was not successful as if in FIG. 8H, the saving operation was not successful. In some embodiments, the round tap tactile output is generated in response to a stylus input associated with a failure. In particular, the round tap tactile output is generated when an operation performed in response to the stylus input was not successful. The round tap tactile output in such a case thus serves as a notice provided by the electronic device via the electronic stylus for the failure of the operation. In some embodiments, one or more of the input characteristics correspond to the input that resulted in the unsuccessful operation. Unsuccessful or failed operations at the electronic device can include failure at opening a file, saving a file, or deleting content. For example, in the case described above where the electronic device prompts the user with whether they are sure they want to delete an object and the user confirms the deletion by clicking “OK” with the stylus, the electronic device generates a round tap tactile output after the deletion attempt to indicate that the attempt failed (for example because the file is write-protected). Optionally or alternatively, the stylus input received by the electronic device and associated with the failure is provided to the electronic device in a variety of ways. In some embodiments, the input is a stylus squeeze such as squeeze, a long press, or a release. In some embodiments, the stylus input is a gesture such as a tap, a swipe, or a lift off. Any other means of providing an input to the electronic device using the stylus can constitute the stylus input associated with the unsuccessful or failed operation. Providing the user with a round tap tactile output at the stylus in response to a failed operation facilitates the use of the electronic device by providing another channel of communication with the user in addition to the user interface, audio interface, and any tactile output of the device itself. The availability of another communication channel with the user helps unclutter the user interface by alleviating the need to display messages and notifications that instead, can be transmitted to the user through tactile output at the stylus for instance to help the user avoid erroneous inputs, thereby minimizing user input errors and thus conserving computing resources associated with correcting erroneous input.

In some embodiments, the first one or more input characteristics corresponds to the electronic stylus being used to delete a previous input of the stylus such as the deleted previous input (e.g., corresponding to erasures 844) of FIG. 8N. In some embodiments, the round tap tactile output is generated in response to a stylus input associated with an eraser. In particular, in the content creation application, the electronic stylus is optionally configured to undo or erase prior inputs made by the stylus on the canvas, in some embodiments. When the eraser function is selected, a stylus gesture such as a tap or a swipe on the location of a drawing previously made using the stylus erases a portion of the drawing at the point of contact. In response to each erasure of portion of drawing, the electronic device generates a round tap tactile output at the stylus. The round tap tactile output in such a case thus serves to provide a tactile feel of an erasing pencil to the user, as well as provide an additional notification of the erasure to the user. In some embodiments, the round tap tactile output is generated for the duration of the erasure of the portion of drawing, or for the duration of the engagement of the stylus with the portion of drawing. In some embodiments, the tactile output begins when the stylus configured to function as an eraser touches down on the canvas or user interface of the contact creation application and stops when the stylus lifts off from the canvas or user interface. Optionally, the round tap tactile output stops when the stylus configured as an eraser stops moving during an erasure. Optionally, the round tap tactile output stops when the stylus ceases to be configured to function as an eraser (e.g., when the eraser function is deselected by the user or otherwise turned off). Optionally or alternatively, the stylus input received by the electronic device and associated with the eraser is provided to the electronic device in a variety of ways. In some embodiments, the input is a stylus squeeze such as squeeze, a long press, or a release. In some embodiments, the stylus input is a gesture such as a tap, a swipe, or a lift off. Any other means of providing an input to the electronic device using the stylus can constitute the stylus input associated with the eraser. Providing the user with a round tap tactile output at the stylus in response to an erasure facilitates the use of the electronic device by providing another channel of communication with the user in addition to the user interface, audio interface, and any tactile output of the device itself. The availability of another communication channel with the user helps unclutter the user interface by alleviating the need to display messages and notifications that instead, can be transmitted to the user through tactile output at the stylus for instance to help the user avoid erroneous inputs, thereby minimizing user input errors and thus conserving computing resources associated with correcting erroneous input.

In some embodiments, the first one or more input characteristics corresponds to a contact of the electronic stylus with a slider bar followed by a motion of the stylus such that the stylus reaches a first end of the slider bar as if in FIG. 8L, state slider bar 836 were a straight slider bar and the motion of the electronic stylus 800 had reached its end. In some embodiments, the round tap tactile output is generated in response to a stylus input associated with a hitting the limit of a slider bar. In particular, the round tap tactile output is generated when in response to the stylus's contact with the slider bar followed by a further motion (to move the slider bar), the electronic device determines that the stylus is at an end of the slider bar. In some embodiments, the slider bar is a state slider bar and is configured to allow the user to undo and/or redo multiple inputs to the content creation application in response to inputs received at the state slider bar (e.g., the user interacts with the state slider bar using the electronic stylus and/or a portion of their body such as their finger), such as described for example with respect to method 700. In some embodiments, the round tap tactile output in such a case thus serves as notice to the user that a limit of the slider bar has been reached. Providing the user with a round tap tactile output at the stylus in response to hitting an end of a slider bar facilitates the use of the electronic device by providing another channel of communication with the user in addition to the user interface, audio interface, and any tactile output of the device itself. The availability of another communication channel with the user helps unclutter the user interface by alleviating the need to display messages and notifications that instead, can be transmitted to the user through tactile output at the stylus for instance to help the user avoid erroneous inputs, thereby minimizing user input errors and thus conserving computing resources associated with correcting erroneous input.

In some embodiments, generating the tactile output comprises generating a detent tactile output at the electronic stylus such as the detent tactile output 824 of FIG. 8L. In some embodiments, the generated vibration is a “detent tactile output.” (previously described). As described, tactile output is generated based on one of more characteristics of the stylus input. In some embodiments, the one or more characteristics of the stylus include characteristics of a response to the stylus input generated by the electronic device, or an operation performed by the electronic device in response to the stylus input. For example, the one or more characteristics of the stylus input may include crossing tick marks on a slider bar or inputs associated with a retarget. Providing the user with a detent tactile output at the stylus in response to a stylus release facilitates the use of the electronic device by providing another tactile output from the device different from the tap tactile output. The availability of another tactile output helps unclutter the user interface by alleviating the need to display messages and notifications that instead, can be transmitted to the user through tactile output at the stylus for instance to help the user avoid erroneous inputs, thereby minimizing user input errors and thus conserving computing resources associated with correcting erroneous input.

In some embodiments, the first one or more input characteristics corresponds to the electronic stylus making contact with a tick mark of a plurality of tick marks of a slider bar of the content creation application, such as the ticks marks 838 and 838a of the state slider bar 836 of FIGS. 8K and 8L. In some embodiments, the detent tactile output is generated in response to a stylus input associated with crossing the tick marks on a slider bar. In some embodiments, a slider bar features ticks marks, which are visible marks or other marks that denote increments or intervals of the slider bar, for example as described with respect to method 1100. During operation of the slider bar by the stylus, the stylus is moved across one or more tick marks. When tick mark is crossed, the electronic device generates a detent tactile output at the electronic stylus. The detent tactile output serves to provide an acknowledgment to the user that an increment or an interval of the slider bar has been crossed. Providing the user with a detent tactile output at the stylus in response to crossing a tick mark on a slider bar facilitates the use of the electronic device by providing another tactile output from the device different from the tap tactile output. The availability of another tactile output helps unclutter the user interface by alleviating the need to display messages and notifications that instead, can be transmitted to the user through tactile output at the stylus for instance to help the user avoid erroneous inputs, thereby minimizing user input errors and thus conserving computing resources associated with correcting erroneous input.

In some embodiments, the first one or more input characteristics corresponds to a target of the electronic stylus changing from a first element in the user interface of the content creation application to a second element in the content creation application as if in FIG. 8G, the target of the electronic stylus 800 changed from the “No” button to the “Yes” button 828. In some embodiments, the detent tactile output is generated in response to a stylus input associated with a retarget. In particular, the detent tactile output optionally is generated when the electronic device changes a target of the stylus from a first element in the user interface of the content creation application to a second element in the content creation application. In some embodiments, the stylus is determined by the electronic device to target an element when it touches down on the element. For example, a text box on the user interface is determined to be targeted when the stylus touches down on the text box to provide input. In some embodiments, the stylus is determined to target an element when the device determines that the stylus points towards that element, that is, when a vector longitudinal to the stylus and extending from the tip of the stylus intersects with the interface element. For example, the device determines that a stylus target a button when the device determines that the stylus is pointing toward it. In some embodiments, the stylus is determined by the electronic device to target an element when the element is located in an area of the under interface toward which the stylus is pointing. Optionally, multiple elements are determined to be targeted by the stylus in this case. For example, the stylus may be determined to target both a button and a text box adjacent to the button when it is pointed toward the area of the user interface where both the button and the text box are located. In some embodiments, an element of the user interface is determined to be targeted if the element would receive input if input is provided at the stylus. For example, the stylus may be optionally configured to engage a button when a stylus squeeze input is provided, in which case the button to be engaged in response to the input is the targeted element. The electronic device optionally retargets the electronic stylus by changing the target from a first element targeted by the stylus to a second element, and a detent tactile output is generated at the electronic stylus upon retargeting. The detent tactile output upon retargeting serves to notify the user of the retargeting. In some embodiments, an indication of targeting associated with the first element may shift to being associated with the second element after the retargeting. Optionally or alternatively, the stylus input received by the electronic device that the device repositions and corrects as described above is provided to the device in a variety of ways. In some embodiments, the stylus input is a gesture such as a tap or a swipe. Providing the user with a detent tactile output at the stylus in response to retargeting facilitates the use of the electronic device by helping unclutter the user interface and alleviating the need to display messages and notifications that instead, can be transmitted to the user through tactile output at the stylus for instance to help the user avoid erroneous inputs, thereby minimizing user input errors and thus conserving computing resources associated with correcting erroneous input.

It should be understood that the particular order in which the operations in FIG. 9 have been described, optionally including the additional and/or alternatives operations to the illustrated operations in FIG. 9 described herein, is merely exemplary and is not intended to indicate that the described order is the only order in which the operations could be performed. One of ordinary skill in the art would recognize various ways to reorder the operations described herein.

### Associated User Interfaces for Palette User Interfaces

In some embodiments, the palette user interface (described in detail above) includes various features that allow the user to customize the output generated by the electronic stylus (e.g., the visual output generated by the device when it detects the electronic stylus is providing input to the device). Also as described in detail above, the size footprint of the palette user interface is kept small so as to minimize any visual occlusions to the user interface of the content creation application that may be caused by displaying the palette user interface. In some instances, selectable options associated with the palette user interface, when selected by the user (e.g., using the electronic stylus) require further input from the user (e.g., to specify further details about the selectable option) in the form of a separate user interface that also includes one or more selectable options. However, since the size of the palette user interface is small, displaying other user interfaces in response to selection of selectable option of the palette user interface can become visually cumbersome since displaying two separate user interfaces on the content creation application creates a substantial risk that one or more portions of the visual content of the content creation application will be visually occluded by the display of multiple user interfaces for configuring the output of the electronic stylus. The embodiments described below provide ways in which an electronic device displays an expanded options user interface that is associated with various selectable options of the palette user interface and other interactions with the palette user interface, thus enhancing the user's interaction with the device. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

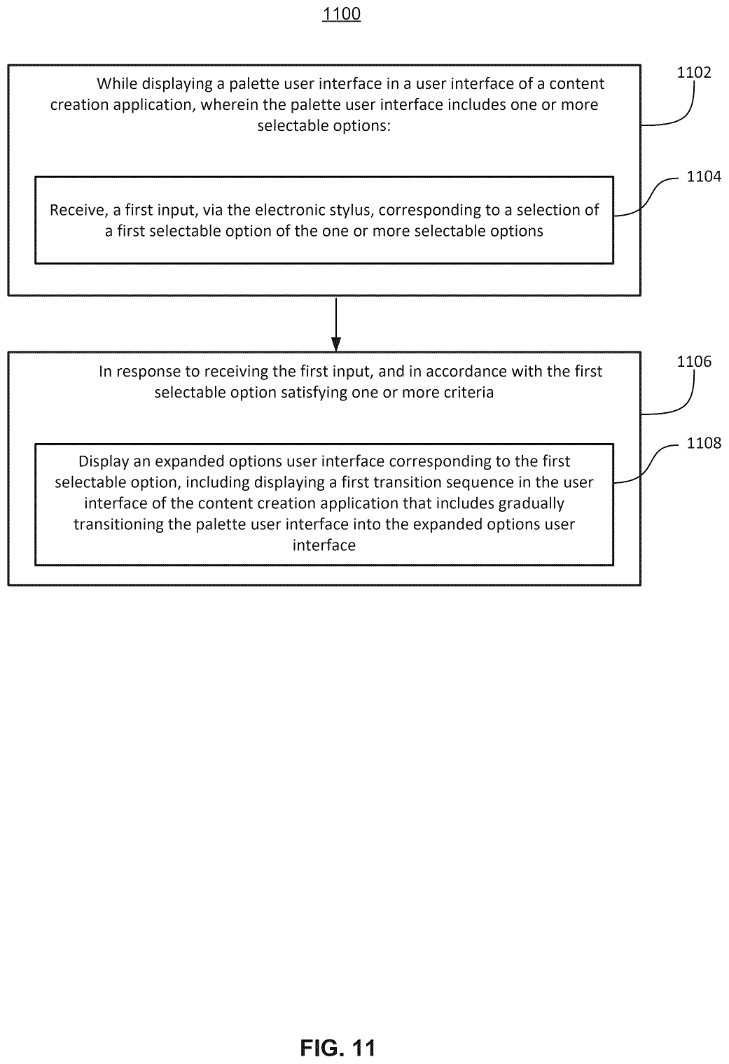

FIG. 10A-10W illustrate examples of an electronic displaying a mini-palette user interface on a content creation application including associated expanded options user interfaces. The embodiments in these figures are used to illustrate the processes described below, including the processes described with reference to FIG. 11. Although FIGS. 10A-10W illustrate various examples of ways an electronic device is able to perform the processes described below with respect to FIG. 11, it should be understood that these examples are not meant to be limiting, and the electronic device is able to perform one or more processes described below with reference to FIG. 10 in ways not expressly described with reference to FIGS. 10A-10W.

FIG. 10A illustrates an exemplary device 500 displaying a user interface 1002. In some embodiments, the user interface 1002 is displayed via a display generation component 504. In some embodiments, the display generation component 504 is a hardware component (e.g., including electrical components) capable of receiving display data and displaying a user interface. In some embodiments, examples of a display generation component include a touch screen display, a monitor, a television, a projector, an integrated, discrete, or external display device, or any other suitable display device.

In some embodiments, an electronic device (e.g., device 500) includes a content creation application that represents visual content that is generated by a user using an electronic stylus or other input device. In some embodiments, the content creation application at user interface 1002, receives inputs from an electronic stylus 1004. For instance, in some embodiments, in response to the user applying a squeeze input 1003, and while the electronic stylus 1004 is a distance 1006 away from the display 504 that is above a threshold 1008, device 500 displays palette user interface 1018. As described above, palette user interface 1018 includes one or more selectable options (described above) that allows for the user to customize the visual content 1016 that is generated by device 500 in response to inputs provided by the electronic stylus 1004 (as described above). In some embodiments, palette user interface 1018 includes an undo selectable option 1020 and a redo selectable option 1022 that when selected respectively undo and redo prior inputs to the content creation application that were applied by electronic stylus 1004.

In some embodiments, the user using hand 1010 selects undo selectable option 1020 of palette user interface 1018 as illustrated in FIG. 10B. In the example of FIG. 10B, the user selects undo selectable option 1020 by bringing the stylus 1004 within a distance 1006 that is within threshold 1008 (e.g., touching or near hovering) of display 504 and at a location on user interface 1002 that is at or in close proximity undo selectable option 1020 as illustrated in FIG. 10B. In some embodiments, in response to the selection of undo selectable option 1020, device 500 undoes (e.g., deletes) one of portions 1024a-1 of visual content 1016 that was last added by the user using stylus 1004 as illustrated in FIG. 10C.

As illustrated in FIG. 10C, in response detecting selection of selectable option 1020, device 500 undoes/deletes portion 1024a of visual content 1016 which corresponds to the portion of visual content 1016 that was last inputted by the user. In some embodiments, a “portion” of a visual content comprises a portion of the visual content that was created when the electronic stylus initially contacts display 504 at user interface 1002, moves in a direction on the user interface 1002, and finally is lifted off of display 504. In some embodiments, if the user wishes to undo and/or redo multiple portions 1024a-1 of visual content 1016, the user can initiate display of a state slider bar as illustrated in FID. 10D.

In the example of FIG. 10D, and in order to initiate a state slider bar, the device 500 detects that the user (via input from electronic stylus 1004) is performing a “long press” input on undo selectable option 1020 of palette user interface 1018. In some embodiments, a “long press” is detected when device 500 detects that stylus 1004 is selecting (e.g., by placing stylus 1004 on undo selectable option 1020) for a duration 1012 that is longer than a threshold duration 1014. In some embodiments, and in response to detecting that stylus 1004 is performing a long press on undo selectable option 1020, device 500 initiates a process to display a state slider bar as illustrated in FIG. 10E.

As illustrated in FIG. 10E, rather than displaying a state slider bar in addition to the palette user interface, device 500 collapses the palette user interface on to point 1026 (the point at which the stylus 1004 is making contact with display 504. In some embodiments, the process of displaying the state slider bar is referred to a “reflow” in which the palette user interface is visually morphed from being a palette user interface to being a state slider bar. Thus, in some embodiments, after the palette user interface is visually collapsed onto point 1026 according a first animation that shows the palette user interface collapsing onto point 1026, the state slider bar is displayed according to a second animation in which the state slider bar is expanded from point 1026 as shown in FIG. 10F.

As illustrated in FIG. 10F, upon the conclusion of the second animation sequence that expands to state slider bar 1028 from point 1026, device 500 displays state slider bar 1028 as a continuous (e.g., ring shaped) state slider bar. The example of a continuous slider bar is means as an example and is not meant to be limiting. Thus, in some embodiments, state slider bar 1028 can be displayed using an alternative shape that is not continuous such as a rectangular bar with a first and second end, or in any alternative shape (continuous or otherwise). In some embodiments, state slider bar includes one or more tick marks 1030, with each tick mark representing a portion of the one or more portions 1024a-1 of visual content 1016 that can be undone and/or redone based on inputs that are applied to state slider bar 1028 (described in further detail below).

In some embodiments, the circumference of state slider bar can be based on the number of portions 1024a-1 of visual content 1016 that can be undone/redone. Additionally or alternatively, the state slider bar can be shorter or longer than the number of inputs that are available to be redone/undone. In the event that the state slider bar is shorter than the number of inputs that are available to be undone/redone, optionally, a tick mark 1030 of the state slider bar can correspond to multiple portions 1024a-1 of visual content 1016 such that the user can go over a tick mark multiple times when undoing and redoing portions (e.g., applying a continuous input that is repeated even if the user has traversed over a single circumference of the state slider bar). In some embodiments, state slider bar 1028 includes a current state button 1032 that the user slides across state slider bar 1028 to undo/redo various portions 1024a-1 of visual content 1016. For instance, when stylus 1004 drags current state button 1032 (e.g., by contacting current state button 1032 and dragging it) to the left by a single tick mark 1030, device 500 undoes (e.g., deletes) portion 1024b as illustrated in FIG. 10G.

As illustrated in the example of FIG. 10 G, in response to detecting movement of current state button 1032 to the left (e.g., commensurate with the direction of an undo operation) device 500 deletes portion 1024b, which represents the most recent portion that was added to visual content 1016 that is still displayed (portion 1024a having been previously undone as described above with respect to FIG. 10C). In some embodiments, portion 1024b is undone/deleted when current state button 1032 is moved over a tick mark that corresponds to portion 1024b as illustrated in FIG. 10G. As described above, when the device detects that the current state button 1032 has been dragged over tick mark 1030 that corresponds to portion 1024b, the device deletes portion 1024b and causes a haptic to be generated at stylus 1004 thereby providing tactile feedback to the user indicating that an undo/redo operation has been performed by device 500. In some embodiments, as the user slides/drags current state button 1032 further to the left, more portions 1024a-1 of visual content 1016 are deleted/undone by device 500. For instance, as illustrated in FIG. 10H, in response to detecting that current state button 1032 has been dragged to the left over another tick mark 1030, device 500 undoes/deletes portion 1024c, which represents the most recent portion that was added to visual content 1016 that is still displayed (portions 1024a and 1024b having been previously undone as described above).

In some embodiments, when the device detects that the electronic stylus 1004 is dragging the current state button 1032 in the opposite direction (e.g., to the right/clockwise), the device redoes or reinstates a previously deleted portion 1024a-1 as illustrated in FIG. 10I. In the example of FIG. 10I, electronic stylus 1004 drags current state button 1032 to the right, crossing over a tick mark 1030 (that was previously crossed over during a deletion of a portion of the visual content 1016). In response to detecting that the current state bar 1032 has crossed a tick mark 1030, device 500 reinstates/displays portion 1024c (which represents the last portion in time to have been previously deleted). In some embodiments, in response to detecting that current state button 1032 has been dragged further to the right by another tick mark 1030, device 500 reinstates another previously deleted portion of visual content 1016 as illustrated in FIG. 10J. In the example of FIG. 10J, device 500 detects that current state button 1032 is moved further to the right over the tick mark 1030 corresponding to portion 1024b. In response to detecting that the current state bar 1032 has crossed the tick mark 1030, device 500 reinstates/displays portion 1024b (which represents the last portion in time to have been previously deleted). Similarly, as device 500 detects that current state button 1032 is moved further to the right/clockwise, and crosses another tick mark 1030, device 500 reinstates another portion of visual content 1016 as illustrated in FIG. 10K. In the example of FIG. 10K, device 500 reinstates portion 1024a is reinstated in response to detecting that current state button 1032 has been dragged to the right/clockwise over another tick mark 1030.

In some embodiments, and as there are no other portions of visual content 1016 that are available to be redone/reinstated, in response to detecting that current state button 1032 is being dragged further to the right, device 500 implements a rubber-band effect (described in detail below with respect to method 1100) that is configured to provide an indication to the user that there are no other portions available to be redone. Similarly in the event that there are no further portions to be deleted, upon detecting that current state button 1032 is being dragged further to the left/counter clock-wise, device 500 will apply the rubber-band effect to the motion so as to indicate to the user that there are no further portions available for deletion.

In some embodiments, the user can provide an input to device 500 via electronic stylus 1004 that when received by the device, causes device 500 to close/cease display of state slider bar 1028 as illustrated in FIG. 10L. In the example of FIG. 10L, device 500 in response to detecting that electronic stylus 1004 is a distance 1006 away from display 504 that is above threshold 1008, and in response to a squeeze input 1003, ceases display of the state slider bar.

In some embodiments, the reflow animation process described above with converting the palette user interface into a state slider bar can be applied with other types of selectable options that are associated with the palette user interface. For instance, in some embodiments palette user interface 1018 includes a color selectable option 1034 as illustrated in FIG. 10M. In some embodiments, in response to detecting that color selectable option 1034 has been selected (e.g., in substantially the same manner as undo selectable option 1020 described above with respect to FIG. 10B), device 500 changes the color that is generated by device 500 as part of visual content 1016 in response to inputs detected from stylus 1004. In some embodiments, similar to the example described above with respect to undo selectable option 1020, device 500 initiates a process to display a color picker user interface associated with color selectable option 1034 in response to detecting a long press of color selectable option 1034 (e.g., a contact with color selectable option that is for a duration 1012 that is longer than a threshold 1014) as illustrated in FIG. 10N.

In the example of FIG. 10N, in response to a long press of color selectable option 1034, initiates a process to display a color palette user interface. In some embodiments, and as illustrated in FIG. 10N, device reflows the palette user interface 1018 by first displaying an animation that collapses palette user interface 1018 to a single point 1052, and then displays a second animation that depicts color palette user interface 1038 expanding from point 1052 as illustrated in FIG. 10O (and similar to the example of the state slider bar described above). In some embodiments, color palette user interface 1036 includes a gradient of colors that are displayed on it, with any point on the color palette user interface being selectable and in response to detecting selection of a point, device 500 changes the color of the output of stylus 1004 in accordance with the selected color. Additionally and/or alternatively, color palette user interface 1036, alternatively to a gradient, displays one or more discrete color selectable options. In some embodiments, when device 500 detects that the electronic stylus has selected a discrete option of the one or more color selectable options, device 500 changes the color of the output of stylus in accordance with the selected color.

As described above, palette user interface 1018 includes only a subset of the selectable option includes on expanded palette user interface 612 (described above with respect to 6A) in order to minimize the size footprint of the palette user interface. Thus, in some embodiments, the user can change the options that are displayed on the palette user interface (to reveal additional selectable options) using stylus 1004 as illustrated at FIG. 10P. In the example of FIG. 10P, palette user interface 1018 includes selectable options 1038-c corresponding to an eraser, a marker, and a pencil respectively. In some embodiments, when device 500 detects a swipe input 1005 (which includes detecting that stylus 1004 while making contact with or within a distance 1006 that is below threshold 1008), device 500 changes the selectable options that are displayed on palette user interface 1018 as illustrated in FIG. 10Q. As illustrated in FIG. 10Q, in response to detecting swipe input 1005, device 500 replaces selectable options 1038a-c with selectable options 1040a-c that corresponds to a ruler, a fine tip pen, and thicker tip pen respectively. The selectable options 1038a-c and 1040a-c illustrated in FIGS. 10P-10Q respectively, are meant as exemplary only and should not be seen as limiting to the disclosure. In some embodiments, and as illustrated in FIG. 10Q, while some selectable options are replaced in response to a swipe input 1005, some selectable options are retained. In some circumstance, the selectable options that are retained when a swipe input is performed pertain to options are frequently used during a user's interaction with a content creation application such as undo selectable option 1020. In some embodiments, in response to detecting a swipe input 1005, device 500 displays an animation sequence in which the selectable options to be replaced are shown as moving and disappearing from palette user interface 1018, while the selectable options that are replacing them are displayed as moving onto the palette user interface in place of the selectable options that are moving off of the palette user interface.

In some embodiments, palette user interface 1018 includes one or more selectable options that do not include any associated user interfaces, and thus when device 500 determines that they are selected, device 500 ceases display of the palette user interface (after configuring the output of the stylus 1004 in accordance with the selected option) as illustrated in FIGS. 10R-10S. In the example of FIG. 10S, device 500 detects that stylus 1004 is making contact with selectable option 1040b which corresponds to a fine tip pen (as described above). In some embodiments, selectable option 1040b does not have any associated user interfaces (e.g., to further configure the fine tip pen), and thus, in response to detecting that selectable option 1040b has been selected, device 500 configures the output of electronic stylus 1004 to operate as a fine tip pen and ceases display of palette user interface 1018 as illustrated in FIG. 10S. In some embodiments, in response to a squeeze input 1003, and when device 500 detects that stylus 1004 is a distance 1006 that is beyond threshold 1008, device 500 displays palette user interface 1018 as illustrated in FIG. 10T.

In some embodiments, palette user interface 1018 includes one or more selectable options that have an associated user interface, but the associated user interface is limited and not as large in terms of size and options as the state slider bar and/or color palette user interfaces described above. Thus, optionally, rather than perform a reflow to collapse palette user interface 1018, and expand the associated user interface, device 500 displays the associated user interface concurrently with the palette user interface 1018 as illustrated in FIG. 10U. As illustrated in FIG. 10U, in response to a selection of selectable option 1040b (illustrated in FIG. 10T) device 500, displays menu user interface 1042 that is associated with selectable option 1040b. As illustrated in FIG. 10U, menu user interface 1042 is a limited menu insofar as the number of selectable options included on menu user interface 1042 is small and thus can be displayed concurrently with palette user interface 1018. As an example, menu user interface 1042 that is associated with a thicker pen selectable option 1040b, includes a plurality of selectable options for configuring the desired thickness of the pen. In some embodiments, when device 500 detects that the user selects a selectable option of menu user interface 1042, the device ceases display of menu user interface 1042 while continuing to display palette user interface 1018. Additionally or alternatively, in response to detecting that the user selects a selectable option of menu user interface 1042, device 500 ceases displays of both menu user interface 1042 as well as palette user interface 1018.

In some embodiments, device 500 detects selection of a selectable option of palette user interface 1018 with a release of the squeeze input that initiated display of palette user interface 1018 as illustrated in FIG. 10V. For instance, and as illustrated in FIG. 10V, when the device detects that a squeeze input 1003 is being released on stylus 1004 while the stylus is above or at selectable option 1040b (while also being a distance 1006 that is above threshold 1008), device 500 configures the output of stylus 1004 in accordance with selectable option 1040b (e.g., the fine tip pen), and ceases display of the palette user interface 1018 as illustrated in FIG. 10W. As illustrated in FIG. 10W, device 500 has ceased displaying palette user interface 1018 (and has instead displayed tool status indicator user interface 1050, described above with respect to FIGS. 6A-6L). As demonstrated by the example of FIGS. 10R and 10V, a selectable option of palette user interface 1018 can be selected in multiple ways. For instance, in the example of FIG. 10R, selectable option 1040b is selected when the device determines that the electronic stylus 1004 is making contact with the selectable option. In the example of FIG. 10V, selectable option 1040b is selected when the device determines that the user is releasing a squeeze input when the stylus is directed to the selectable option. However, in both instances, the ultimate result is the same, which in the case of selectable option 1040b includes ceasing display of the palette user interface.

FIG. 11 is a flow diagram illustrating a method 1100 for displaying additional user interfaces associated with a palette user interface, in accordance with some embodiments. The method 1100 is optionally performed at an electronic device such as device 100, device 300, device 500 or device 580, as described above with reference to FIGS. 1A-1B, 2-3, 4A-4B and 5A-5I. Some operations in method 1100 are, optionally combined and/or order of some operations is, optionally, changed.

In some embodiments, method 1100 is performed at an electronic device in communication with a display generation component and one or more input devices, wherein the one or more input devices include an electronic stylus: In some embodiments, the electronic device, display generation component, and the one or more input devices including the electronic stylus share one or more characteristics with the electronic device, display generation component, and input devices described with respect to methods 700 and 900.

In some embodiments, while displaying, via the display generation component, a palette user interface in a user interface of a content creation application, wherein the palette user interface includes one or more selectable options (1102), the electronic device receives (1104) a first input, via the electronic stylus, corresponding to a selection of a first selectable option of the one or more selectable options such as detecting that the tip of stylus 1004 is making contact with selectable option 1022 in FIG. 10B. In some embodiments the palette user interface, the user interface, and the content creation application include one or more characteristics of the palette user interfaces, the user interfaces of the content creation application, and content creation applications described with respect to methods 700 and 900. In some embodiments, the selectable options of the palette user interface include options that when selected by the user (e.g., by pressing and/or touching-down the tip of the stylus on the selectable option) configure the one or more characteristics of input from the electronic stylus into the content creation application (e.g., configure the response of the electronic device and/or content creation application to input from the stylus). For instance, the selectable options of the palette user interface include (but are not limited to): one or more tools (such as a pencil, paintbrush, marker) an eraser for erasing previously inputted content, one or more color options that configure the color of the output (e.g., the color that the device generates in response to an input from the stylus), and an undo button (described in further detail below) for undoing previous inputs to the content creation application. In some embodiments, the first input includes the electronic stylus and/or a tip of the electronic stylus touching a portion of the electronic device and/or a portion of the user interface and/or a portion of a touch-sensitive display corresponding to (e.g., displaying) a selectable option of the one or more selectable options of the palette user interface. In some embodiments, the first input includes detecting the electronic stylus and/or a tip of the electronic stylus hovering above or within (e.g., within a threshold distance above or within 0, 0.01, 0.05, 0.1, 0.2, 0.5, 0.8, 1, 3, 5, 10, 30, 50 or 100 cm) a selectable option of the palette user interface. In some embodiments, the first input in addition to touch or hovering over a selectable option of the palette user interface can also include detecting that the user has applied a squeeze gesture to the electronic stylus. In some embodiments, the squeeze gesture has one or more characteristics of the squeeze gesture described above with respect to methods 700 and 900. In some embodiments, in response to receiving the first input, and in accordance with the first selectable option satisfying one or more criteria (1006) (e.g., the first selectable option has a pre-defined expanded options user interface associated with it), the electronic device displays (1108), via the display generation component, an expanded options user interface corresponding to the first selectable option, including displaying a first transition sequence in the user interface of the content creation application that includes gradually transitioning the palette user interface into the expanded options user interface such as state slider bar 1028 in FIG. 10F being displayed according to a transition sequence illustrated in FIGS. 10D-10E. In some embodiments, an expanded options user interface has a pre-defined association with one or more of the selectable options of the palette user interface. In some embodiments, one or more selectable options are each associated with their own expanded options user interface. In some embodiments, an expanded options user interface associated with one of the selectable options of the one or more selectable options includes one or more selectable options that are associated with the selectable option of the palette user interface. For instance, in the electronic device determines that the user has selected a selectable option pertaining to a particular tool (e.g., the electronic device will cause the displayed output in response to the input from the electronic stylus to appear as if it was made by a tool such as a marker, pen, and/or pencil), then the electronic device in response to receiving the selection of the tool opens an expanded selectable options user interface that is associated with the selected tool and that includes one or more selectable options for configuring the selected tool such as picking the width, size, or other feature associated with the tool. In some embodiments, the selectable options displayed in the expanded selectable options user interface are not displayed as part of the palette user interface. In some embodiments, selection of the tool in the palette user interface, in addition to opening the expanded selectable options, causes the electronic device to select the tool such that tool is active and is used when the electronic device receives input from the electronic stylus. In some embodiments, the electronic device, rather than abruptly ceasing display of the palette user interface and replacing it with the expanded user options user interface, instead displays a transition sequence that gradually transitions the palette user interface into the expanded user interface. In some embodiment transitioning “into” refers to a transition sequence in which the electronic device, rather than ceasing display of the palette user interface and replacing it with the expanded options user interface instead displays an animation that visually morphs the palette user interface into the appearance of the expanded options user interface such that from the perspective of the user viewing the transition sequence, the palette user interface looks as if it was converted into the expanded options user interface rather than being replaced by the expanded options user interface. For instance, in some embodiments, gradually transitioning the palette user interface into the expanded options user interface includes expanding and/or contracting the size of the palette user interface until it is the size of the expanded options user interface while fading out the selectable options of the palette user interface and replacing them with the selectable options of the expanded options user interface. Additionally or alternatively, gradually transitioning the palette user interface into the expanded options user interface includes contracting the palette user interface into a predetermined shape and then expanding the pre-determined shape into the shape of the expanded options user interface while also displaying the selectable options associated with the expanded options user interface. In some embodiments, after the palette user interface is transitioned into the expanded options user interface, the original palette user interface is no longer displayed by the electronic device. Transitioning the palette user interface into an expanded options user interface according to a transition sequence provides the user of the electronic device with visual feedback of the association between the palette user interface and the expanded options user interface thus minimizing the likelihood of erroneously portraying the expanded options user interface to the user, such as by causing the user to mis-associate the expanded options user interface with another displayed user interface, and avoids abrupt changes to the context of interaction of the user with the palette user interface, thus minimizing the occurrence of erroneous user input and thereby conserving computing resources associated with correcting erroneous input.

In some embodiments, the first selectable option of the palette user interface is an undo button configured to undo a previous input to the content creation application such as undo button 1020 in FIG. 10C. In some embodiments, the undo button on the palette user interface is configured to allow the user to undo the last input that entered into the content creation application. In some embodiments, an input refers an input from the electronic stylus that generates a visual output (e.g., a line, a shape, text) on the content creation application. In some embodiments, the beginning of an input occurs when the electronic stylus (or other input device/means) makes contact with the device/user interface of the content creation application and ends when the electronic stylus is lifted off (e.g., no longer touching) the device/user interface. In some embodiments, when the device has detected that the undo button has been selected (for instance by the user pressing the undo button with the electronic stylus or their finger when the undo button is displayed as part of the palette user interface), the device will undo and/or delete the last input that was provided by the electronic stylus or other input means. In some embodiments, each time the undo button is detected as being selected by the user another previous input to the content creation will be undone and/or deleted until there are no more previous inputs to be undone. In some embodiments, the palette user interface is configured to allow the user to redo a previously deleted/undone inputs. In some embodiments, the palette user interface includes a selectable redo option. Optionally, the “redo button” is activated/engaged is substantially the same manner as the undo button described above. Providing an undo button minimizes the amount of input necessary to correct erroneous input and minimizes the likelihood of generating further erroneous input to correct the erroneous input, thereby conserving computing resources associated with correcting erroneous input.

In some embodiments, the expanded options user interface corresponding to the undo option comprises a state slider bar such as state slider bar 1028 in FIG. 10F. In some embodiments, the state slider bar is configured to allow the user to undo and/or redo (described in further detail below) multiple inputs to the content creation application in response to inputs received at the state slider bar (e.g., the user interacts with the state slider bar using the electronic stylus and/or a portion of their body such as their finger).

In some embodiments, while displaying the state slider bar, the electronic device receives a second input, via the electronic stylus at the state slider bar, wherein the second input comprises a contact from the stylus with the state slider bar followed by motion of the electronic stylus relative to the state slider bar while contacting the state slider bar such as the input provided to current state button 1032 in FIGS. 10F-10K. In some embodiments, the electronic device detects that the electronic stylus has contacted the state slider bar thus indicating the user's intent to undo and/or redo previous inputs to the content creation application. Once the electronic device determines that the user is attempting to undo/redo prior input, the electronic device detects motion of the electronic stylus while it is making contact with the state slider bar to determine the number of inputs to undo/redo. In some embodiments, the number of inputs to undo/redo is based on the distance of the motion of the electronic stylus once it has made contact with the state slider bar. For instance, if the device after determining that the stylus has made contact with the state slider bar and was then moved a first distance across the state slider bar, will undo two inputs that were previously inputted in the content creation application. If the device determines that the movement was a second distance that twice the distance of the first distance, the device will undo four input that were previously inputted in the content creation application. Thus, in some embodiments, the number of inputs that are undone/redone is proportional to the distance that the electronic stylus is moved across the state slider bar once the device detects that that the stylus has made contact with the state slider bar. In some embodiments, in response to the second input: in accordance with a determination that the motion of the electronic stylus is in a first direction, the electronic device undoes a previous input to the content creation application such as in FIGS. 10F-10H (wherein stylus 1004 is moving counter clockwise), and in accordance with a determination that the motion of the electronic stylus in a second direction, the electronic device reinstates a previously undone input to the content creation application such as in FIGS. 10I-10K (wherein stylus 1004 is moving clockwise). In some embodiments, the direction of motion of the electronic stylus is used by the electronic device to infer the user's intent as to whether they wish to undo and/or redo previous inputs. For instance, in the example where the state slider bar is straight (e.g., line shaped, or rectangle shaped), the device will undo an input if the device determines that the motion of the electronic stylus (after making contact with the state slider bar) is to the right. In an example, wherein the state slider bar is circular (described in further detail below), the device will undo one or more inputs if the device determines that the motion of the electronic stylus is clockwise. If the motion of the electronic stylus is in the opposite direction (in either the straight or circular embodiments of the state slider bar), the electronic device will redo previous inputs, wherein the number of inputs that are redone is commensurate/proportional to the distance of travel of the electronic stylus after it has made contact with the state slider bar. Providing a state slider bar to undo and redo previous inputs to the content creation application minimizes the amount of input necessary to correct erroneous input and minimizes the likelihood of generating further erroneous input to correct the erroneous input, thereby conserving computing resources associated with correcting erroneous input.

In some embodiments, the first input includes selection of the first selectable option for longer than a threshold amount of time such as stylus 1004 making contact for a duration 1014 that is longer than time threshold 1012 in FIG. 10D. In some embodiments, the state slider bar differentiates the user's intent to undo a single previous input (e.g., by selecting the undo button) with the user's intent to display the state slider bar, using an amount of time that the user presses the undo button with the electronic stylus. For instance, if the device detects that that the electronic stylus has pushed the undo button (e.g., by making contact with the undo button using the electronic stylus) beyond a threshold amount time (e.g., a long press), then the device displays the state slider bar. However, if the time of contact (e.g., the time between when the stylus first made contact with the undo button until the time when the stylus ceased making contact with the undo button) is below the threshold, then the device undoes the last input to the content creation application (as described above). In some embodiments, the threshold time is a period of time such as 0, 0.01, 0.05, 0.1, 0.2, 0.5, 0.8, 1, 3, 5, 10, 30, 50 or 100 seconds. Displaying the state slider after the device detects a long press of the undo button with the electronic stylus, minimizes the likelihood of erroneously displaying the state slider bar, when the user only intended to undo the last input to the content creation application, thereby conserving computing resources associated with having to provide inputs to remove the state slider bar from being displayed when display of the state slider bar was not intended.

In some embodiments, the state slider bar includes one or more tick marks such as tick marks 1030 of state slider bar 1028 illustrated in FIG. 10F. In some embodiments, a tick mark refers to a visible line or other mark that is disposed on the state slider bar. In some embodiments a tick mark provides a visual indicator as to the number of inputs to be redone or undone when the electronic stylus is moved along the state slider bar (e.g., an input to the state slider bar as described above). In some embodiments, the number of tick marks that are crossed when performing an input provides a visual indication to the user as to the number of inputs that are going to be undone or redone based on the input that is being applied to the state slider bar. In some embodiments, while displaying the state slider bar, the electronic device receives a third input, via the electronic stylus at the state slider bar, wherein the third input comprises a contact from the stylus with the state slider bar followed by motion of the electronic stylus while contacting the state slider bar such as the input provided current state button 1032 in FIGS. 10F-10H. In some embodiments, the third input shares one or more characteristics with the first and second inputs described above, such as comprising a contact with the state slider bar followed by movement of the electronic stylus while the stylus is in contact with the state slider bar. In some embodiments, in response to the third input: in accordance with a determination that the motion of the electronic stylus is in a first direction, and in accordance with a determination that motion of the electronic stylus crosses over a first number of tick marks of the state slider bar during the third input, the electronic device undoes a first number of previous inputs to the content creation application, in accordance with a determination that the motion of the electronic stylus is in the first direction (such as illustrated by inputs 1024b-c being undone by the input provided to state slider bar 1028 by stylus 1004 in FIGS. 10F-H, and in accordance with a determination that motion of the electronic stylus crosses over a second number, different from the first number of tick marks of the state slider bar during the third input, the electronic device undoes a second number of previous inputs to the content creation application, wherein the second number of previous inputs is different than the first number of previous inputs. In some embodiment, the tick marks of the state slider bar provide the user with a visual representation of the number of inputs that are to be undone in response to the user's input when the motion of the input is in the direction that corresponds to undoing inputs. Thus, in some embodiments, rather than having to judge the distance of the motion to ensure that it corresponds to the number of inputs the user wishes to be undone, the user can use the tick marks as a visual indicator to determine how many inputs will be undone based on the motion of the input. In some embodiments, the electronic device, in addition to or alternatively to the embodiments described above, determines the number of tick marks crossed by the motion of the user's input to determine the number of inputs that are to be undone (when the motion of the input is in the direction of undoing inputs as described above). In some embodiments, the number of tick marks that are visible on the state slider bar correspond to the number of undo/redo states that exist (e.g., that are available to be undone/redone). For instance, if there are only 4 inputs that have occurred on the content creation application, then the state slider bar will have 4 tick marks visible, with each tick mark corresponding to an input of the 4 inputs that are available to be undone/redone. In some embodiments, in accordance with a determination that the motion of the electronic stylus is in a second direction, different than the first direction, and in accordance with a determination that the motion of the electronic stylus crosses over a third number of tick marks of the state slider bar during the third input, the electronic device reinstates a first number of previous deleted inputs to the content creation application (such as inputs 1024b-c being reinstated in response to the motion of current state button 1032 in a clock wise direction in FIGS. 10I-10K), and in accordance with the determination that the motion of the electronic stylus is in the second direction, and in accordance with a determination that the motion of electronic stylus crosses over a fourth number, different from the third number, of tick marks of the state slider bar during the third input, the electronic device reinstates a second number of previous deleted inputs to the content creation application, wherein the second number of previously deleted inputs is different than the first number of previously deleted inputs. In some embodiments, the number of tick marks also provide a visual indication of how many inputs to the content creation application are to be redone when the motion of the input to the state slider bar is in the direction associated with redoing inputs. Thus, in some embodiments, rather than having to judge the distance of the motion to ensure that it corresponds to the number of inputs the user wishes to be redone, the user can use the tick marks as a visual indicator to determine how many inputs will be redone based on the motion of the input. In some embodiments, the electronic device, in addition to or alternatively to the embodiments described above, determines the number of tick marks crossed by the motion of the user's input to determine the number of inputs that are to be redone (when the motion of the input is in the direction of redoing inputs as described above). Providing tick marks on the state slider bar to undo and redo previous inputs to the content creation application minimizes the likelihood of erroneous input associated with redoing or undoing more or less inputs than desired, thereby conserving computing resources associated with correcting erroneous input.

In some embodiments, the third input includes the motion of the electronic stylus crossing over a tick mark of the slider bar. In some embodiments, in response to the motion of the electronic stylus crossing over the tick mark of the slider bar, the electronic device initiates a process to generate a tactile output at the electronic stylus such as illustrated and described above with respect to FIG. 8L. In some embodiments, the tactile output shares one or more characteristics of the tactile outputs described above with respect to method 900, including but not limited the vibration patterns (e.g., tap, detent, and/or round tap) described with respect to method 900. In some embodiments, a tactile output is initiated when the device detects that the electronic stylus has crossed a tick mark during its motion corresponding to input on the state slider bar. In some embodiments, the tactile response is a detent, and shares one or more of the characteristics of a detent tactile response described with respect to method 900. In some embodiments, the duration of the tactile response is coordinated by the electronic device such that a tactile response made in response to crossing a first tick mark of the state slider bar has ceased before the electronic stylus crosses a second tick mark. Thus, in some embodiments, the device determines the speed that the electronic stylus is moving across the state slider bar and bases the duration of the tactile response based on the determined speed thereby ensuring that a tactile response for the first tick mark will not interfere with the tactile response associated with crossing a second tick mark. Providing tactile output response on the state slider bar to undo and redo previous inputs to the content creation application minimizes the likelihood of erroneous input associated with redoing or undoing more or less inputs than desired, thereby conserving computing resources associated with correcting erroneous input.

In some embodiments a shape of the state slider bar is continuous such as the shape of state slider bar 1028 in FIG. 10F. In some embodiments, while displaying the continuous shaped state slider bar, the electronic device receives a fourth input from the electronic stylus at a first portion of the slider bar, followed by movement of the electronic stylus in a first direction along the state slider bar, and in response to receiving the movement of the electronic stylus in the first direction: in accordance with a determination that the movement of the electronic stylus that followed the fourth input has returned to the first portion of the state slider bar: in accordance with a determination that one or more states of one or more inputs to the content creation application are available for access via the state slider bar, the electronic device continues undoing prior inputs in accordance with the further movement of the electronic stylus in the first direction beyond the first portion such as if the stylus 1004 moved current state button 1032 of state slider bar 1028 further clockwise in FIG. 10K. In some embodiments, a continuous shape refers to a shape in which there is no end or beginning point such as a circular shape (e.g., circle, oval, ovoid). In some embodiments, when the user is providing input to the state slider bar, rather than being constrained (in terms of the amount of movement that can be performed) by a non-continuous slider bar that has an end point such that the user can only move until the end point, a continuous state slider bar allows for more input, since there is no end or beginning point. Thus, when using a continuous state slider, the user can continuously apply input to the state slider bar, even passing the initial point at which the input was applied (e.g., going around the continuous state slider bar multiple times) so long as there are still inputs to the content creation application that can be undone/redone. In some embodiments, if the movement of the electronic stylus reaches the end of the available states before getting back to the beginning point, the device will not continue undoing prior input in accordance with movement past the tick mark that corresponds to the last available state that can be undone. In some embodiments, the continuous state slider bar includes one or more tick marks (described above) that provides the user with a visual indication as to how many inputs to the content creation application are to be undone/redone based on the movement associated with the input to the state slider bar by the user using the electronic stylus. Providing a continuous state slider bar to undo and redo previous inputs to the content creation application minimizes the likelihood of erroneous input associated with redoing or undoing less inputs than desired by avoiding constraints on movement associated with non-continuous state slider bars that have a beginning and end point, thereby conserving computing resources associated with correcting erroneous input.

In some embodiments, a length of the state slider bar is based on a number of previous inputs to the content creation application stored at the electronic device such as illustrated by the length of state slider bar (e.g., circumference) 1028 in FIG. 10F. In some embodiments, as each input (described above) is entered into the content creation application (using the stylus or other input means), the electronic device stores the inputs in a memory of the device. In some embodiments, when the device receives an indication to display the state slider bar (described above) the device calculates/determines the length of the state slider bar (or the circumference in the case of a continuous state slider bar described above) based on the number of inputs stored in the memory of the electronic device. In some embodiments, based on the number of inputs stored in the memory of the electronic device, the device determines the length of the state slider bar such that the state slider bar includes the same number of tick marks. Thus, in some embodiments, the length and/or circumference of the state slider bar is based on the number of tick marks needed to provide a tick mark for each input to the content creation application stored at the electronic device. In some embodiments, the length of the state slider bar is proportional to the number of states that are available to be undone/redone (e.g., the more states there are, the longer the state slider bar). In some embodiments, if the number of states available to be undone/redone is less than a predefined threshold (e.g., 3, 4, 6, 8, 10 states) than the state slider bar is not displayed as a continuous state slider bar (such as a circle as described above described above) but instead is displayed in a bar shape with distinct beginning and end points. In some embodiments, if the number of states is above the predefined threshold, then the device displays the state slider bar in a continuous shape (e.g., a circle) as described above. Setting the length of the state slider bar to be commensurate with the number of inputs to the content creation application minimizes the likelihood of erroneous input associated with redoing or undoing less inputs than desired by avoiding constraints on movement when providing input to the state slider bar, thereby conserving computing resources associated with correcting erroneous input.

In some embodiments, the state slider bar includes a first end. In some embodiments, while displaying the state slider bar, the electronic device receives a fourth input, via the electronic stylus at the state slider bar, wherein the fourth input comprises a contact from the stylus with the state slider bar followed by motion of the electronic stylus beyond the first end of the state slider bar; and in response to receiving the fourth input, the electronic device displays an animation of a rubber band effect at the first end of the state slider bar such as if stylus 1004 was detected as trying to drag current state button 1032 further clockwise when no more portions 1024a-1 of visual content 1016 are available to be reinstated. In some embodiments, the rubber band effect refers to a visual response in which a visual indicator that is used to indicate the position of the stylus on the state slider bar is pushed beyond a limit of the state slider bar by the user controlling the electric stylus and once the user removes the contact of the stylus with the state slider bar, the device moves the visual indicator back to the limit of the state slider bar. For instance, in the example of the continuous (e.g., circular) state slider bar, if the device detects that the user is entering input into the state slider bar (as described above) and the motion of the stylus goes beyond the last possible tick mark that corresponds to an undo and/or redo operation (because there are no more input to undo and/or redo), the visual indicator will continue to move with the user's input, however once the device detects that the user has terminated the input (by detecting that the electronic stylus no longer is in contact with the state slider bar), the device moves the visual indicator back to the tick mark that corresponded to the last possible undo and/or redo that was possible (e.g., snaps back the visual indicator in a manner similar to a rubber band that returns to its natural form after being stretched beyond its natural form). In some embodiments, the rubber band effect includes moving the visual indicator back to the limit of the state slider bar gradually over time. Additionally, the rubber band effect includes moving the visual indicator back to the limit of the state slider bar gradually over time and at non-linear/non-uniform speed. In some embodiments, and as part of the rubber band effect, when the device detects that the visual indicator has surpassed the limit of the state slider bar, the device may limit the responsiveness of the visual indicator to the motion of the electronic stylus. For instance, once the electronic stylus moves beyond the limit of the state slider bar, the visual indicator used to show the position of the electronic stylus moves at a rate that is slower than the rate of motion of the stylus, such that the visual indicator will begin to lag or be behind the position of the electronic stylus on the state slider bar. In some embodiments, once there are no more states to be undone/redone, the device no longer undoes/redoes any states based on further movement of the electronic stylus across the state slider bar. Applying the rubber band effect to the state slider bar when the user surpasses the limit of the state slider bar while providing input to the state slider bar minimizes the likelihood of erroneous input associated with the user providing input that is beyond the limits of the state slider bar, thereby conserving computing resources associated with correcting erroneous input.

In some embodiments, the first selectable option of the palette user interface is color selection option configured to select a color associated with a graphical response by the electronic device displayed in response to an input by the electronic stylus in the user interface of the content creation application such as color selectable option 1034 in FIG. 10M. In some embodiments, the color selection option of the palette user interface is configured to change the color of the visual output provided by the electronic stylus to the content creation application. For instance, in an example where the user is using the electronic stylus to free hand draw in the content creation application, the stylus generates a marking in accordance with the motion of the stylus when it is making contact with the user interface of the content creation application. In this example, the color selection option of the palette user interface when selected by the user, changes the color that the device outputs for the markings when the user applies an input to the user interface of the content creation application. In some embodiments, the color selection option is configured to provide the user with the option of selecting a previous color that was set for the visual output caused by the electronic stylus prior to the current color that is set for the output generated in response to the stylus input. Providing a color selection option on the palette user interface minimizes the amount of input required to change the color of the visual output that is generated by the device in response to stylus inputs to the content creation application, thereby conserving computing resources associated with the extra input that would be required to change the color without the color selectable option of the palette user interface.

In some embodiments, the expanded options user interface corresponding to the color selection option comprises a color palette user interface such as color palette user interface 1036 in FIG. 10O. In some embodiments, the color palette user interface is configured to allow the user to select a color from a plurality of colors, wherein each color of the plurality of colors is represented by a selectable option on the color palette user interface. In some embodiments, while displaying the color palette user interface, the electronic device receives a second input, via the electronic stylus at the color palette interface, wherein the second input comprises a contact from the stylus with one or more selectable options of the color palette interface. In some embodiments, each selectable option of the color palette user interface is distinct from one another (e.g., each selectable option is separated by white space between the selectable option and adjacent selectable options). Additionally or alternatively, the color palette user interface includes a gradient of colors beginning on one end with a first color and ending on the opposite end with a second color, wherein the colors in between transition from the first color to the second color with no white spaces between color options, such that input at any part of the color palette user interface will select a color for the graphical output generated by the device in response to inputs from the stylus at the content creation application. In such an example, each distinct color displayed on the color palette user interface represents a selectable o. In some embodiments, the color palette user interface is continuous (e.g., ring shaped) similar to the state slider bar described above. In some embodiments, in response to the second input: in accordance with a determination that the contact from the stylus is at a first selectable option of the color palette interface, the electronic device sets the color associated with the graphical response by the electronic device in response to the input by the electronic stylus in the user interface of the content creation application to a first color such as the selectable option selected by input from stylus 1004 to color palette user interface 1036 in FIG. 10O, and in accordance with a determination that the contact from the stylus is at a second selectable option of the color palette interface different from the first selectable option, the electronic device sets the color associated with the graphical response by the electronic device in response to the input by the electronic stylus in the user interface of the content creation application to a second color different from the first color such as if the device detects that stylus 1004 is contacting color palette user interface 1036 at a different location than the one illustrated in FIG. 10O. In some embodiments, once the device detects that the user, via the electronic stylus, has selected a color from the color palette user interface (for instance by making contact with a color from the color palette user interface with the electronic stylus, and then raising the electronic stylus away from the color palette user interface, thereby indicating selection of a color), the electronic device ceases display of the color palette user interface, and sets the color of the graphical output associated with the input from the electronic stylus according to the color selected from the color palette user interface. Providing a color palette user interface configured to receive a selection of color from the user via the electronic stylus minimizes the amount of input necessary to select a color and minimizes the thereby conserving computing resources associated with the extra amount of input necessary to select a color without the color palette user interface.

In some embodiments, the second input includes selection of the second selectable option for longer than a threshold amount of time such as color selectable option 1034 being selected for a duration of time 1014 that is longer than threshold 1012 in FIG. 10M. In some embodiments, the color palette user interface differentiates the user's intent to configure the color of the graphical output to the previous color (e.g., by selecting the color selection option of the palette user interface) with the user's intent to display the color palette user interface, using an amount of time that the user presses the color selection option with the electronic stylus. For instance, if the device detects that that the electronic stylus has pushed the color selection option (e.g., by making contact with the color selection option using the electronic stylus) beyond a threshold amount time (e.g., a long press), then the device displays the color palette user interface. However, if the time of contact (e.g., the time between when the stylus first made contact with the color selection option until the time when the stylus ceased making contact with the color selection option) is below the threshold, then the device configures the color of the graphical output to a previous color used on the content creation application (as described above). Alternatively, if the time of the contact is below the threshold, a limited menu of colors is displayed by the device for the user to pick from. In some embodiments, the threshold time is a period of time such as 0, 0.01, 0.05, 0.1, 0.2, 0.5, 0.8, 1, 3, 5, 10, 30, 50 or 100 seconds. Displaying the color palette user interface after the device detects a long press of the undo button with the electronic stylus, minimizes the likelihood of erroneously displaying the color palette user interface, when the user only intended to revert to the last color used in the content creation application, thereby conserving computing resources associated with having to provide inputs to remove the color palette user interface from being displayed when display of the color palette user interface was not intended.

In some embodiments, in response to receiving the first input, and in accordance with the first selectable option satisfying the one or more criteria, the electronic device displays, via the display generation component, the expanded options user interface including: in accordance with a determination that a pose of the electronic stylus is a first pose relative to the user interface when the first input is received, the electronic device displays the expanded options user interface with a first spatial arrangement relative to the user interface such as the orientation and location of color palette user interface 1036 in response to the position of stylus 1004 in FIG. 10, and in accordance with a determination that the pose of the electronic stylus is a second pose, different from the first pose, relative to the user interface when the first input is received, the electronic device displays the expanded options user interface with a second spatial arrangement, different from the first spatial arrangement, relative to the user interface such as if color palette user interface 1036 were displayed in a different location based on a different pose of stylus 1004 in FIG. 10O. In some embodiments, the relationship between the pose of the electronic stylus when the first input is received and the spatial arrangement that the expanded options user interface is displayed with relative to the user interface shares one or more characteristics with the relationship between the pose of the electronic stylus and the spatial arrangement that the palette user interface is displayed at as described above with respect to method 700. Thus, in some embodiments, two different poses of the electronic stylus when the first input is received will yield two different spatial arrangements relative the user interface at which the electronic device displays the expanded options user interface. By determining the spatial arrangement to display the expanded options user interface based on the pose of the electronic stylus, the electronic device ensures that the expanded options user interface is not occluded by the stylus when it is initially displayed similar to how the device displays the palette user interface as described above with respect to method 700. In some embodiments, the electronic device in response to two different stylus positions that nonetheless have the same orientation with respect to the user interface, display, and/or electronic device, displays the expanded options user interface at two different locations but at the same orientation with respect to the electronic device, display, and/or user interface. In some embodiments, the electronic device in response to two different stylus orientations that nonetheless have the same location with respect to the electronic device, display, and/or user interface, displays the expanded options user interface at two different orientations but at the same location respect to the electronic device, display, and/or user interface. Displaying the expanded options user with a spatial arrangement with respect to the user interface based on the pose of the electronic stylus allows for the expanded options user interface to be displayed on the electronic device at a location that minimizes the likelihood that one or more portions of the expanded options user interface will be visually occluded when displayed thus reducing the need for inputs to manually move/reorient the expanded options user interface, thus minimizing the occurrence of erroneous user input associated with visual occlusions to the expanded options user interface and/or input to reorient/move the expanded options user interface, and thereby conserving computing resources associated with correcting erroneous input.

In some embodiments, the first selectable option is a first tool selection option configured to select a tool associated with a graphical response by the electronic device displayed in response to an input by the electronic stylus in the user interface of the content creation application such as selectable options 1038a-c in FIG. 10P. In some embodiments, the tool selection option of the palette user interface is configured to change the appearance of the visual output provided by the electronic stylus to the content creation application that is commensurate with tool selected using the tool selection option. For instance, in an example where the user is using the electronic stylus to free hand draw in the content creation application, the stylus generates a marking in accordance with the motion of the stylus when it is making contact with the user interface of the content creation application. In this example, the tool selection option of the palette user interface when selected by the user, changes a characteristic of the graphical output that the device outputs for the markings when the user applies an input to the user interface of the content creation application. For instance, a “ball point pen” tool will cause the device to generate a thin, fine line when the electronic stylus is being used to draw. In contrast a “marker” tool will generate a thicker line. Providing a tool selection option on the palette user interface minimizes the amount of input required to change a characteristic of the visual output that is generated by the device in response to stylus inputs to the content creation application, thereby conserving computing resources associated with the extra input that would be required to change the characteristic without the tool selectable option of the palette user interface.

In some embodiments, the palette user interface comprises a second selectable option, wherein the second selectable option is a second tool selection option. In some embodiments, in accordance with a first use history of the electronic stylus in the content creation application, the electronic device displays the first and second tool selection options in a first order on the palette user interface such as the order of selectable options in 10P being in response to the use history of the user, and in accordance with a second use history of the electronic stylus in the content creation application, different from the first use history, the electronic device displays the first and second tool selection options in a second order on the palette user interface, different from the first order such as if selectable options 1038a-1038c being arranged in a different order based on a second use history in FIG. 10P. In some embodiments, the use history refers to past tool settings that were used to generate graphical output on the content creation application. For instance, if the during a user session with the content creation application, the user is using a fourth tool setting, after previously using a first, second, and third (in that order) tool settings during the session prior to using the fourth tool setting, then the electronic device when displaying the tool selections options will display them in an order that mimics the use history of the tools. Using the above example, the tool selection options will be displayed on the palette user interface in an order that places the third tool selection option (corresponding to the third tool setting) closest to the tip of the electronic stylus, the second tool selection option (corresponding to the second tool setting) the next closest to the tip of the electronic stylus, and the first tool selection option (corresponding to the first tool setting) the further from the tip of the electronic stylus. In some embodiments, since the distance between a tool setting and the tip of the electronic stylus is based on the use history as demonstrated above, the order in which the tool selection options are displayed on the palette user interface will be based on the use history of the tools. In some embodiments, the order refers to the order of the tool settings options when looking from left to right (or down to up in the case that the palette user interface is vertically oriented) and/or a first end to a second end on the palette user interface. Displaying the tool setting on the palette user interface based on the use history of the tool settings minimizes the likelihood of user error when selecting a tool setting by putting the tools that have been not used the longest furthest away from the tip of the electronic stylus, thereby conserving computing resources associated with the extra input that would be required to correct erroneous tool selections.

In some embodiments, the first input includes selection of the first selectable option for longer than a threshold amount of time such as if menu user interface 1042 in FIG. 10U were reflowed from palette user interface 1018 similar to the examples of state slider bar 1028 and color palette user interface 1036 described above. In some embodiments, the expanded options user interface corresponding to a tool selection option of the palette user interface is configured to allow the user to configure the tool that was selected using the tool selection option. For instance, the user using the expanded options user interface associated with the tool selection option can configure a thickness, opacity, texture, and/or brightness associated with the selected tool using the expanded options user interface associated with the selected tool selection option. In some embodiments the device differentiates the user's intent to select a tool (e.g., by selecting the tool selection option of the palette user interface) with the user's intent to display the expanded options user interface associated with the tool selection option, using an amount of time that the user presses the tool selection option with the electronic stylus. For instance, if the device detects that that the electronic stylus has pushed the tool selection option (e.g., by making contact with the color selection option using the electronic stylus) beyond a threshold amount time (e.g., a long press), then the device displays the expanded options user interface associated with the tool. However, if the time of contact (e.g., the time between when the stylus first made contact with the tool selection option until the time when the stylus ceased making contact with the tool selection option) is below the threshold, then the device configures the graphical output of the content creation application based on the selected tool (as described above) (e.g., the device selects the tool corresponding to the selected option as the current tool). In some embodiments, the threshold time is a period of time such as 0, 0.01, 0.05, 0.1, 0.2, 0.5, 0.8, 1, 3, 5, 10, 30, 50 or 100 seconds. In some embodiments, the characteristics described above with respect to the first tool selection option also applies to other tool selection options (e.g., a second and/or third) tool selection option that are also displayed on the palette user interface. Displaying the expanded options user interface associated with a selected tool after the device detects a long press of the corresponding tool selection option with the electronic stylus, minimizes the likelihood of erroneously displaying the expanded options user interface, when the user only intended to select to a tool for use in the content creation application, thereby conserving computing resources associated with having to provide inputs to remove the expanded options user interface from being displayed when display of the expanded options user interface was not intended.

In some embodiments, while displaying the palette user interface, the electronic device receives a second input at the palette user interface, wherein the second input comprises a contact from the stylus at the palette user interface followed by motion of the electronic stylus relative to the palette user interface while contacting the palette user interface such as input 1005 in FIG. 10P, and in response to the second input, the electronic device displays one or more additional selectable options, different from the one or more selectable options such as selectable options 1040a-c in FIG. 10Q being displayed in response to input 1005 instead of options 1038a-c in FIG. 10P. In some embodiments, the contact from the stylus at the palette user interface followed by motion of the electronic stylus while contacting the palette user interface comprises a “swipe” input at the palette user interface, which when detected by the electronic device causes the device to display the one or more additional selectable options on the palette user interface that were not previously being displayed on the palette user interface. In some embodiments, when displaying the one or more additional options, the additional options are displayed according to an animation sequence in which the options that were being displayed are gradually removed from being displayed and the additional options are then gradually (over time) displayed on the palette user interface. For instance, the previous options move across and out from the palette user interface, and then the additional options are shown as moving into the palette user interface. Displaying additional options on the palette user interface in response to a swipe inputs allows for more options to be displayed on the palette user interface without requiring the size of the palette user interface to increase, thereby minimizing the amount of visual occlusion to the user interface of the content creation application caused by display of the palette user interface, thus minimizing the occurrence of erroneous user input associated with visual occlusions to the user interface of the content creation application, and thereby conserving computing resources associated with correcting erroneous input.

In some embodiments, the first input comprises contact by the electronic stylus with the first selectable option of the one or more selectable options such the contact with selectable option 1040b by stylus 1004 in FIG. 10R. In some embodiments, the one or more selectable options of the palette user interface are selected when the electronic stylus comes in to contact with any given selectable option (and the contact is less than the threshold amount of time as described above). Allowing the user to select a selectable option of the palette user interface by contacting the stylus with the selectable options minimizes the likelihood of erroneously selection a selectable option, thereby conserving computer resources associated with correction erroneous selection of a selectable option.

In some embodiments, in response to receiving the first input, and in accordance with the first selectable option not satisfying the one or more criteria: the electronic device performs an action associated with the first selectable option. In some embodiments, if the first selectable option does not have an expanded options user interface associated with it (e.g., not satisfying the one or more criteria), the device performs an action associated with selection of the selectable option without displaying an expanded options user interface. For instance, the device optionally configures the input generated by the electronic stylus on the content creation application to have one or more characteristics that are associated with the selected first selectable option. For instance, if the selectable option corresponds to a tool selection such as a highlighter and/or marker tool, upon detecting that the user has selectable such a selectable option, the device configures the output according to the selected tool and closes the palette user interface in response to detecting the selection. In some embodiments, the electronic device ceases display of the palette user interface without displaying the expanded options user interface such as the selection of option 1040b causing the tool to be selected and the palette to be closed in FIG. 10S. In some embodiments, if a selectable option does not have an expanded options user interface associated with it, then upon selection of the selectable option (described above) the electronic device ceases display of the palette user interface thereby removing any visual occlusions to the user interface of the content creation application associated with display of the palette user interface. Ceasing display of the palette user interface in response to a selection of a selectable option that does not have an expanded options user interface associated with it, minimizes the amount of time that the palette user interface visually occludes the user interface of the content creation application, thus minimizing the occurrence of erroneous user input associated with visual occlusions to the user interface of the content creation application, and thereby conserving computing resources associated with correcting erroneous input.

In some embodiments, in response to receiving the first input, and in accordance with the first selectable option not satisfying the one or more criteria (e.g., not having an expanded options user interface associated with it): the electronic device displays a menu user interface associated with the first selectable option while maintaining display of the palette user interface such as menu user interface 1042 being displayed concurrently with palette user interface in FIG. 10U. In some embodiments, one or more selectable options of the palette user interface may not have a large number of associated settings and configurations associated with them to warrant an expanded options user interface, however it may have a small number of settings and configurations to warrant the display of a smaller menu user interface. In some embodiments, the menu user interface is a smaller (from a size perspective) version of the expanded options user interface and thus shares one or more characteristic with the expanded options user interface described above. In some embodiments, since the size footprint of the menu user interface is smaller, the device continues to display the palette user interface while the menu user interface is being displayed since the combined visual occlusion to the user interface of the content creation application caused by both the menu user interface and the palette user interface being displayed together would not warrant ceasing display of the palette user interface when the menu user interface is displayed. In some embodiments, the menu user interface associated with a tool has one or more selectable options pertaining to selecting a thickness and/or texture of the tool. In some embodiments, if the selectable option pertains to a highlighter tool, then the menu user interface includes selectable options for choosing the color of highlighting inputted by the tool to the electronic device. Maintaining display of the palette user interface while the menu user interface is being displayed minimizes input errors associated with ceasing display of the palette user interface while the user is engaged with the palette user interface, thereby conserving computing resources associated with correcting erroneous input.

In some embodiments, before displaying the palette user interface, the electronic device detects an indication of a squeeze input detected at the electronic stylus; In some embodiments the squeeze input shares one or more characteristics with the squeeze input described with respect to method 700. In some embodiments, in response to detecting the indication of the squeeze input at the electronic stylus, the electronic device displays, via the display generation component, the palette user interface. In some embodiments, while displaying the palette user interface, wherein the palette user interface includes a second selectable option, the electronic device detects an indication of a release of the squeeze input detected at the electronic stylus. In some embodiments, the release of the squeeze input shares one or more characteristics with the release of a squeeze input described with respect to methods 700 and 900. In some embodiments, in response to detecting the indication of the release of the squeeze input detected at the electronic stylus: in accordance with a determination that a pose of the stylus when the indication of the release of the squeeze input detected at the electronic stylus is received is directed towards the second selectable option: the electronic device performs an operation on the content creation application in accordance with selection of the second selectable option, and the electronic device ceases display of the palette user interface such as in response to the release of squeeze input 1003 selecting selectable option 1040b in FIG. 10V. In some embodiments, the squeeze input that is used to initiate display of the palette user interface is also used to perform a selection on the palette user interface and cause the palette user interface to stop being displayed. For instance, in some embodiments, the device detects that the user has squeezed the electronic stylus, and initiates display of the palette user interface. The device then detects that the user has released the squeeze input while the pose of the stylus is directed towards (e.g., the tip of the stylus is directed towards) a selectable option of the palette user interface, and in response, performs an operation associated with the selectable option that the electronic stylus is directed to and ceases display of the palette user interface. In some embodiments, the selectable option is any of the selectable options described above and with respect to methods 700, 900 and/or 1100. In some embodiments, the electronic device determines that the pose of the stylus is directed towards the first selectable option of the palette user interface when a tip of the electronic stylus is within a threshold distance away from the first selectable option (e.g., 0.01, 0.1, 1, or 10 cm). Additionally or alternatively, in some embodiments, the electronic device determines that the second input is directed towards the first selectable option of the palette user interface when a vector that originates along a central axis of the electronic stylus towards the display/user interface is aligned with the first selectable such that the vector contacts the display/user interface at the first selectable option when the vector is extended to the device/user interface. In some embodiments, the pose of the stylus being directed towards the second selectable option requires that the stylus tip is touching a selectable option when the pencil squeeze is released. In some embodiments, detecting the release of squeeze input includes a determination that squeeze strength of a squeeze input has fallen below a predefined threshold after the squeeze input was previously above another predefined threshold (e.g., thereby causing the palette user interface to be displayed.) In some embodiments, the predefined threshold shares one or more characteristics with the predefined thresholds associated with a squeeze release described above with respect to methods 700 and 900. In some embodiments, the processes described above with respect to a stylus squeeze release applies to other selectable options that are displayed on the palette user interface including a second and/or third selectable option. Detecting selection of a selectable option of the palette user interface using the release of the squeeze input that initiated the display of the palette user interface minimizes the number of inputs required to select a selectable option of the palette user interface, thereby minimizing the likelihood of erroneous inputs, thereby conserving computing resources associated with additional input required to select a selectable option of the palette user interface and correcting erroneous input.

In some embodiments, in response to detecting the indication of the release of the squeeze input detected at the electronic stylus: in accordance with a determination that the pose of the stylus when the indication of the release of the squeeze input detected at the electronic stylus is received is not directed towards the second selectable option (and/or any other selectable option in the palette user interface): the electronic device maintains display of the palette user interface, and the electronic device forgoes selection of the second selectable option (and/or forgoing performing any other operation in response to the detected release of the squeeze input at the electronic stylus) such as if the release of squeeze input 1003 was directed away from palette user interface 1018 in FIG. 10V and the device maintained display of the palette user interface in FIG. 10W. In some embodiments, if the device detects that the user has released the squeeze input that initiated display of the palette user interface, the device determines if the pose of the stylus is consistent with selection of a selectable option of the palette user interface as described above. In some embodiments, and since the device has not received a selection of a selectable option (because the stylus is not directed to any of the selectable options of the palette user interface at the time the second input was received), the device maintains display of the palette user interface to provide the user with additional time and opportunity to make a selection of a selectable option of the palette user interface. Maintaining display of the palette user interface when the device does not detect that the user has made a selection of a selectable option of the palette user interface when the squeeze input is released minimizes the number of times that the user will enter input into the device to initiate display of the palette user interface, thereby conserving computing resources associated with additional input that would otherwise be necessary to repeatedly initiate display of the palette user interface.

In some embodiments, while displaying the palette user interface, the electronic device receives a second input, via the electronic stylus, corresponding to inputting graphical data on the user interface of the content creation application using the electronic stylus. In some embodiments, the electronic device determines that the user is inputting graphical data on the user interface if it detects that the electronic stylus is touching a portion of the user interface of the content creation application (other than the portion where a selectable option of the palette user interface is displayed). In some embodiments, in response to receiving the second input, the electronic device displays a representation of the graphical data on the user interface of the content creation application, and ceases display of the palette user interface such as palette user interface 618 ceasing to be displayed in response to stylus 604 making contact with display 504 in FIG. 6H. In some embodiments, the electronic device ceases display of the palette user interface when it detects that the user is drawing or otherwise inputting graphical data on the user interface of the content creation application in order to ensure that the palette user interface does not obstruct or otherwise occlude the user interface when the user is applying the graphical input to the user interface. Ceasing display of the palette user interface when the user is applying input to the user interface of the content creation application minimizes the likelihood of erroneous input associated with visual obstructions/occlusions to the user interface caused by the display of the palette user interface, thereby conserving computing resources associated with additional user inputs that would be required to correct erroneous input.

It should be understood that the particular order in which the operations in FIG. 11 have been described, optionally including the additional and/or alternatives operations to the illustrated operations in FIG. 11 described herein, is merely exemplary and is not intended to indicate that the described order is the only order in which the operations could be performed. One of ordinary skill in the art would recognize various ways to reorder the operations described herein. In some embodiments, aspects/operations of methods 700, 900, and/or 1100 may be interchanged, substituted, and/or added between these methods. For example, the palette user interfaces of methods 700, 900, and/or 1100, the tactile outputs of methods 700, 900, and/or 1100, inputs on or via input devices (e.g., styluses) and/or expanded palette user interfaces in methods 700, 900, and/or 1100 are optionally interchanged, substituted, and/or added between these methods. For brevity, these details are not repeated here.

The operations in the information processing methods described above are, optionally, implemented by running one or more functional modules in an information processing apparatus such as general purpose processors (e.g., as described with respect to FIGS. 1A-1B, 3, 5A-5I) or application specific chips. Further, the operations described above with reference to FIG. 7 are, optionally, implemented by components depicted in FIGS. 1A-1B. For example, receiving operation 704, and displaying operations 706 and 708 are, optionally, implemented by event sorter 170, event recognizer 180, and event handler 190. Similarly, the operations described above with reference to FIG. 9 are, optionally, implemented by components depicted in FIGS. 1A-1B. For example, receiving operation 904, and generating operations 906, 908, and 910 are, optionally, implemented by event sorter 170, event recognizer 180, and event handler 190. Similarly, the operations described above with reference to FIG. 11 are, optionally, implemented by components depicted in FIGS. 1A-1B. For example, receiving operation 1104 and displaying operation 1108 are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology potentially involves the gathering and use of data available from specific and legitimate sources to facilitate correspondence of a pose and orientation of a drawing implement for the input device to the manner in which a user interacts with the input device (e.g., how a user holds the input device relative to the surface) or other interactions with the electronic device. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information, usage history, and/or handwriting styles.

The present disclosure recognizes that the use of such personal information data, in the present technology, can be used to the benefit of users. For example, the personal information data can be used to automatically perform operations with respect to interacting with the electronic device using a stylus (e.g., recognition of handwriting as text). Accordingly, use of such personal information data enables users to enter fewer inputs to perform an action with respect to handwriting inputs. Further, other uses for personal information data that benefit the user are also contemplated by the present disclosure. For instance, handwriting styles may be used to identify valid characters within handwritten content.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the user is able to configure one or more electronic devices to change the discovery or privacy settings of the electronic device. For example, the user can select a setting that only allows an electronic device to access certain of the user's handwriting entry history when analyzing handwritten content.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, handwriting can be recognized based on aggregated non-personal information data or a bare minimum amount of personal information, such as the handwriting being handled only on the user's device or other non-personal information.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method comprising:
at an electronic device in communication with a display generation component and one or more input devices, wherein the one or more input devices include an electronic stylus:
while displaying, via the display generation component, a user interface associated with a content creation application, and while a user of the electronic device is interacting with the user interface using the electronic stylus, receiving a first input, via the electronic stylus, corresponding to a request to display a palette user interface in the user interface of the content creation application; and
in response to receiving the first input, and in accordance with one or more criteria being satisfied, displaying, via the display generation component, the palette user interface in the user interface of the content creation application, including:
in accordance with a determination that a pose of the electronic stylus is a first pose relative to the user interface when the first input is received, displaying the palette user interface with a first spatial arrangement relative to the user interface; and
in accordance with a determination that the pose of the electronic stylus is a second pose, different from the first pose, relative to the user interface when the first input is received, displaying the palette user interface with a second spatial arrangement, different from the first spatial arrangement, relative to the user interface.

2. The method of claim 1, wherein:
the first pose of the electronic stylus corresponds to a first orientation of the electronic stylus relative to the user interface, and the first spatial arrangement of the palette user interface corresponds to a second orientation of the palette user interface relative to the user interface; and
the second pose of the electronic stylus corresponds to a third orientation of the electronic stylus relative to the user interface, and the second spatial arrangement of the palette user interface corresponds to a fourth orientation of the palette user interface relative to the user interface.

3. The method of claim 1, wherein the method further comprises:
selecting the first spatial arrangement such that the palette user interface is visually unimpeded by one or more portions of the user holding the electronic stylus in the first pose relative to the user interface.

4. The method of claim 1, wherein determining that the pose of the electronic stylus is the first pose relative to the user interface comprises determining a tilt angle of the electronic stylus relative to the user interface and wherein the first spatial arrangement of the palette user interface is based on the determined tilt angle of the electronic stylus.

5. The method of claim 4, wherein displaying the palette user interface with the first spatial arrangement relative to the palette user interface comprises:
determining a first vector, wherein the first vector is based on the determined tilt angle of the electronic stylus, and
determining the first spatial arrangement such that a center of the palette user interface aligns with the determined first vector.

6. The method of claim 4, wherein displaying the palette user interface with the first spatial arrangement relative to the user interface comprises:
in accordance with a determination that a first hand of the user is holding the electronic stylus, displaying the palette user interface at a first orientation relative to the user interface; and
in accordance with a determination that second hand of the user, different from the first hand, is holding the electronic stylus, displaying the palette user interface at a second orientation, different from the first orientation, relative to the user interface.

7. The method of claim 1, wherein displaying the palette user interface with the first spatial arrangement comprises displaying one or more selectable options of the palette user interface in a first order, and wherein displaying the palette user interface with the second spatial arrangement comprises displaying the one or more selectable options of the palette user interface in a second order, different from the first order.

8. The method of claim 1, wherein the one or more criteria include a criterion that is satisfied when the electronic stylus is within a first threshold distance from the user interface when the first input is received, and wherein the method further comprises:
in response to receiving the first input:
in accordance with a determination that the one or more criteria are not satisfied because the electronic stylus is beyond the first threshold distance from the user interface of the content creation application when the first input is received:
displaying the palette user interface with a third spatial arrangement relative to the user interface of the content creation application, wherein the third spatial arrangement is based on a third pose of the electronic stylus relative to the user interface prior to when the first input was received and wherein the electronic stylus was within the first threshold distance from the user interface when the electronic stylus was at the third pose.

9. The method of claim 1, wherein the one or more criteria include a criterion that is satisfied when the electronic stylus is within a first threshold distance from the user interface when the first input is received, and wherein the method further comprises:
in response to receiving the first input:
in accordance with a determination that the one or more criteria are not satisfied because the electronic stylus is beyond the first threshold distance from the user interface of the content creation application when the first input is received:
displaying the palette user interface with a third spatial arrangement relative to the user interface of the content creation application, wherein the third spatial arrangement is based on a previous spatial arrangement of the palette user interface relative to the user interface displayed by the electronic device prior to receiving the first input.

10. The method of claim 1, wherein the one or more criteria include a criterion that is satisfied when the electronic stylus is within a first threshold distance from the user interface when the first input is received, and wherein the method further comprises:
in response to receiving the first input:
in accordance with a determination that the one or more criteria are not satisfied because the electronic stylus is beyond the first threshold distance from the user interface of the content creation application when the first input is received, forgoing display of the palette user interface.

11. The method of claim 1, wherein the one or more criteria include a criterion that is satisfied when the electronic stylus is beyond a first threshold distance from the user interface when the first input is received, and wherein the method comprises:
in response to receiving the first input:
in accordance with a determination that the one or more criteria are not satisfied because the electronic stylus is touching the user interface of the content creation application when the first input is received, forgoing display of the palette user interface.

12. The method of claim 1, wherein receiving the first input comprises determining that the user of the electronic device is performing a squeeze input on a surface of the electronic stylus.

13. The method of claim 12, wherein displaying the palette user interface with the first spatial arrangement relative to the user interface comprises:
in accordance with a determination that a squeeze intensity associated with the first input is a first squeeze intensity, displaying the palette user interface at a first animation speed; and
in accordance with a determination that the squeeze intensity associated with the first input is a second squeeze intensity, different from the first squeeze intensity, displaying the palette user interface at a second animation speed, different from the first animation speed.

14. The method of claim 12, wherein the one or more criteria include a criterion that is satisfied when a squeeze intensity of the first input is above a squeeze intensity threshold, wherein the squeeze intensity threshold is user-defined.

15. The method of claim 1, wherein the first input is a first type of input, the method further comprises:
while the palette user interface is being displayed by the display generation component, receiving a second input, via the electronic stylus, wherein the second input is the first type of input; and
in response to receiving the second input, ceasing display of the palette user interface on the display generation component.

16. The method of claim 1, wherein the method further comprises:
while the palette user interface is being displayed by the display generation component, detecting that the electronic stylus is being used to provide handwritten input to the user interface of the content creation application; and
in response to detecting that the electronic stylus is being used to provide handwritten input to the user interface of the content creation application, ceasing display of the palette user interface and displaying a representation of the handwritten input in the user interface of the content creation application.

17. The method of claim 1, wherein the method further comprises:
while displaying, via the display generation component, the user interface associated with the content creation application and before receiving the first input, displaying an expanded palette user interface; and
in response to displaying the palette user interface, ceasing display of the expanded palette user interface.

18. The method of claim 17, wherein the method further comprises:
while displaying the palette user interface and while the expanded palette user interface is not displayed, receiving, via the one or more input devices, an indication to cease displaying the palette user interface; and
in response to receiving the indication to cease displaying the palette user interface, displaying the expanded palette user interface.

19. The method of claim 18, wherein displaying the expanded palette user interface in response to receiving the indication to cease displaying the palette user interface comprises displaying the expanded palette user interface in a compressed state.

20. The method of claim 1, wherein the method further comprises:
while displaying the palette user interface with the first spatial arrangement relative to the user interface, detecting that the pose of the electronic stylus has changed from the first pose relative to the user interface to a third pose relative to the user interface, different from the first pose relative to the user interface; and
in response to detecting that the pose of the electronic stylus has changed from the first pose relative to the user interface to the third pose relative to the user interface, displaying the palette user interface with a third spatial arrangement relative to the user interface, different from the first spatial arrangement relative to the user interface.

21. An electronic device that is in communication with a display generation component and one or more input devices, wherein the one or more input devices include an electronic stylus, the electronic device comprising:
one or more processors;
memory; and
one or more programs, wherein the one or more programs are stored in the memory and configured to be executed by the one or more processors, the one or more programs including instructions for:
while displaying, via the display generation component, a user interface associated with a content creation application, and while a user of the electronic device is interacting with the user interface using the electronic stylus, receiving a first input, via the electronic stylus, corresponding to a request to display a palette user interface in the user interface of the content creation application; and
in response to receiving the first input, and in accordance with one or more criteria being satisfied, displaying, via the display generation component, the palette user interface in the user interface of the content creation application, including:
in accordance with a determination that a pose of the electronic stylus is a first pose relative to the user interface when the first input is received, displaying the palette user interface with a first spatial arrangement relative to the user interface; and
in accordance with a determination that the pose of the electronic stylus is a second pose, different from the first pose, relative to the user interface when the first input is received, displaying the palette user interface with a second spatial arrangement, different from the first spatial arrangement, relative to the user interface.

22. A non-transitory computer readable storage medium storing one or more programs, the one or more programs comprising instructions, which when executed by one or more processors of an electronic device that is in communication with a display generation component and one or more input devices wherein the one or more input devices include an electronic stylus, cause the electronic device to perform a method comprising:
while displaying, via the display generation component, a user interface associated with a content creation application, and while a user of the electronic device is interacting with the user interface using the electronic stylus, receiving a first input, via the electronic stylus, corresponding to a request to display a palette user interface in the user interface of the content creation application; and
in response to receiving the first input, and in accordance with one or more criteria being satisfied, displaying, via the display generation component, the palette user interface in the user interface of the content creation application, including:
in accordance with a determination that a pose of the electronic stylus is a first pose relative to the user interface when the first input is received, displaying the palette user interface with a first spatial arrangement relative to the user interface; and
in accordance with a determination that the pose of the electronic stylus is a second pose, different from the first pose, relative to the user interface when the first input is received, displaying the palette user interface with a second spatial arrangement, different from the first spatial arrangement, relative to the user interface.

23. An electronic device that is in communication with a display generation component and one or more input devices, wherein the one or more input devices include an electronic stylus, the electronic device comprising:
one or more processors;
memory; and
means for while displaying, via the display generation component, a user interface associated with a content creation application, and while a user of the electronic device is interacting with the user interface using the electronic stylus, receiving a first input, via the electronic stylus, corresponding to a request to display a palette user interface in the user interface of the content creation application; and
means for in response to receiving the first input, and in accordance with one or more criteria being satisfied, displaying, via the display generation component, the palette user interface in the user interface of the content creation application, including:
in accordance with a determination that a pose of the electronic stylus is a first pose relative to the user interface when the first input is received, displaying the palette user interface with a first spatial arrangement relative to the user interface; and
in accordance with a determination that the pose of the electronic stylus is a second pose, different from the first pose, relative to the user interface when the first input is received, displaying the palette user interface with a second spatial arrangement, different from the first spatial arrangement, relative to the user interface.

24-85. (canceled)
